(19) United States
(12) Patent Application Publication
(10) Pub. No.: US 2007/0112668 A1
(43) Pub. Date: May 17, 2007

(54) Method and apparatus for a consumer interactive credit report analysis and score reconciliation adaptive education and counseling system

(76) Inventors: Matt Celano, Winter Garden, FL (US); David L. Wheelock, Windermere, FL (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/595,629

(22) Filed: Nov. 9, 2006

Related U.S. Application Data
(60) Provisional application No. 60/735,570, filed on Nov. 12, 2005.

(51) Int. Cl. G06Q 40/00

(52) U.S. Cl. 705/38

(57) ABSTRACT

An interactive credit report educational and counseling system provides a method and system for compiling, presenting and explaining a consumer's credit report in an easier to understand and more user friendly format. A consumer's credit performance information is characterized and a customized display of a consumer's credit report information is provided. Through the customized display of information the user may access detailed explanations regarding the information contained within their credit report. Based on the characterization of the consumer's credit performance an action plan may be generated allowing the consumer to receive counseling as to actions to avoid or to take to enhance their credit score, thereby improving their credit worthiness.

### CROSS REFERENCE TO RELATED APPLICATION

The present invention claims priority under 35 U.S.C. §119 to the U.S. Provisional Application Ser. No. 60/735,570, filed on Nov. 12, 2005, which is herein incorporated by reference in its entirety.

### FIELD OF THE INVENTION

This present invention relates generally to methods and systems for consumer credit report data analysis, intelligent reporting, adaptive counseling and education. In particular, it provides a customized interactive credit education tool that a consumer may use to decode and reconcile their credit score with past credit usage behavior and an intelligent analysis method that creates an adaptive action plan outlining steps to improve the consumer's credit score.

### BACKGROUND OF THE INVENTION

Consumer credit reports are compositions of multiple records containing information components regarding a consumer's credit usage. Within some credit reports is a credit score, which is typically the primary baseline used to assess a consumer's credit worthiness. A consumer credit score is a numerical reflection of a consumer's loan repayment risk representing the probability that a consumer will repay a loan extended by a credit lender. A “basic” credit report contains little or no explanation of what relevant factors influence a score while an advanced credit report may provide limited additional insight through qualifying factors that influence the score.

Credit reports are created and maintained by Credit Reporting Agencies (CRA) who serve as entrusted repositories for credit lenders and consumers. The credit report for various entities such as consumers, are constructed of multiple records collected from lenders and various court systems. These records contain distinct information components that are assembled into the comprehensive credit report format. There are three major CRAs within the United States and they are regulated by the Federal Trade Commission (FTC). CRA's benefit credit lenders by providing a risk management means for loaning money, and benefit consumers by providing access to capital. The risk management means is typically the consumer's credit score. By today's current standards, the higher the credit score, the more likely a consumer is to repay the loan and thus, the lower the credit risk the consumer is to potential credit lenders. It is known that a consumer's credit score may fluctuate based upon credit activity, therefore a consumer's credit score is a snapshot in time and is computed from assessing consumers' current and historical debt-paying activities.

As stated previously, the credit reporting process is supported by credit lenders and court systems who may electronically post consumer credit usage activities to a CRA's database repository. Thus, the CRAs not only provide compiled credit report information to both credit lenders and consumers, they use the credit information from the lenders and courts to determine credit scores and provide those scores to both credit lenders and consumers.

Unfortunately, a credit score represents a single determinant variable used by a credit lender to predict the probability of repayment and does not explain “how” specific credit activities have influenced a score. Unfortunately, it is often the case that relatively few consumers understand their credit score and how their credit score affects them financially. This is supported by consumer research conducted by the Consumer Federation of America, the Government Accounting Office and others, who determined that a majority of consumers have difficulty understanding their credit report and credit score. The lack of understanding of how credit scores are determined and of the effect of a credit score may lead to low credit scores and may be a significant problem for a consumer attempting to secure credit, make purchases, apply for jobs, obtain favorable insurance coverage, and many other activities.

For instance, some Creditors utilize proprietary scorecards in conjunction with credit scores to assess future payment performance and risks associated with lending to a consumer. Thus, each CRA may calculate a different consumer credit score based upon various credit usage information collected. The different score may result from each CRA using different information components to determine the score and/or may be the result of each CRA utilizing a different scoring method(s). There is no FTC regulation which requires each of the CRA's to use a single standard approach, based on the use of similar information components and scoring method(s), for determining consumer credit scores. This lack of a standard approach may cause confusion for the consumer.

It may often be the case that a typical credit report provides little or no insight into what behaviors impact a credit score. Thus, for consumers with low credit scores their lack of knowledge of what actions they took that resulted in their credit score being lowered may prevent them from avoiding such actions in the future. Further, it is often the case that consumers are not provided information on how to improve their credit scores. Therefore, consumers are not enabled to take the necessary steps to repair their credit and credit scores. The consumers who are unable to improve a poor credit score may often find themselves unable to receive credit, get a job, find favorable insurance coverage, and various other financial aspects of their lives may be negatively impacted.

Therefore, it would be desirable to provide a credit behavior inference model that is able to take the complex information within a consumer credit report and provide it in a format that a consumer may comprehend and act upon. It would also be desirable to allow the model to disclose to the consumer what past behaviors have influenced their credit score and what new behaviors need to be employed to avoid negative impacts upon their credit and/or improve their credit.

### SUMMARY OF THE INVENTION

Accordingly, the present invention provides an Interactive Credit Report Educational and Counseling System (ICRECS) that assists consumers by providing consumers with a credit report counseling and education tool delivered through an interactive digital dashboard over a secured Internet connection in a particularly preferred embodiment. It is to be understood that the delivery of the counseling and educational benefits provided by the present invention may be accomplished utilizing various mechanisms, such as through a conversation with a counselor, exchange of documents, and the like without departing from the scope and spirit of the present invention. In a particularly preferred embodiment, the present invention includes a method for providing credit education to a consumer. The method may begin with the building of a personal profile for the consumer. This personal profile may be built by the consumer providing information to the ICRECS over the secured internet connection. Alternatively, the personal profile may be built in various other manners, such as the consumer providing the information directly to a credit counselor, who may then enter it into the ICRECS. In another exemplary step, the method may proceed by retrieving credit report data for the consumer. The present invention (ICRECS) may download a credit report data file from a CRA database which contains data records collected from lenders and various court systems regarding a consumer. Information within the credit report data file is stored as records, and records have distinct formats for different information components. The composition of these data records and their translation into a human readable format is what is referred to as a “credit report”. In another exemplary step, the method may include the characterization of the credit report data for the consumer. The characterization of the credit data includes the analysis and assessment of the credit data by the ICRECS of the present invention. As will be described below herein, the characterization of consumer credit data by ICRECS may include the quantification of the factors that influence a score, going beyond an advanced credit report as previously described. It is further contemplate that the characterization of the consumer's credit information may also include the disclosure of future conditional factors, or Alerts, that may change a score and provide guidance for improving a credit score and clarify specific cautions. These future conditional factors are usually dependent upon action taken by the consumer.

In another particularly preferred embodiment of the current invention, the method for providing credit education to a consumer may include the further step of generating an action plan. The action plan may be generated utilizing the information provided through the characterization (analysis and assessment) of the consumer's credit information. Thus, the action plan may suggest positive behaviors to build a strategy from which a consumer may work towards long-term creditworthiness. The action plan may also point out past positive behaviors that have contributed to a consumer's good credit standing. It is further contemplated that the present invention may provide an audit of a consumer's credit report, thereby allowing ICRECS to recommend supplemental educational content to address any identified deficiencies in credit usage behavior. The ICRECS educational and counseling system adapts to the specific needs of each consumer, offering a customized plan of action for each element of their credit report.

As previously mentioned, some Creditors utilize proprietary scorecards in conjunction with credit scores to assess future payment performance and risks with lending to a consumer. What is needed is a scorecard for the consumer that is an interpretation of all the factors that influence a credit score. Furthermore, the interpretation needs to be presented in terms that an average consumer may understand and in a format that allows information to be viewed at different levels of detail, both graphically and numerically. In a particularly preferred embodiment of the present invention, such an interpretation and a consumer oriented scorecard that delineates the factors that influence a credit score, at both a detail and summary level, using terms that the average consumer may understand, is provided through the ICRECS.

In another particularly preferred embodiment of the present invention the credit report interpretative results are presented to a consumer in an interactive framework. ICRECS uses a digital dashboard to deliver various information, such as credit report education and counseling information as shown in the drawing figures and described herein. Using ICRECS, a consumer may dimensionally analyze their credit data, view customized education components and use an interactive counseling tool that details how their credit scores work and how financial behaviors affect a credit score. This may be accomplished by divulging the specifics of how the proprietary ICRECS credit score is generated using the consumers own credit report data. As a result, consumers are actually able to see how their score is reconciled down to the very detailed data elements in their trade lines. This systematic educational methodology teaches consumers to decipher and proactively manage their credit score using an adaptive counseling process that is specific to the data in a consumer's credit file and makes available educational tools, such as a trained counselor, to guide the consumer through the process. ICRECS assists the consumer in understanding the calculation of a credit score in a way that has been previously unavailable to consumers.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWING FIGURES

FIG. 1 is a block diagram representation illustrating an interactive credit report educational and counseling system (ICRECS) in accordance with an exemplary embodiment of the present invention;

FIG. 2A is a block diagram representation illustrating multiple functional capabilities of the ICRECS for educating and counseling a consumer in accordance with an exemplary embodiment of the present invention;

FIG. 2B is a block diagram representation illustrating a method of providing credit education to a consumer;

FIG. 2C is a block diagram representation illustrating a method of providing credit counseling to a consumer;

FIG. 3 is an illustration of a representative information gathering format (“self assessment”) provided within the ICRECS of the present invention wherein major components of the ICRECS are identified to a user and response from the user is requested;

FIG. 4 is an illustration of a representative information gathering format (“Personal Information and Payment”) provided within the ICRECS of the present invention wherein data elements are collected from the user;

FIG. 5 is an illustration of a representative information presentation format (“Credit Overview Screen”) provided by the present invention;

FIG. 6 is an illustration of a representative information presentation format (“Score Analysis”) provided by the present invention;

FIG. 7 is an illustration of a representative information presentation format (“Report Analysis—Credit Report Summary Panel”) provided by the present invention;

FIG. 8 is an illustration of a representative information presentation format (“Report Analysis—Personal Information Panel”) provided by the present invention;

FIG. 9 is an illustration of a representative information presentation format (“Report Analysis—My Accounts Panel”) provided by the present invention;

FIG. 10 is an illustration of a representative information presentation format (“Report Analysis—Inquiries Panel”) provided by the present invention;

FIG. 11 is an illustration of a representative information presentation format (“Report Analysis—Consumer Statements Panel”) provided by the present invention;

FIG. 12 is an illustration of a representative information presentation format (“Action plan—Personal Information Panel”) provided by the present invention;

FIG. 13 is an illustration of a representative information presentation format (“Action plan—Grouping, Summary Panel”) provided by the present invention;

FIG. 14 is an illustration of a representative information presentation format (“Action plan—Grouping, My Actions Panel”) provided by the present invention;

FIG. 15 is an illustration of a representative information presentation format (“Action plan—Grouping, Warnings Panel”) provided by the present invention;

FIG. 16 is an illustration of a representative information presentation format (“Action plan—Grouping, Learn More”) provided by the present invention;

FIG. 17 is an illustration of a representative information presentation format (“Letters”) provided by the present invention;

FIG. 18 is an illustration of a representative Credit Score Academic Mapping Table in accordance with an exemplary embodiment of the present invention;

FIG. 19 is an illustration of a representative ICRECS Decision Score Card in accordance with an exemplary embodiment of the present invention; and

FIGS. 20A, B, C, and D are illustrations of a representative listing of action plan Program Topics that may be utilized during the generation of an action plan in accordance with an exemplary embodiment of the present invention.

### DETAILED DESCRIPTION OF THE INVENTION

The current invention provides an interactive tool that reconciles an individual's credit score to their credit usage activities and in a user friendly format. The point weighting, analysis, and components that go into developing a credit score are explained for each credit report.

An Interactive Credit Report Educational and Counseling System (“ICRECS”) is composed of several components that deliver counseling and education to a consumer. In a preferred embodiment, a Credit Report Inference Engine, (referred to hereinafter as the “CRIE”) component provides the analysis and assessment of credit report data to generate educational and counseling information. Information is organized using a scorecard model that presents the number of points lost for different factors. This information is presented within an interactive digital dashboard that provides a graphical view and text view of summarized and analyzed credit data. It is contemplated that the display of relevant information to a consumer may be provided in various formats, such as in a “hard” copy format, video format, audio format, and the like. The dashboard is known as the Credit Report Interactive Intelligent Dashboard (referred to hereinafter as “CRIID”). A consumer may use CRIID to dimensionally examine and view summarized and detailed information derived from the analysis of their credit report. The dimensional examination capabilities may allow the user to “drill down” into certain data information provided, that the consumer has questions regarding, and find additional information explaining the particular data record, such as how it was formulated and how it impacts the consumer's credit score. It is contemplated that the dimensional examination capability may be accomplished utilizing various tools and formats without departing from the scope and spirit of the present invention.

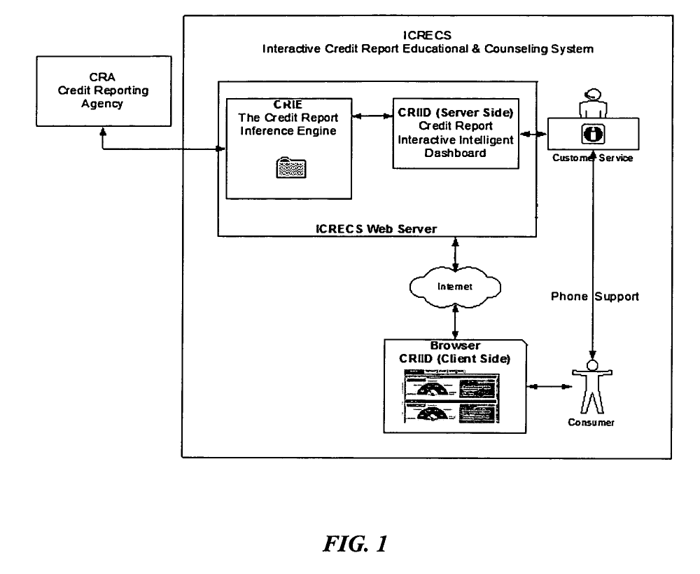

Reference will now be made in detail to the presently preferred embodiments of the invention, examples of which are illustrated in the accompanying drawings. The ICRECS system provides methods for educating and counseling a consumer regarding their credit and credit score. FIG. 1 provides an overview of the ICRECS system including an ICRECS Web Server that includes a Credit Report Inference Engine (“CRIE”) that allows for and supports the implementation of the Credit Report Interactive Intelligent Dashboard (“CRIID”). The ICRECS Web Server further allows for the communicative coupling of the CRIE with a Credit Reporting Agency (“CRA”) and the CRIID with the consumer. In a preferred embodiment, the consumer receives the CRIID through the consumer's web browser. It is contemplated that the ICRECS may provide some or all of its educational and counseling functionality to the consumer through an alternative medium to the web-based service. For instance, the ICRECS may provide a telephone based system wherein the consumer may speak with a “customer service” representative for the ICRECS system and receive education and counseling regarding the consumer's credit rating. The representative for the ICRECS may be given access, such as through a web-based connection to the ICRECS Web Server, to the relevant information regarding the consumer, as is detailed below, and provide assistance to the consumer from that information.

In a preferred embodiment, the ICRECS is a software application that may be downloaded to a computing system, such as a Server, PC, and the like. The ICRECS software contains various computer readable sets of instructions/commands providing hierarchical, logical instruction/command execution sequences that allow the ICRECS to perform its credit education and counseling functions. Thus, the computer readable commands provide for the execution of specific functions by the computing system to allow the ICRECS to perform its capabilities, as will be described below and throughout the instant specification. In the current embodiment, the CRIE is a logic construct within the ICRECS and it is through this logic construct that the execution of the sets of instructions/commands for the performance of certain functions of the ICRECS software is handled. It is contemplated that the number, sequence, directives, and language contained within the commands of the ICRECS may vary as contemplated by those of ordinary skill in the art. It is further contemplated that the number and interactions of logic constructs within the ICRECS may vary without departing from the scope and spirit of the present invention. Thus, the execution of the fuctional capabilities of the present invention may occur through various logic constructs as may be contemplated by those of ordinary skill in the art and is not intended to be limited only to the CRIE.

In the current embodiment of FIG. 1, the system is a web based application delivered through a secured web browser connected to a web server. It is contemplated that the ICRECS may be implemented and executed over various computer networks without departing from the scope and spirit of the present invention. The web server is the apparatus that contains logic (CRIE and CRIID) and data that generates HTML data (or other data formats) rendered through a connected web browser. The web browser is the user interface for CRIID, and uses a digital dashboard model to present information and interact with a consumer. As previously mentioned, ICRECS' support of a telephone based counseling service allows the consumer to talk directly to an ICRECS representative (“trained counselor”) to answer questions about their credit report. The phone based system may be accomplished through an authentication and information retrieval process conducted by the counselor when a consumer calls. Other methodologies for accomplishing the credit education and counseling functionality and purpose of the present invention may be employed in providing the phone based support.

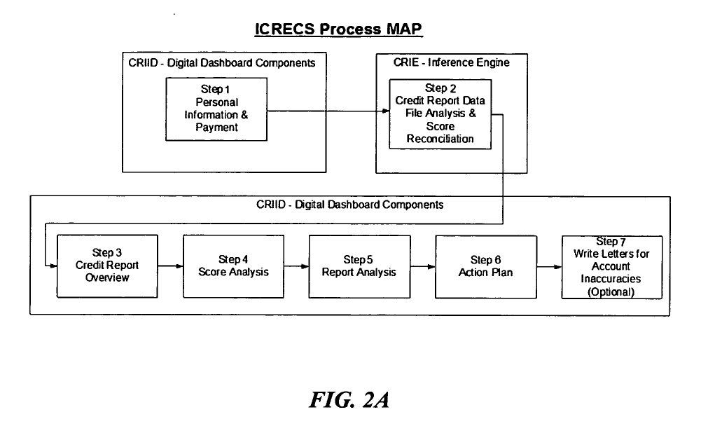

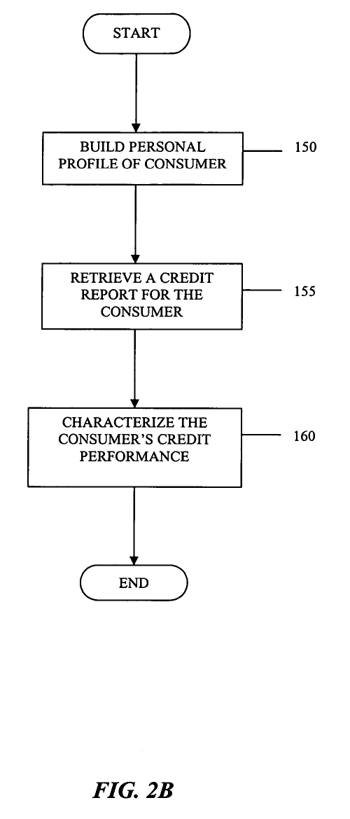

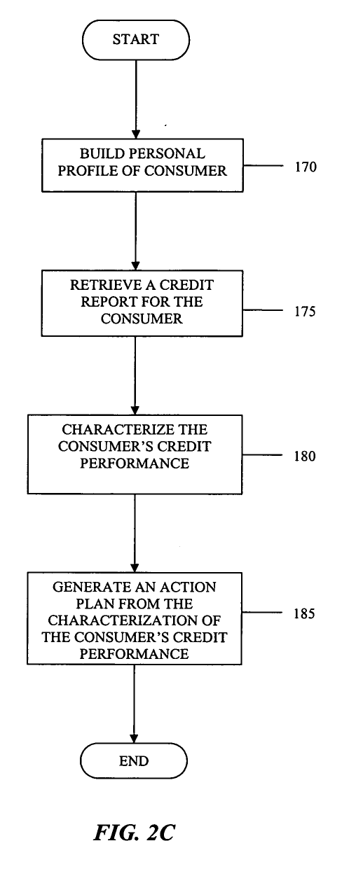

FIG. 2A shows various functional features that may be performed by the execution of the computer readable commands provided by the ICRECS. In a preferred embodiment, the ICRECS enables the performance of seven functions or steps including a first step of collecting personal information and payment (which may include a credit report self-assessment), a second step of providing a credit report data file analysis and assessment, a third step of providing a credit report overview, a fourth step of providing a score analysis, a fifth step of providing a report analysis, a sixth step of providing an action plan and a seventh step of providing a letter writer to address account inaccuracies. It is contemplated that the ICRECS may include greater or fewer functional features and/or performance of executable computer readable commands. For instance, the ICRECS may provide, as separate functional feature, the gathering of the credit report self-assessment data bringing the total number of functional features to eight.

In a preferred embodiment, the ICRECS allows the consumer to navigate these steps through the CRIID. Within the digital dashboard (CRIID) the user is provided with various prompts that allow them to select the information they wish to receive, thus directing the execution of one or more of the various functions provided within the ICRECS software application. It is to be understood that the presentation of the functional capabilities/steps of the ICRECS shown in FIG. 2A and described above is not intended as an exclusive listing of functional capabilities that may be performed by the present invention or to be limited to a linear progression. The steps may be performed in a non-linear format, wherein certain steps may execute simultaneously. The designation of the steps as “first”, “second”, . . . and “seventh” is provided for clarity purposes only and does not necessarily require the performance of any one step for the performance of another step. Thus, the steps performed by the current invention may be organized in various ways, such as executing only certain functional steps at certain times, consolidating or expanding the number of steps, and/or varying the order the steps are performed in.

In a preferred embodiment, a method provided by the ICRECS is a process shown in FIG. 2B. This process involves a first step 150 of building a personal profile for a consumer. After the personal profile is completed, the next step 155 retrieves a credit report data file for the consumer. Utilizing the credit report data file information, step 160 includes the characterizing of the consumer's credit performance. In general, the method provides the consumer with their current credit rating and gives them the information relevant to how their credit rating was established and what factors influenced their credit rating. In the current embodiment, the method of the current invention for characterizing the consumer's credit performance, which includes analysis and assessment of a consumer's credit information and provides the relevant information to the consumer that assists in explaining to the consumer the various factors that have influenced their credit performance, is detailed below. The analysis of various “Triggers” and “Alerts” within a consumer's credit records allows the current invention to characterize and display educational information about their credit.

A method for providing credit counseling to a consumer is shown in FIG. 2C. In a preferred embodiment, the credit counseling method is similar to the method for providing credit education, involving a first step 170 of building a personal profile for a consumer, a next step 175 of retrieving a credit report data file for the consumer and a third step 180 of characterizing of the consumer's credit performance. However, the current embodiment goes one step further by including step 185 whereby the generation of an action plan for reporting opportunities to the consumer regarding their credit performance occurs. In the current embodiment, the present invention provides a behavioral trend analysis to identify to the consumer both positive and negative opportunities that may impact the consumer's credit performance. In addition, the present invention may also provide general recommendations to the consumer regarding their credit performance. The action plan that is developed through the behavioral trend analysis resulting in the reporting of positive and/or negative opportunities and the general recommendations is further explained in the description below.

The step of the method for generating the action plan for a consumer includes the step of providing recommended actions to the consumer. These recommended actions are based upon the analysis and assessment of the consumer's credit records performed in the characterization step. The action plan may provide the consumer with educational links, general recommendations, or specific counseling regarding positive and negative opportunities found within the consumer's credit records. As is described below, the action plan may include recommended action(s) to be taken or actions not to be taken by the consumer in order to improve their credit record. It is further contemplated that the action plan may include various educational topics, preferably accessed through the educational links, regarding consumer credit. The action plan may be tailored for the individual consumer based upon the characterization of the consumer's credit performance and then making specific recommendations for actions that may be taken by the consumer.

An exemplary system and various exemplary methods of the current invention have been generally described heretofore. It is contemplated that those of ordinary skill in the art may enhance the various system features and/or method steps without departing from the scope and spirit of the present invention. The following provides a detailed description of the steps performed in the exemplary methods and the system features utilized.

In a preferred embodiment, the first step in the education and counseling of a consumer on their credit usage/performance, which may include the development of an action plan, is the building of a personal profile of the consumer. The ICRECS system provides an interactive framework through which a consumer is allowed to complete a self-assessment and personal profile. In the current embodiment, the system is a web enabled system that utilizes a website, such as an ICRECS website, to present and gather relevant information. The website may be accessed by a consumer through the use of a computer, such as a PC, Macintosh, and the like. It is within this exemplary networked computing environment that the ICRECS system operates and provides the various methods described above and throughout the instant specification. The consumer's interaction and entry of information initiates a Credit Report Counseling Session (referred to hereinafter as the “CRCS”).

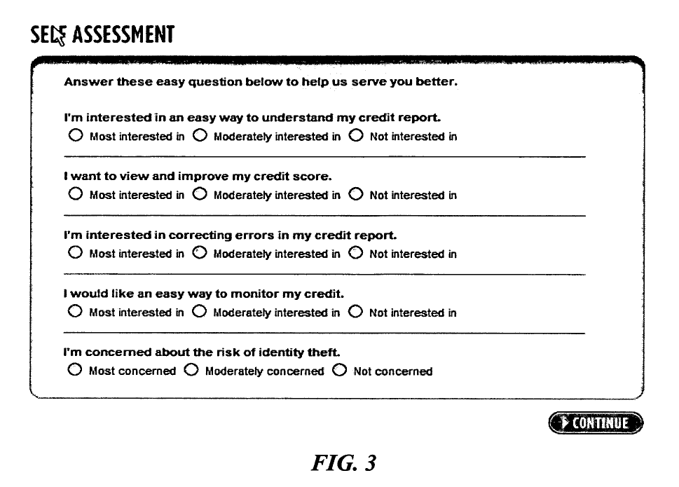

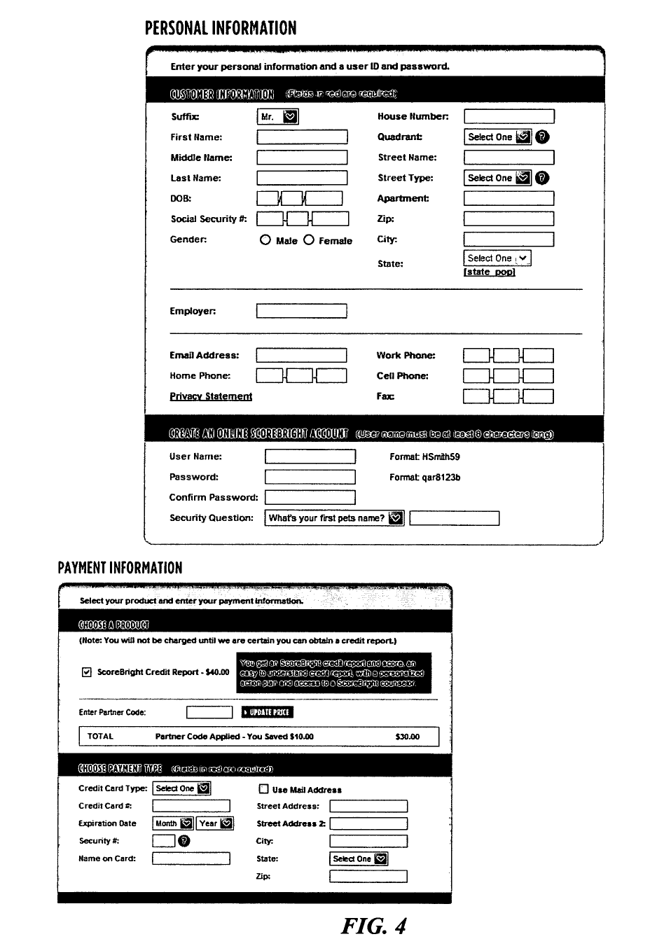

An exemplary self-assessment process, shown in FIG. 3, is part of the exemplary methods and assists in base-lining the consumer's knowledge and defining their credit management needs. As described above, the self-assessment may preferably be included as part of the step of gathering personal information and payment information or, alternatively, may be a separate step. This self-assessment (personal profile) may be presented to the consumer as a screen on a computer system being used by the consumer. In the current embodiment, the assessment questions are presented as follows: 1) I'm interested in an easy way to understand my credit report, 2) I want to view and improve my credit score, 3) I'm interested in correcting errors in my credit report, 4) I would like an easy way to monitor my credit, 5) I'm concerned about the risk of identity theft. The consumer scores each question within the following categories; 1) Most interested in, 2) Moderately interested in, 3) Not interested in/Not concerned. The score results are stored in the consumer's profile data record in a computer generated format and used to customize education and counseling for the consumer.

It is to be understood that the self-assessment (personal profile) may include various other queries, be provided in different formats, and include other information as may be contemplated by one of ordinary skill in the art. For instance, an additional query may include, “I am interested in a credit monitoring program that provides me regular updates on my credit situation”, and the like. The formatting may be varied to provide each question in an individual “block” of information presented on the screen. Each question may be provided on an independent screen and/or each question may provide a “link” to further information/explanation about the question being asked. Various links may be provided that allow the user to access further information, for instance there may be a link to a “page” (alternative screen accessed through the computing environment) giving an exemplary view of one of the screens in the CRIID, other links may prompt a user to answer further questions, other links may prompt a user to explore various other features of the current invention, such as a “enhanced features”, different product lines, and the like. Generally speaking, the display screen enabled for the self-assessment and personal profile may allow the user to perform any computer network capability known to those of ordinary skill in the art in the relevant field.

In a preferred embodiment, the step of building a personal profile may begin with the gathering of a consumer's personal and payment information for the ICRECS service through use of a web-enabled interactive framework, as shown in FIG. 4. It is contemplated that the self-assessment information may be presented within this framework or be given a separate framework as shown in FIG. 3. It is contemplated that the information gathered from either the self-assessment, personal information and/or payment information frameworks may be altered to include greater or fewer queries, different queries, various different formats, screen configurations, and the like. It is also contemplated that the order in which such information is gathered by the ICRECS system may be varied. For instance, the personal information may be gathered first and then the self-assessment performed. The type and amount of information contained on each screen may be variously presented. For example, the self-assessment and personal information queries may be included on a single screen and the payment information on a separate screen. Such changes to the information presented and gathered by and through the ICRECS system are intended to fall within the scope and spirit of the present invention.

In a preferred embodiment, as shown in FIG. 4, the personal information is gathered through a web enabled ICRECS system. Via consumer interaction with the screen enabled over the web, the ICRECS is capable of identifying key data elements provided by the consumer and a payment method.

In a next step of the method(s), the consumer information collection process is used to securely retrieve credit report data file (“credit report”) from a Credit Reporting Agency, (referred to hereinafter as the “CRA”) as shown in FIG. 1. The formatting, layout, and information asked for and provided for this consumer information collection process enabled via a computer display may be varied as contemplated by those of ordinary skill in the art. ICRECS system provides this functional step through its communicative coupling of the CRA with the ICRECS Web Server. It is contemplated that the present invention may utilize the information collected regarding the consumer to retrieve the consumer's credit report in various ways. For instance, the consumer's information may be presented to the CRA in a hard copy (e.g., paper) format and the consumer's credit report may be presented in a hard copy format. The credit report information may then be entered into the ICRECS system and utilized for the performance of methods of the present invention.

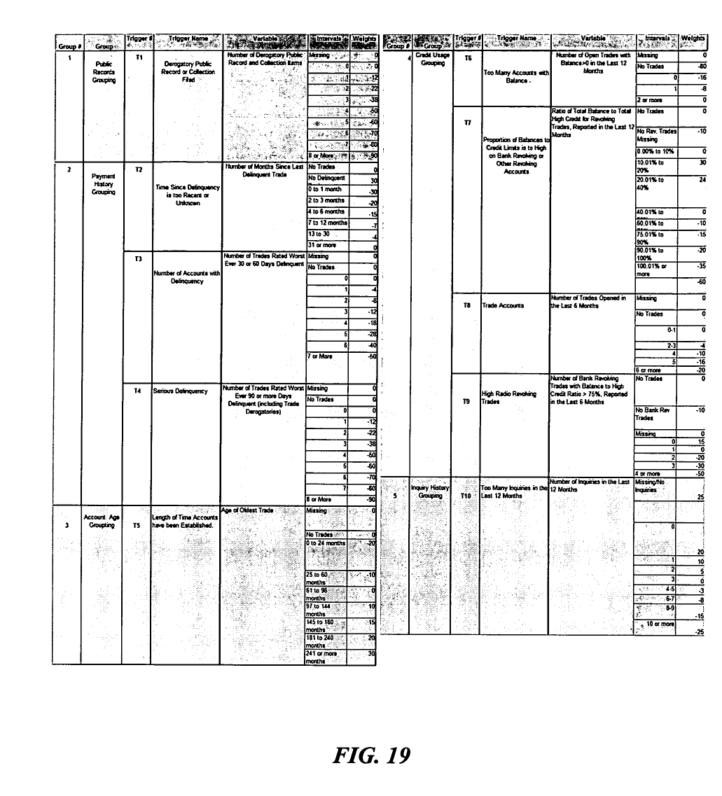

After the consumer's credit report information has been retrieved, the next step in the methods of the current invention is the characterization of the consumer's credit performance. In the current embodiment, the characterization of the credit performance is accomplished by allowing the Credit Report Inference Engine (“CRIE”) to compute a credit score and provide an academic grade translation of the computed credit score. The ICRECS system utilizes a decision score-card model that uses statistical analysis to create a single quantifiable credit usage risk factor. An exemplary embodiment of the decision score-card model is presented in its entirety in FIG. 19. This score quantifies risk in predicting future credit usage behavior based upon historic credit usage behavior.

Typically, a credit score computed by the CRA's ranges from 300 to 850, wherein a higher score represents a lower credit risk. The CRIE may compute a credit score that falls within or outside of this range. It is contemplated that the CRIE may calculate a credit score that uses a range similar to or different from the one stated above. Utilizing the CRIE generated credit score; the ICRECS provides a report grade, a Computed Credit Grade (CCG), which is computed by using a grading scale, which maps scores to an academic grade of A to F. FIG. 19 provides an exemplary embodiment showing how the CCG utilizes a grading scale that maps to a credit score. CRIE generates information in a computer-usage form for each factor and presents the information to the user through the CRIID (digital dashboard). The CRIID provides the user with the capability to interactively “drill down” (access further information through computer enabled links) and examine information at various levels, such as a Grouping and Detail level.

The credit report analysis and assessment process performed by CRIE, begins by retrieving a credit report data file from a CRA on behalf of a consumer as illustrated in FIG. 1. From the credit report data file, CRIE compiles measurements, provides reports and graphics and may provide a behavioral trend analysis and action plan, all of which may be customized for a consumer.

A credit report data file is composed of data records and data records are composed of data attributes. A data attribute represents a specific entity of information, which CRIE evaluates in the characterization of a consumer's credit performance information. The characterization is an analysis and assessment process performed by the CRIE. There are two primary classes of data records, informational data records and trigger data records. CRIE analyzes trigger records because they contain the determining factors used to interpret the credit worthiness for a consumer and represent a historical account of a consumer's credit behavior. The examination of the triggers may proceed in any manner, such as that described below, without departing from the scope and spirit of the present invention. As shown in FIG. 19, there are 10 classes of Triggers, which are: T1) Derogatory Public Records or Collection, T2) Time Since Delinquency is too Recent or Unknown, T3) Number of Accounts with Delinquency T4) Serious Delinquency, T5) Length of Time Accounts Have Been Established, T6) Too Many Accounts with Balance, T7) Proportion of Balances to Credit Limits is to High on Bank Revolving or Other Revolving Accounts, T8) Trades Accounts, T9) Number of Revolving Trades, T10) Too Many Inquiries in the Last 12 Months.

FIG. 19 further illustrates that each of these 10 triggers may be classified into five distinct Groupings: 1) Public Records/Collections, 2) Payment History, 3) Account Age, 4) Credit Usage and 5) Inquiry History. It is contemplated that the present invention may be employed with various distinct Groupings, for which various triggers may be classified into, and that the listing provided herein is not an exclusive listing or intended to limit the present invention. The Public Records/Collections grouping allows a user to access information relating to various activities that may or may not have occurred. Such activities may include foreclosure, civil and small claims judgments that remain on the credit report for seven years from the date filed. Paid tax liens remain for seven years from the paid date of the lien. Unpaid tax liens remain for 15 years from the filing date. Chapter 13 Bankruptcy remains on the credit report for seven years from the filing date while Chapter 7, 11 and 12 Bankruptcy remains for ten years. The Payment History/Missed Payments grouping includes records that represent a consumer's payment history. The Inquiry History/Inquiries grouping includes records for credit data request from companies. Some requests are from lenders who are evaluating credit worthiness and may negatively impact a credit score. Other inquires; such as employment inquires do not impact a credit score. The Credit Usage/Balances grouping records represent open trade accounts with credit lenders. The Account Age grouping records represent the length of time specific trade accounts have been open/active.

Within each trigger is a measure, which is the primary variable used to compute a credit score. This Computed Credit Score (CCS) is the sum of all the Trigger scores, T1+T2+T3+ . . . T10=CCS. CRIE may also define conditions, which are written explanations of observed factors within a trigger or its records. Conditions provide definitions of the root cause analysis performed by CRIE. Similar to a Condition, CRE also defines alerts, which are a conjugation of records and triggers. Table 1 lists all Triggers and their associated groups and measures.

TABLE 1
Trigger Table
Trigger Table

| Group | # | Trigger | Measures |
|---|---|---|---|
| Public Records Grouping | T1 | Derogatory Public Record or | Number of Derogatory Public |
| | | Collection Filed | Record and Collection Items |
| Payment History Grouping | T2 | Time Since Delinquency is | Number of Months Since Last |
| | | too Recent or Unknown | Delinquent Trade |
| | T3 | Number of Accounts with | Number of Trades Rated Worst |
| | | Delinquency | Ever 30 or 60 Days Delinquent |
| | T4 | Serious Delinquency | Number of Trades Rated Worst |
| | | | Ever 90 or more Days Delinquent |
| | | | (including Trade Derogatories) |
| Account Age Grouping | T5 | Length of Time Accounts | Age of Oldest Trade |
| | | have been Established. | |
| Credit Usage Grouping | T6 | Too Many Accounts with | Number of Open Trades with |
| | | Balance | Balance >0 in the Last 12 Months |
| | T7 | Proportion of Balances to | Ratio of Total Balance to Total |
| | | Credit Limits is to High on | High Credit for Revolving Trades, |
| | | Bank Revolving or Other | Reported in the Last 12 Months |
| | | Revolving Accounts | |
| | T8 | Trade Accounts | Number of Trades Opened in the |
| | | | Last 6 Months |
| | T9 | High Radio Revolving Trades | Number of Bank Revolving |
| | | | Trades with Balance to High |
| | | | Credit Ratio >75%, Reported in |
| | | | the Last 6 Months |
| Inquiry History Grouping | T10 | Too Many Inquiries in the Last | Number of Inquiries in the Last |
| | | 12 Months | 12 Months |

CRIE uses a hierarchy approach in assessing and analyzing data records and data attributes within a credit report, starting at the record level and then summarized at the trigger and group level. A trigger will generally include multiple records within a credit report data file and may include a record for each trade line. For example, the trigger “T2-Time Since Delinquency is too Recent or Unknown”, which falls within the payment history grouping, will include a record for each trade line. Within each of these records will be the payment delinquency rate for a given trade line.

In the current embodiment, the CRIE score-card decision model begins its computational process using 676 points as a baseline credit score for every consumer. It is contemplated that the current invention may include a score-card decision model that begins its computational processing using a number less than 676 or greater than 676 without departing from the spirit and scope of the present invention. The credit score calculation process begins by setting the accumulated credit score to the baseline value of 676 points. It is then adjusted up or down by iterating through each trigger and adding each trigger's respective points to the accumulated total. It is contemplated that each of the triggers utilized by the present invention may have points associated with it which may be positive or negative; a positive value diminishes credit risk and a negative value increases credit risk. The assignment of point values to the triggers is a process that is individually repeated for each of the 10 triggers, in the current embodiment. It is contemplated that varying numbers of triggers may be employed with the present invention and that regardless of the number of triggers, each trigger may have a point value associated with it. Further, each trigger may have an interval range or tier associated with it that represents a scoring weight or specific condition. It is to be understood that the number of tiers and/or number/values of particular interval ranges associated with a trigger may be varied without departing from the scope and spirit of the present invention. A trigger's points are computed by evaluating the primary variable for each of its records and in some cases the number of records that fall within a specific tier. The primary variable is a numeric value within a record that represents the measurement for a given trigger type. The primary variable for each record is mapped to its respected tier and is then assigned the weight associated with the given tier. A weight may be a positive or negative numeric value and represents the number of points rewarded or castigated. Table 2 illustrates the Score Card Decision Model:

TABLE 2
Score Card Decision Model
Score Card Decision Model

| | | | Number | | |
|---|---|---|---|---|---|
| | | | Intervals/ | | Computed Score |
| # | Trigger | Measures | Tiers | Weight Ranges | (Points) |
| Baseline Score | | | | | 676 |
| T1 | Derogatory Public Record or | Number of Derogatory Public | 9 | −90 to 0 | Plus or Minus |
| | Collection Filed | Record and Collection Items | | | |
| T2 | Time Since Delinquency is | Number of Months Since Last | 8 | −30 to 30 | Plus or Minus |
| | too Recent or Unknown | Delinquent Trade | | | |
| T3 | Number of Accounts with | Number of Trades Rated Worst | 9 | −50 to 0 | Plus or Minus |
| | Delinquency | Ever 30 or 60 Days Delinquent | | | |
| T4 | Serious Delinquency | Number of Trades Rated Worst | 9 | −90 to 0 | Plus or Minus |
| | | Ever 90 or more Days Delinquent | | | |
| | | (including Trade Derogatories) | | | |
| T5 | Length of Time Accounts | Age of Oldest Trade | 8 | −20 to 30 | Plus or Minus |
| | have been Established. | | | | |
| T6 | Too Many Accounts with | Number of Open Trades with | 4 | −80 to 0 | Plus or Minus |
| | Balance | Balance>0 in the Last 12 Months | | | |
| T7 | Proportion of Balances to | Ratio of Total Balance to Total | 10 | −60 to 30 | Plus or Minus |
| | Credit Limits is to High on | High Credit for Revolving Trades, | | | |
| | Bank Revolving or Other | Reported in the Last 12 Months | | | |
| | Revolving Accounts | | | | |
| T8 | Trade Accounts | Number of Trades Opened in the | 8 | −20 to 0 | Plus or Minus |
| | | Last 6 Months | | | |
| T9 | High Radio Revolving Trades | Number of Bank Revolving | | −50 to 15 | Plus or Minus |
| | | Trades with Balance to High | | | |
| | | Credit Ratio >75%, Reported in | | | |
| | | the Last 6 Months | | | |
| T10 | Too Many Inquiries in the Last | Number of Inquiries in the Last | 7 | −25 to 25 | Plus or Minus |
| | 12 Months | 12 Months | | | |

| | |
|---|---|
| Total Score | Total |

The characterization of the consumer's credit performance is accomplished through an analysis and assessment method employed by CRIE. This is an iterative process that records the score, rating and condition for each trigger. Thus, the characterization step of the exemplary methods of the instant invention includes multiple analysis functions for multiple triggers. The score and conditions are stored in Meta data records and are used by CRIID in a preferred embodiment to populate information panels within the digital dashboard.

In a preferred embodiment, the first function performed during this characterization process, within CRE, is the analysis and assessment of the Trigger T1, “Derogatory Public Record or Collection Filed”. Within T1, records will be analyzed and assessed from events that are a matter of public record, such as bankruptcies, foreclosures, small claims judgments or tax liens. Table 3 displays the primary variable, intervals/tiers and weights associated with trigger T1-Derogatory Public Record or Collection Filed.

TABLE 3
Trigger T1
Trigger T1
Derogatory Public Record or Collection Filed

| | | | Weights |
|---|---|---|---|
| Primary Variable | Tiers | Intervals | (Points Impacted) |
| Number of Derogatory | 0 | Missing | 0 |
| Public Record and | 1 | 0 | 0 |
| Collection Items | 2 | 1 | −12 |
| | 3 | 2 | −22 |
| | 4 | 3 | −38 |
| | 5 | 4 | −50 |
| | 6 | 5 | −60 |
| | 7 | 6 | −70 |
| | 8 | 7 | −80 |
| | 9 | 8 or | −90 |
| | | More | |

The analysis and assessment of the T1 Trigger involves the use of the following variables: T1P=Points Impacted (Weight) or Trigger's Score, T1X=Total number of derogatory public record and collection items, T1Y=Positive opportunity tier for improving the number of derogatory public record and collection items, T1A=Negative opportunity tier for deterioration of number of derogatory public record and collection items, and T1D=Difference between T1P and T1Y, current points less previous tier points impacted.

To assess the points (T1P) and condition for trigger T1, the number of derogatory public records and collection items will be counted and recorded in the variable T1X, a tier will be selected based upon what interval range T1X falls within and T1P will then be assigned a value from tier's corresponding weight. To assess T1P the following steps are preformed by CRIE. If T1X's value is 8 or greater, then negative ninety (−90) points are assessed and the condition “Your current count of T1X public record derogatories and collection items is considered extremely high by most credit analyzing companies, and has an extremely large negative impact on your score” is assigned to the trigger. If T1X's value is 7, then negative eighty (−80) points are assessed and the condition “Your current count of 7 public record derogatories and collection items is considered extremely high by most credit analyzing companies, and has an extremely large negative impact on your score” is assigned to the trigger. If T1X's value is 6, then negative seventy (−70) points are assessed and the condition “Your current count of 6 public record derogatories and collection items is considered extremely high by most credit analyzing companies, and has an extremely large negative impact on your score” is assigned to the trigger. If T1X's value is 5, then negative sixty (−60) points are assessed and the condition “Your current count of 5 public record derogatories and collection items is considered extremely high by most credit analyzing companies, and has an extremely large negative impact on your score” is assigned to the trigger. If T1X's value is 4, then negative fifty (−50) points are assessed and the condition “Your current count of 4 public record derogatories and collection items is considered extremely high by most credit analyzing companies, and has an extremely large negative impact on your score” is assigned to the trigger. If T1X's value is 3, then negative thirty-eight (−38) points are assessed and the condition “Your current count of 3 public record derogatories and collection items is considered high by most credit analyzing companies, and has an large negative impact on your score” is assigned to the trigger.

If T1X's value is 2, then negative twenty-two (−22) points are assessed and the condition “Your current count of 2 public record derogatories and collection items is considered high by most credit analyzing companies, and has an large negative impact on your score” is assigned to the trigger. If VT1X value is 1, then negative twelve (−12) points are assessed and the condition “Your current count of 1 public record derogatory or collection item is considered moderate by most credit analyzing companies, and has an significant negative impact on your score” is assigned to the trigger. If VT1X value is 0, then Zero points are assessed and the condition “Your current count of 0 public record derogatories and collection items is considered good by most credit analyzing companies. At this time, your score is not affected by the total number trades public record derogatories and collection items” is assigned to the trigger.

In a preferred embodiment, the present invention includes the step of generating an action plan within the ICRECS system wherein the CRIE has compiled and analyzed all credit information and produces a customized comprehensive report, preferably referred to herein as the action plan, that includes various counseling recommendations, based upon the analysis and assessment performed in the characterization step, to assist the consumer and provide counseling to the consumer through a series of recommendations. Thus, the method of the present invention may include the additional step of reporting opportunities the consumer may have to affect their credit based upon a comprehensive analysis of the consumer's credit performance records. In the current embodiment, these opportunities are generated through a behavioral and trend analysis function of the present invention. The generation of an action plan as described herein in reference to Trigger T1 may be similar for all the Triggers analyzed and assessed by the current invention. Thus, for Trigger T1, and all Triggers analyzed by the present invention, credit counseling or behavioral coaching/counseling may be provided through an action plan based upon a behavioral and trend analysis. For trigger T1 the behavioral and trend analysis performed may result in the identification and examination of negative and positive opportunities, general recommendations and providing further credit counseling/education through educational links. In a preferred embodiment, education links provided by the ICRECS system direct the user into an ICRECS educational topical library.

A positive opportunity is the next tier level for improvement within a given trigger and a negative opportunity is the next tier level for deterioration within a given trigger. General recommendations may provide counseling on how the consumer may avoid future derogatory actions by avoiding specific actions or may provide specific recommendations for improving credit performance. The educational topical library may provide general education about credit ratings, scoring, the particular grouping and/or trigger reflected on an individual's credit report, and/or the positive or negative impacts that affect the consumer's credit rating.

Specific counseling regarding a consumer's credit performance, such as how to improve their credit rating, may be provided in various locations within the ICRECS system. For instance, the ICRECS educational topical library may contain relevant counseling information. Alternatively, the counseling information may be included with the presentation of certain information, such as the results of the analysis of various Triggers. It is contemplated that the counseling method of the current invention may further include the step of providing a single report that contains all the counseling information for a consumer's entire credit report analysis. Thus, the consumer may be directed to a specific “page” within the ICRECS system, and as stated above, wherein the CRIE has compiled and analyzed all credit information and produces a customized comprehensive report (action plan), that includes various counseling recommendations to assist the consumer and provide counseling to the consumer through a series of recommendations.

The recommendations provided through the generation of the action plan may be general in nature and/or specific to the trigger being analyzed and may be presented to the user in various ways.

Utilizing T1 by way of example, output of the analysis and assessment utilized to generate the action plan may further allow the ICRECS to provide assessment of positive opportunities and uses the formerly computed T1X variable to select the previous tier, which represents the next opportunity for improvement. To assess the positive opportunity for trigger T1, the following steps are performed by CRIE. If T1X's value is 8 or greater, then the next positive opportunity is: “Your current count of T1X public record derogatories and collection items is T1A over the previous tier. Once one of these is too old to remain on the credit report, and no new ones occur, your score will improve by T1D points.” It will be assigned to the trigger T1.

If T1X's value is 7, then the next positive opportunity is: “Your current count of 7 public record derogatories and collection items is 1 over the previous tier. Once one of these is too old to remain on the credit report, and no new ones occur, your score will improve by T1D points.” It will be assigned to the trigger T1. If T1X's value is 6, then the next positive opportunity is: “Your current count of 6 public record derogatories and collection items is 1 over the previous tier. Once one of these is too old to remain on the credit report, and no new ones occur, your score will improve by T1D points.” It will be assigned to the trigger T1. If T1X's value is 5, then the next positive opportunity is: “Your current count of 5 public record derogatories and collection items is 1 over the previous tier. Once one of these is too old to remain on the credit report, and no new ones occur, your score will improve by T1D points.” It will be assigned to trigger T1. If T1X's value is 4, then the next positive opportunity is: “Your current count of 4 public record derogatories and collection items is 1 over the previous tier. Once one of these is too old to remain on the credit report, and no new ones occur, your score will improve by T1D points.” It will be assigned to the trigger T1. If T1X's value is 3, then the next positive opportunity is: “Your current count of 3 public record derogatories and collection items is 1 over the previous tier. Once one of these is too old to remain on the credit report, and no new ones occur, your score will improve by T1D points.” It will be assigned to the trigger T1. If T1X's value is 2, then the next positive opportunity is: “Your current count of 2 public record derogatories and collection items is 1 over the previous tier. Once one of these is too old to remain on the credit report, and no new ones occur, your score will improve by T1D points.” It will be assigned to the trigger T1. If T1X's value is 1, then the next positive opportunity is: “Your current count of 1 public record derogatory and collection item is 1 over the previous tier. Once one of these is too old to remain on the credit report, and no new ones occur, your score will improve by T1D points.” It will be assigned to the trigger T1. If T1X's value is 0, then the next positive opportunity is: “Your current count of 0 public record derogatories or collection items is the lowest tier and you now receive the best points for this.” It will be assigned to the Trigger T1.

The output of the analysis and assessment utilized to generate the action plan may further allow the ICRECS to provide assessment of negative opportunities and may use the formerly computed T1X variable to select the next tier that represents the next opportunity for deterioration. To assess the negative opportunity for trigger T1, the following steps are performed by CRIE. If T1X's value is 0, then the next negative opportunity is: “Your current count of 0 public record derogatories and collection items is the best score for this.” It will be assigned to the trigger T1. If T1X's value is 1, then the next negative opportunity is: “You have 1 public record derogatory or collection item. You need to pay your bills before the due date or your score may decrease.” It will be assigned to the trigger T1. If T1X's value is 2, then the next negative opportunity is: “You have 2 public record derogatories and collection items. You need to pay your bills before the due date or your score may decrease.” It will be assigned to trigger T1. If T1X's value is 3, then the next negative opportunity is: “You have 3 public record derogatories and collection items. You need to pay your bills before the due date or your score may decrease.” It will be assigned to trigger T1. If T1X's value is 4, then the next negative opportunity is: “You have 4 public record derogatories and collection items. You need to pay your bills before the due date or your score may decrease.” It will be assigned to trigger T1. If T1X's value is 5, then the next negative opportunity is: “You have 5 public record derogatories and collection items. You need to pay your bills before the due date or your score may decrease.” It will be assigned to trigger T1. If T1X's value is 6, then the next negative opportunity is: “You have 6 public record derogatories and collection items. You need to pay your bills before the due date or your score may decrease.” It will be assigned to trigger T1. If T1X's value is 7, then the next negative opportunity is: “You have 6 public record derogatories and collection items. You need to pay your bills before the due date or your score may decrease.” It will be assigned to trigger T1. If T1X's value is 8 or more, then the next negative opportunity is capped and T1 will be assigned: “You have X public record derogatories and collection items. This is the most negative points you can receive.”

In addition to the positive and negative behaviors opportunities, general recommendations may be provided for trigger T1 if T1X is greater than zero. The general recommendation assigned to T1 is: “Avoid incurring derogatory public record items including foreclosure, civil and small claims judgments, foreclosure, paid or unpaid tax liens, bankruptcy, and paid or unpaid collection items. These remain on the credit report for at least seven years and are seen as very serious by most creditors. Chapter 13 Bankruptcy remains on the credit report for seven years from the filing date, while Chapter 7, 11 and 12 Bankruptcy remains for ten years. Though you may be able to get new credit even with some of these issues it may be at a high cost to you.” In addition to recommendations educational relative links are provided, preferably into the ICRECS educational topical library, for subject matter associated with derogatory public records and collection items. The general recommendation mentioned above, and the various other general recommendations that will be described below in relation to the various Triggers identified by the present invention, are not intended to be limited in the breadth and scope of counseling information they may provide.

Additional statements, recommendations, and/or steps that may be taken (“action steps”) may be generated from and presented through the action plan to the consumer. For example, the action plan may provide one or more of the following: “Identify accounts that presently are past due”; “Verify that past due status and amounts are correct”; “If not correct, notify the credit bureau and the appropriate creditor; “If correct, bring as many of the past due accounts to current status as possible given budgetary and other constraints”; “Keep credit accounts current and over time the negative impact of these items on credit will be reduced”; “Verify that the public record or collection information is correct as shown on the credit report”; “If not, contact the credit bureau and the appropriate creditor”; and “If correct, determine whether there is anything that can be done to otherwise satisfy or remove the public record or collection.” These various statements, recommendations, and/or action steps are exemplary and not intended to limit the scope of the current invention. The presentation, through the action plan, of various additional statements, recommendations, and/or action steps, as contemplated by those of ordinary skill in the art may be employed without departing from the scope and spirit of the present invention. It is contemplated that the statements, recommendations, and or action steps may be presented in a logical order, such as a sequential progression wherein a first statement follows another, however, various presentation orders and formats may be employed.

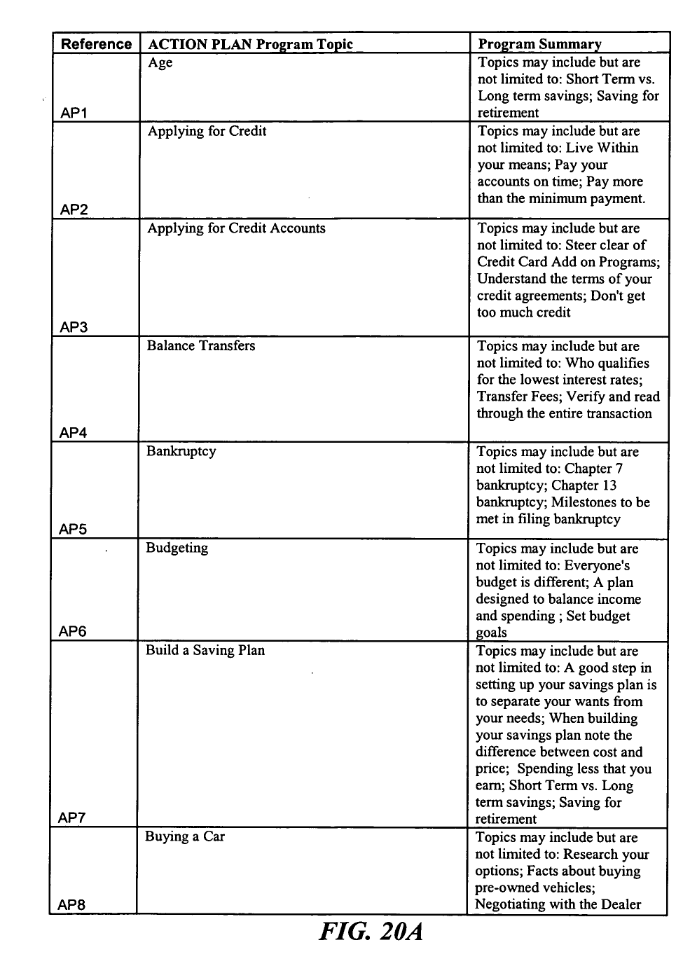

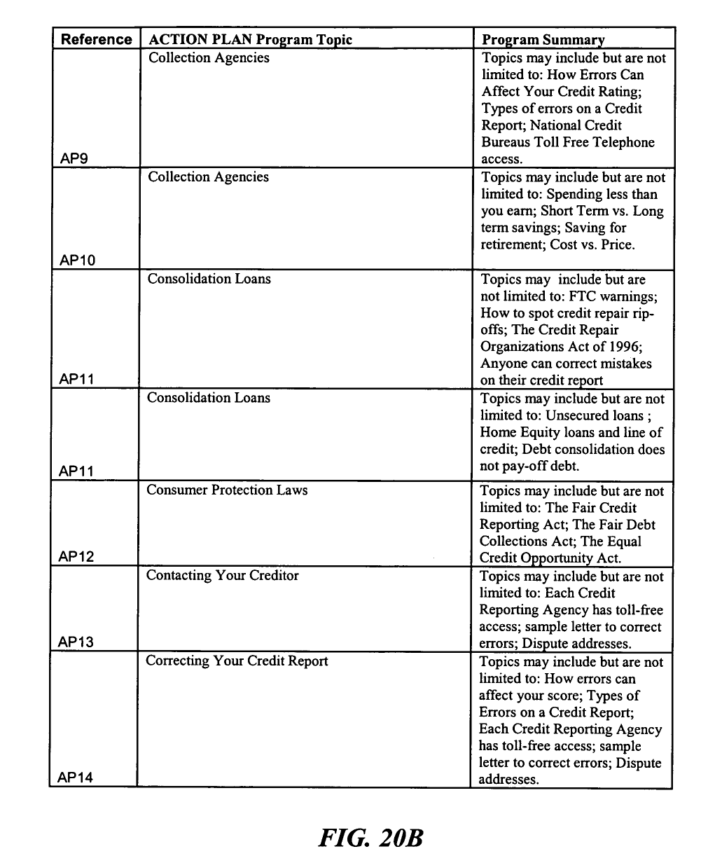

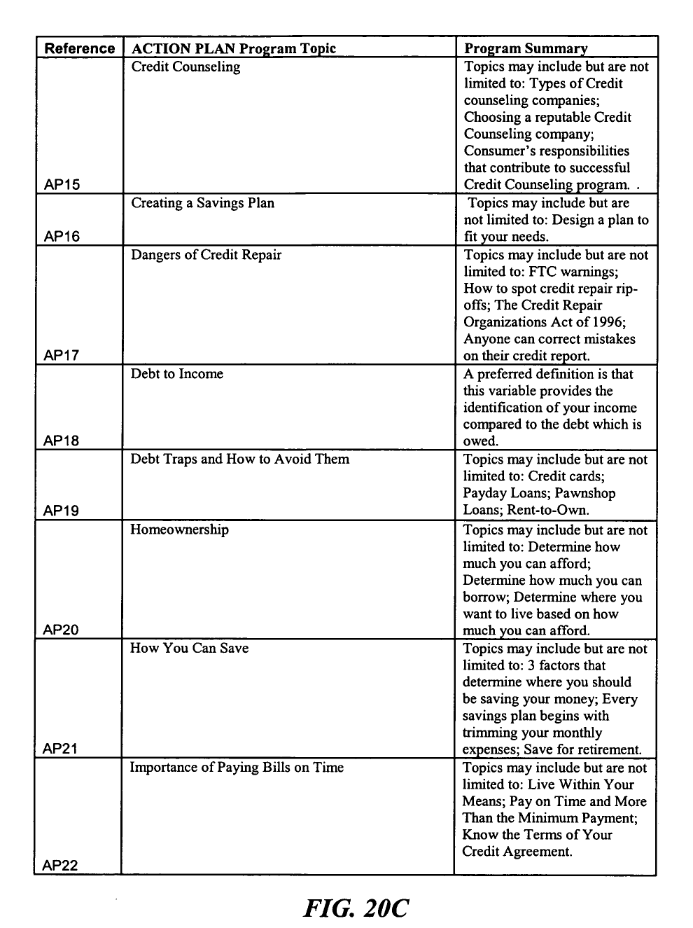

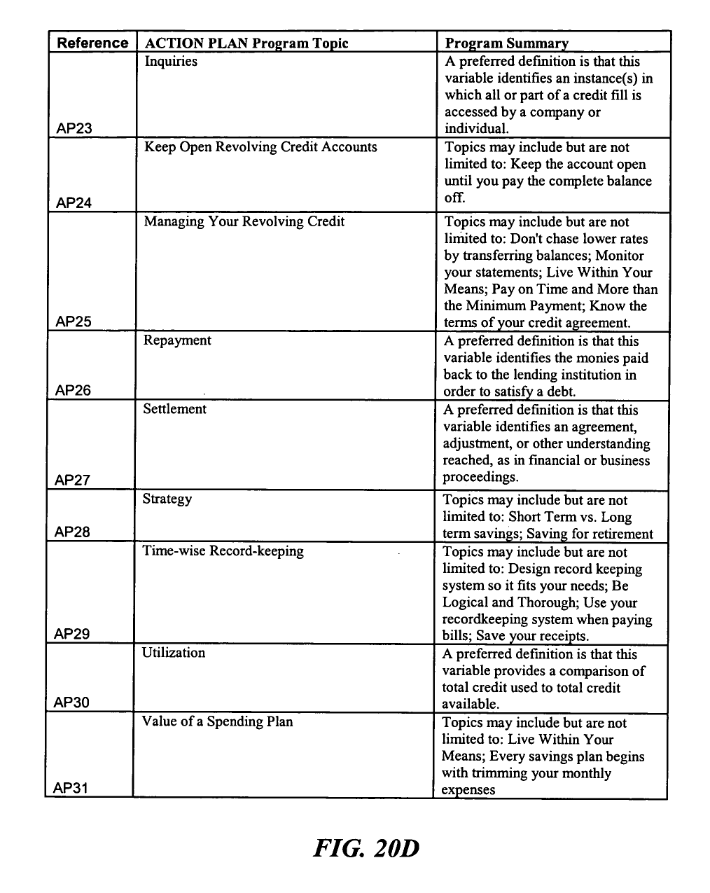

In addition to recommendations, educational relative links are provided to the ICRECS, preferably through the educational topical library, for subject matter associated with account delinquency. In a preferred embodiment, the links are assigned to the variable T1EL. For example, the action plan for T1 may provide the consumer access to the educational topical library, which may include access to various links/recommendations, such as: AP5, “Bankruptcy”; AP9, “Collection Agencies”; “AP10, “Collection Agencies”; AP11, “Consolidation Loans”; AP12, “Consumer Protection Laws”; AP13, “Contacting Your Creditor”; AP14, “Correcting Your Credit Report”; AP15, “Credit Counseling”; AP16, “Creating a Savings Plan”; AP 17, “Dangers of Credit Repair”; AP19, “Debt Traps and How to Avoid Them”; AP21, “How You Can Save”; AP25, “Managing Your Revolving Credit”; AP26, “Repayment”; AP27, “Settlement”; AP29, “Time-wise Record-keeping”; and AP31, “Value of a Spending Plan”, as shown in FIGS. 20A-D. It is contemplated that the action plan part of the method of the current invention may provide the consumer with various pieces of information. This information may be educational/counseling and/or general in nature, and may be organized and presented in any manner as is contemplated by those of ordinary skill in the art.

Another exemplary feature of the current invention is the identification and utilization of “Alerts”. Alerts represent an action taken by the ICRECS and provide the consumer a description of that action and what was discovered. The Alerts then provide the consumer with a recommended action to take based off what was found. Therefore, an Alert, for any of the various triggers, describes when a possible factor may change and what steps the consumer may take to realize a credit score improvement. In a preferred embodiment, the Alert for T1 is as follows:

| | | Associated | Technical | Consumer | Recommended |
|---|---|---|---|---|---|
| # | Name | Trigger | Action | Description | Action |
| 1 | Missing | T1 | This alert will | We have audited | Examine the data flagged |
| | payment | | scan the 24 | your payment history | in your credit report. If it |
| | information. | | month payment | and found that | is not accurate then it is |
| | | | history grid and | information is | recommended that you |
| | | | identify months | missing. Incomplete | contact the credit bureau |
| | | | that are missing | information may | and update your |
| | | | creditor | affect the accuracy of | information accordingly. |
| | | | information. | your ICRECS Credit | |
| | | | | Score. | |

It is contemplated that the Alert(s) provided may be associated with various Triggers, as shown in Table 1 or as further described below, and may further be associated with multiple Triggers. It is further contemplated that the Associated Trigger may provide additional descriptive language, which is generated by the current invention in response to the consumer's credit performance data. The Technical Action description may vary to align with the specific Trigger(s) and/or additional descriptive language that is/are being associated with the Alert. The Consumer Description provided may be general in nature or specific to the associated Trigger(s) and/or additional descriptive language. The Consumer Description may provide a restatement of a recommendation or AP variable or provide additional information, such as that shown above. The Recommended Action may include a specific action to take, wherein that action may be further reflected in the Action Plan. Alternatively, the recommended Action may provide additional actions that may be taken with respect to the particular Associated Trigger and/or additional descriptive language provided.

It is to be understood that the language provided above and the language which is presented below, in reference to the positive and negative opportunities and general recommendations associated with the various Triggers identified by the present invention is exemplary and not intended to limit the breadth and scope of counseling language that may be included and used by the present invention. For instance, the language used for counseling on a positive and/or negative opportunity may include further explanation of the Trigger information and/or other credit counseling information as may be contemplated by those of ordinary skill in the art. Alternatively, the general recommendations may include counseling information which relates to other Triggers and or identification of potential trends exhibited by the consumer's credit report. It is further understood that the presentation of this counseling information, for all of the various Triggers described in the instant specification, may be in various locations throughout the ICRECS system as previously described.

The analysis and assessment of the Trigger T2, “Time Since Delinquency is too Recent or Unknown”, is another functional feature of the characterization step performed by the ICRECS system in performance of the exemplary methods of the instant invention. Within T2, payment records and late payments records from creditors will be analyzed and assessed. Table 4 displays the primary variable, intervals/tiers and weights associated with trigger T2.

TABLE 4
Trigger T2
Trigger T2
Time Since Delinquency is too Recent or Unknown

| | | | Weights |
|---|---|---|---|
| | | | Points Impacted |
| Primary Variable (T2X) | Tiers | Intervals | (T2P) |
| Number of Months Since | 0 | No Trades | 0 |
| Last Delinquent Trade | 1 | No Delinquent | 30 |
| | | Trades | |
| | 2 | 0 to 1 month | −30 |
| | 3 | 2 to 3 months | −20 |
| | 4 | 4 to 6 months | −15 |
| | 5 | 7 to 12 months | −7 |
| | 6 | 13 to 30 months | −4 |
| | 7 | 31 or more months | 0 |

The analysis and assessment of the T2 Trigger involves the use of the following T2 variables: T2P=Points Impacted (Weights) or Score, T2X=Delinquency activity specified in months per trade line, T2A=Number of derogatory public record and collection items over last tier, T2Y=Number of derogatory public record and collection items before next tier, T2POP=Positive opportunity points for improving for delinquency, T2POCV=Positive opportunity counseling verbiage, T2NOP=Negative opportunity points for delinquency deterioration, T2NOCV=Negative opportunity counseling verbiage, T2D=Difference between current point impact and previous tier point impact. T2CV=Conditions verbiage, T2RV=Recommendations verbiage T2, T2EL=Educational Links, and T2AV=Alerts verbiage.

To compute T2P for trigger T2, the following steps are performed by CRIE. If T2X's value is 31 months or greater, then 0 points are assessed (T2P=0) and the condition “Your current count of T2X months since last delinquency is considered good by most credit analyzing companies, and has no negative impact on your score” is assigned to the variable T2CV. If T2X's value is 13 to 30 months, then −4 points are assessed (T2P=−4 points), and the condition “Your current count of T2X months since last delinquency is considered moderately negative by most credit analyzing companies, and has a small impact on your score” is assigned to the trigger (T2C). If T2X's value is between 7 and 12 months, then −7 points are assessed (T2P =−7), and the condition “Your current count of X months since last delinquency is considered recent by most credit analyzing companies, and has a significant negative impact on your score” is assigned to the trigger (T2C). If T2X's value is between 4 and 6 months, then −15 points are assessed (T2P=−15), and the condition “Your current count of X months since last delinquency is considered very recent by most credit analyzing companies, and has a very large negative impact on your score” is assigned to the trigger (T2C). If T2X's value is between 2 and 3 months, then −20 points are assessed (T2P=−20), and the condition “Your current count of X months since last delinquency is considered very recent by most credit analyzing companies, and has a very significant negative impact on your score” is assigned to the trigger (T2C). If T2X's value is between 0 to 1 months, then −30 points are assessed (T2P=−30), and the condition “Your current count of X months since last delinquency is considered extremely recent by credit analyzing companies, and has a very large negative impact on your score” is assigned to the trigger (T2C). If there are no records for T2 that have delinquent trades, then 0 points are assessed (T2P=0), and the condition “Your current count of no delinquent trades is considered very good by credit analyzing companies, and has a very positive impact on your score” is assigned to the trigger (T2C).

As stated previously, based upon the output of the analysis and assessment performed in the characterization step, an action plan may be generated. The recommendations provided through the generation of the action plan may be general in nature and/or specific to the trigger being analyzed and may be presented to the user in various ways.

In a preferred embodiment, utilizing T2, the output of the analysis and assessment utilized to generate the action plan may further allow the ICRECS to provide assessment of positive opportunities and use the formerly computed T2X variable to select the previous tier, which represents the next opportunity for improvement. To assess the positive opportunity for trigger T2, the following steps are performed by CRIE. If T2X's value is between 0 or 1, then the next positive opportunity (T2POCV) is: “You are T2Y months away from incurring a lower penalty on your score. By paying all your bills on time for T2Y months you will be able to increase your score.” It will be assigned to the trigger T2. If T2X's value is between 4 or 6, then the next positive opportunity counseling verbiage (T2POCV) is: “You are T2Y months away from incurring a lower penalty on your score. By paying all your bills on time for T2Y months you will be able to increase your score.” If T2X's value is between 7 or 12, then the next positive opportunity counseling verbiage (T2POCV) is: “You are T2Y months away from incurring a lower penalty on your score. By paying all your bills on time for T2Y months you will be able to increase your score.” If T2X's value is between 13 or 30, then the next positive opportunity counseling verbiage (T2POCV) is: “You are T2Y months away from incurring a lower penalty on your score. By paying all your bills on time for T2Y months you will be able to increase your score.” If T2X's value is greater than 31, then the next positive opportunity counseling verbiage (T2POCV) is: “Your current months since delinquency is X, which is at the highest end of the grading spectrum. You won't incur a penalty on your score unless you pay your bills late. Once all your delinquencies on your credit report are over 7 years old, they will no longer show on your credit report. At that time, you will get an additional 30 points for not having any delinquent trades.” If T2X's value is 0, no delinquent trades, then positive opportunity verbiage (T2POCV) is: “As your credit report doesn't show any delinquent trades in the past, you receive the most points and cannot incur larger points. Continue to pay your bills on time.”

The output of the analysis and assessment utilized to generate the action plan may further allow the ICRECS to provide assessment of negative opportunities using the formerly computed T2X variable. For the T2 Trigger, the following negative opportunity template will be used for all negative interval assessments: “You are T2X months from incurring a larger penalty on your score. By paying all your bills on time you will avoid a more negative impact on your score.” It will be assigned to T2NOCV.

In addition to the positive and negative behaviors opportunities, general recommendations are provided by the current invention for trigger T2 if T2X is greater than zero. The general recommendation counseling verbiage assigned to T2RCV is: “If you can't pay off all of your monthly bills on time you should make at least the minimum payments before the due dates so you do not have to pay late fees. If you are having trouble making payments you should not make any more purchases on your credit cards until you no longer have problems. If you had been late paying bills in the past, the more time that passes since you last paid late the better. Develop a strategy to pay your bills before the due date.”

It is further contemplated that additional statements, recommendations, and/or steps that may be taken (“action steps”) may be generated from and presented through the action plan to the consumer. For example, the action plan may provide one or more of the following: “Verify that the delinquency information shown on the credit report is correct”; “If not, contact the credit bureau and the appropriate creditor and request that the information be corrected”; “Otherwise, bring all past due accounts to current status and maintain accounts up-to-date in the future”; and “Over time the negative impact on the credit report will become less.” These various statements, recommendations, and/or action steps are exemplary and not intended to limit the scope of the current invention. The presentation, through the action plan, of various additional statements, recommendations, and/or action steps, as contemplated by those of ordinary skill in the art may be employed without departing from the scope and spirit of the present invention. It is contemplated that the statements, recommendations, and or action steps may be presented in a logical order, such as a sequential progression wherein a first statement follows another, however, various presentation orders and formats may be employed.

In addition to recommendations, educational relative links are provided to the ICRECS, preferably through the educational topical library, for subject matter associated with account Delinquency. In a preferred embodiment, the links are assigned to the variable T2EL. For example, the action plan for T2 may provide the consumer access to the educational topical library which may include access to various links/recommendations, such as: AP6, “Budgeting”; AP9, “Collection Agencies”; “AP10, “Collection Agencies”; AP11, “Consolidation Loans”; AP12, “Consumer Protection Laws”; AP13, “Contacting Your Creditor”; AP14, “Correcting Your Credit Report”; AP16, “Creating a Savings Plan”; AP17, “Dangers of Credit Repair”; AP19, “Debt Traps and How to Avoid Them”; AP21, “How You Can Save”; AP23, “Importance of Paying Bills on Time”; AP25, “Managing Your Revolving Credit”; AP26, “Repayment”; AP29, “Time-wise Record-keeping”; and AP31, “Value of a Spending Plan”, as shown in FIGS. 20A-D. It is contemplated that the action plan part of the method of the current invention may provide the consumer with various pieces of information. This information may be educational/counseling and/or general in nature, and may be organized and presented in any manner as is contemplated by those of ordinary skill in the art.

As mentioned previously, another exemplary feature of the current invention is the identification and utilization of “Alerts”. Alerts represent an action taken by the ICRECS and provide the consumer a description of that action and what was discovered. The Alerts then provide the consumer with a recommended action to take based off what was found. In a preferred embodiment, the Alert for T2 is as follows:

| | | Associated | | Consumer | Recommended |
|---|---|---|---|---|---|
| # | Name | Trigger | Technical Action | Description | Action |
| 2 | Payment | Number of | This alert will indicate | We have audited | Examine the data |
| | History | trades rated | that a tradelines 24 | your payment | flagged in your credit |
| | Major. | worst ever 90 | month payment history | history and found | report. If it is not |
| | | or more days | has more than two | that you have | accurate then it is |
| | | delinquent | delinquencies that are | multiple | recommended that you |
| | | | over 90 days past due. | delinquencies that | contact the credit bureau |
| | | | This information is | are over 90 days | and update your |
| | | | used to help determine | past due. | information accordingly. |
| | | | the rating of an account | | |
| | | | because the trigger is | | |
| | | | an aggregate. | | |

It is contemplated that the Alert(s) provided may be associated with various Triggers, as shown in Table 1 or as further described below, and may further be associated with multiple Triggers. It is further contemplated that the Associated Trigger may provide additional descriptive language, which is generated by the current invention in response to the consumer's credit performance data. The Technical Action description may vary to align with the specific Trigger(s) and/or additional descriptive language that is/are being associated with the Alert. The Consumer Description provided may be general in nature or specific to the associated Trigger(s) and/or additional descriptive language. The Consumer Description may provide a restatement of a recommendation or AP variable or provide additional information, such as that shown above. The Recommended Action may include a specific action to take, wherein that action may be further reflected in the Action Plan. Alternatively, the recommended Action may provide additional actions that may be taken with respect to the particular Associated Trigger and/or additional descriptive language provided.

The analysis and assessment of the Trigger T3, “Number of Accounts with Delinquency”, is another functional feature of the characterization step performed by the ICRECS system in performance of the exemplary methods of the instant invention.

Within T3, the number of trades that have a 30 or 60 day delinquent payment status will be analyzed and assessed. Table 5 displays the primary variable, intervals/tiers and weights associated with trigger T3.

TABLE 5
Trigger T3
Trigger T3
Number of Accounts with Delinquency

| | | | Weights |
|---|---|---|---|
| | | | Points |
| | | | Impacted |
| Primary Variable (T3X) | Tiers | Intervals | (T3P) |
| Number of Trades Rated | 0 | Missing | 0 |
| Worst Ever 30 or 60 Days | 1 | No | 0 |
| Delinquent | | Trades | |
| | 2 | 0 | 0 |
| | 3 | 1 | −4 |
| | 4 | 2 | −8 |
| | 5 | 3 | −12 |
| | 6 | 4 | −18 |
| | 7 | 5 | −28 |
| | 7 | 6 | −40 |
| | 7 | 7 or | −50 |
| | | More | |

The analysis and assessment of the T3 Trigger involves the use of the following T3 variables: T3P=Points Impacted (Weights) or Score, T3X=Delinquency activity specified as 30 or 60 days delinquent per trade line, T3Y=Number of months since last delinquency before next tier, T3POP=Positive opportunity points for improving for delinquency, which is the potential positive point impact when rating moves from a lower tier to a higher tier, T3POCV=Positive opportunity counseling verbiage, T3NOP=Negative opportunity points for delinquency deterioration, which is the potential negative point impact when rating moves from a higher tier to a lower tier, T3NOCV=Negative opportunity counseling verbiage, T3D=Difference between T3P and T3PO, current points less previous tier points impacted. T3CV=Conditions verbiage, T3RV=Recommendations verbiage T3, T3EL=Educational Links, and T3AV=Alerts verbiage.

To compute T3P for trigger T3, the following steps are performed by CRIE. If T3X's value is 7 or greater, then negative fifty-one (−51) points are assessed (T3P=−51) and the condition “Your current count of 7 trades rated 30 and/or 60 day highest delinquency is considered extremely high by most credit analyzing companies, and has an extremely large negative impact on your score” is assigned to the variable T3CV. If T3X's value is 6, then negative forty (−40) points are assessed (T3P=−40) and the condition “Your current count of 6 trades rated 30 and/or 60 day highest delinquency is considered very high by most credit analyzing companies, and has an very large negative impact on your score” is assigned to the variable T3CV. If T3X's value is 5, then negative twenty-eight (−28) points are assessed (T3P=−28) and the condition “Your current count of 5 trades rated 30 and/or 60 day highest delinquency is considered very high by most credit analyzing companies, and has an very large negative impact on your score” is assigned to the variable T3CV. If T3X's value is 4, then negative eighteen (−18) points are assessed (T3P=−18) and the condition “Your current count of 4 trades rated 30 and/or 60 day highest delinquency is considered very high by most credit analyzing companies, and has a very large negative impact on your score” is assigned to the variable T3CV. If T3X's value is 3, then negative twelve (−12) points are assessed (T3P=−12) and the condition “Your current count of 3 trades rated 30 and/or 60 day highest delinquency is considered high by most credit analyzing companies, and has a significant negative impact on your score” is assigned to the variable T3CV. If T3X's value is 2, then negative eight (−8) points are assessed (T3P=−8), and the condition “Your current count of 2 trades rated 30 and/or 60 day highest delinquency is considered moderate by most credit analyzing companies, and has a negative impact on your score” is assigned to the variable T3CV. If T3X's value is 1, then negative four (−4) points are assessed (T3P=−4), and the condition “Your current count of 1 trade rated 30 and/or 60 day highest delinquency is considered moderate by most credit analyzing companies, and has a negative impact on your score” is assigned to the variable T3CV. If T3X's value is 0, then zero points are assessed (T3P=0), there is no impact upon the score, and the condition “Your current count of 0 trades rated 30 and/or 60 day highest delinquency is considered neutral most credit analyzing companies, and has no impact on your score” is assigned to the variable T3CV.

Utilizing T3 by way of example, output of the analysis and assessment utilized to generate the action plan may further allow the ICRECS to provide assessment of positive opportunities and uses the formerly computed T3X variable to select the previous tier that represents the next opportunity for improvement. To assess the positive opportunity for trigger T3, the following steps are performed by CRIE. If T3X's value is 7 or greater, then the next positive opportunity counseling verbiage (T3POCV) is: “Your current count of T3X trades rated 30 and/or 60 day highest delinquency is A over the previous tier. Once the delinquency on A trades is seven years old, and no new trades become rated 30 and/or 60 day highest delinquency, your score will improve by T3POP points.” If T3X's value is 6, then the next positive opportunity counseling verbiage (T3POCV) is: “Your current count of 6 trades rated 30 and/or 60 day highest delinquency is 1 over the previous tier. Once the delinquency on 1 trade is seven years old, and no new trades become rated 30 and/or 60 day highest delinquency, your score will improve by 12 points.” If T3X's value is 5, then the next positive opportunity counseling verbiage (T3POCV) is: “Your current count of 5 trades rated 30 and/or 60 day highest delinquency is 1 over the previous tier. Once the delinquency on 1 trade is seven years old, and no new trades become rated 30 and/or 60 day highest delinquency, your score will improve by 10 points.” If T3X's value is 4, then the next positive opportunity counseling verbiage (T3POCV) is: “Your current count of 4 trades rated 30 and/or 60 day highest delinquency is 1 over the previous tier. Once the delinquency on 1 trade is seven years old, and no new trades become rated 30 and/or 60 day highest delinquency, your score will improve by 6 points.” If T3X's value is 3, then the next positive opportunity counseling verbiage (T3POCV) is: “Your current count of 3 trades rated 30 and/or 60 day highest delinquency is 1 over the previous tier. Once the delinquency on 1 trade is seven years old, and no new trades become rated 30 and/or 60 day highest delinquency, your score will improve by 4 points.” If T3X's value is 2, then the next positive opportunity counseling verbiage (T3POCV) is: “Your current count of 2 trades rated 30 and/or 60 day highest delinquency is 1 over the previous tier. Once the delinquency on 1 trade is seven years old, and no new trades become rated 30 and/or 60 day highest delinquency, your score will improve by 4 points.” If T3X's value is 1, then the next positive opportunity counseling verbiage (T3POCV) is: “Your current count of 1 trade rated 30 and/or 60 day highest delinquency is 1 over the previous tier. Once the delinquency on 1 trade is seven years old, and no new trades become rated 30 and/or 60 day highest delinquency, your score will improve by 4 points.” If T3X's value is 0, then the next positive opportunity counseling verbiage (T3POCV) is: “Your current count of 0 trades rated 30 and/or 60 day highest delinquency is the lowest tier and you now receive the best points for this trigger.”

The output of the analysis and assessment utilized to generate the action plan may further allow the ICRECS to provide assessment of negative opportunities and may use the formerly computed T3X variable to select the next tier that represents the next opportunity for deterioration. To assess the negative opportunity for trigger T3, the following steps are performed by CRIE. If T3X's value is 0, then the next negative opportunity is: “Your current count of 0 trades rated 30 and/or 60 day highest delinquency is the best score for this. Continue to pay your bills before the due date or your score will decrease.” It will be assigned to the trigger T3. If T3X's value is 1, then the next negative opportunity is: “You have 1 trade rated 30 and/or 60 day highest delinquency. You need to pay your bills before the due date or your score may decrease.” It will be assigned to the trigger T3. If T3X's value is 2, then the next negative opportunity is: “You have 2 trades rated 30 and/or 60 day highest delinquency. You need to pay your bills before the due date or your score may decrease.” It will be assigned to the trigger T3. If T3X's value is 3, then the next negative opportunity is: “You have 3 trades rated 30 and/or 60 day highest delinquency. You need to pay your bills before the due date or your score may decrease.” It will be assigned to the trigger T3. If T3X's value is 4, then the next negative opportunity is: “You have 4 trades rated 30 and/or 60 day highest delinquency. You need to pay your bills before the due date or your score may decrease.” It will be assigned to the trigger T3. If T3X's value is 5, then the next negative opportunity is: “You have 5 trades rated 30 and/or 60 day highest delinquency. You need to pay your bills before the due date or your score may decrease.” It will be assigned to the trigger T3. If T3X's value is 6, then the next negative opportunity is: “You have 6 trades rated 30 and/or 60 day highest delinquency. You need to pay your bills before the due date or your score may decrease.” It will be assigned to the trigger T3. If T3X's value is 7 or more, then the next negative opportunity is: “You have X trades rated 30 and/or 60 day highest delinquency. You receive the most negative points for this now. You need to pay your bills before the due date in order to improve your score in the future.” It will be assigned to the trigger T3.

In addition to the positive and negative behaviors opportunities, general recommendations are provided for trigger T3 if T3X is greater than zero. The general recommendation counseling verbiage assigned to T2RCV is: “If you can't pay off all of your monthly bills on time you should make at least the minimum payments before the due dates so you do not have to pay late fees. If you are having trouble making payments you should not make any more purchases on your credit cards until you no longer have problems. If you had been late paying bills in the past, try not to be more delinquent on any trade than you have ever been on it in the last seven years. That is, if you were 30 days past due on a trade but never 60 days past due on it then try to never be 60 days past due on it in he future. If you were 60 days past due on a trade in the past but never were 90 days past due then try to never pay that trade any later than 60 days late in the future.”

Additional statements, recommendations, and/or steps that may be taken (“action steps”) may be generated from and presented through the action plan to the consumer. For example, the action plan may provide one or more of the following: “Verify that the payment status is correct for all accounts shown on the credit report”; “If not, contact the credit bureau and the appropriate creditor”; “If correct, bring as many of the past due accounts to current status as possible given budgetary and other constraints”; and “Keep credit accounts current and over time the negative impact of these items on credit will be reduced”. These various statements, recommendations, and/or action steps are exemplary and not intended to limit the scope of the current invention. The presentation, through the action plan, of various additional statements, recommendations, and/or action steps, as contemplated by those of ordinary skill in the art may be employed without departing from the scope and spirit of the present invention. It is contemplated that the statements, recommendations, and or action steps may be presented in a logical order, such as a sequential progression wherein a first statement follows another, however, various presentation orders and formats may be employed.

In addition to recommendations, educational relative links are provided to the ICRECS, preferably through the educational topical library, for subject matter associated with account Delinquency. In a preferred embodiment, the links are assigned to the variable T3EL. For example, the action plan for T3 may provide the consumer access to the educational topical library which may include access to various links/recommendations, such as: AP4, “Balance Transfers”; AP6, “Budgeting”; AP9, “Collection Agencies”; “AP10, “Collection Agencies”; AP11, “Consolidation Loans”; AP12, “Consumer Protection Laws”; AP13, “Contacting Your Creditor”; AP14, “Correcting Your Credit Report”; AP17, “Dangers of Credit Repair”; AP19, “Debt Traps and How to Avoid Them”; AP25, “Managing Your Revolving Credit”; AP26, “Repayment”; AP29, “Time-wise Record-keeping”; and AP31, “Value of a Spending Plan”, as shown in FIGS. 20A-D. It is contemplated that the action plan part of the method of the current invention may provide the consumer with various pieces of information. This information may be educational/counseling and/or general in nature, and may be organized and presented in any manner as is contemplated by those of ordinary skill in the art.

As mentioned previously, another exemplary feature of the current invention is the identification and utilization of “Alerts”. Alerts represent an action taken by the ICRECS and provide the consumer a description of that action and what was discovered. The Alerts then provide the consumer with a recommended action to take based off what was found. In a preferred embodiment, the Alert for T3 is as follows:

| | | Associated | Technical | Consumer | Recommended |
|---|---|---|---|---|---|
| # | Name | Trigger | Action | Description | Action |
| 3 | Payment | Number of | This alert will | We have audited | Examine the data flagged |
| | History | trades rated | indicate that a | your payment | in your credit report. If it |
| | Minor | worst ever 30 to | tradelines 24 month | history and found | is not accurate then it is |
| | | 60 or more days | payment history has | that you have | recommended that you |
| | | delinquent | more than two | multiple | contact the credit bureau |
| | | | delinquencies that | delinquencies that | and update your |
| | | | are under 60 days | are under 60 days | information accordingly. |
| | | | past due. | past due. | |

It is contemplated that the Alert(s) provided may be associated with various Triggers, as shown in Table 1 or as further described below, and may further be associated with multiple Triggers. It is further contemplated that the Associated Trigger may provide additional descriptive language, which is generated by the current invention in response to the consumer's credit performance data. The Technical Action description may vary to align with the specific Trigger(s) and/or additional descriptive language that is/are being associated with the Alert. The Consumer Description provided may be general in nature or specific to the associated Trigger(s) and/or additional descriptive language. The Consumer Description may provide a restatement of a recommendation or AP variable or provide additional information, such as that shown above. The Recommended Action may include a specific action to take, wherein that action may be further reflected in the Action Plan. Alternatively, the recommended Action may provide additional actions that may be taken with respect to the particular Associated Trigger and/or additional descriptive language provided.

The analysis and assessment of the Trigger T4, “Number of Accounts with Delinquency”, is another functional feature of the characterization step performed by the ICRECS system in performance of the exemplary methods of the instant invention. Within T4, the number of trades that have a 90 or more day delinquent payment status (including Trade Derogatories) will be analyzed and assessed. Table 6 displays the primary variable, intervals/tiers and weights associated with trigger T4.

TABLE 6
Trigger T4
Trigger T4
Serious Delinquency

| | | | Weight Points |
|---|---|---|---|
| Primary Variable (T4X) | Tiers | Intervals | Impacted (T4P) |
| Number of Trades Rated Worst | 0 | Missing | 0 |
| Ever 90 or more Days Delinquent | 1 | No Trades | 0 |
| (including Trade Derogatories) | 2 | 0 | 0 |
| | 3 | 1 | −12 |
| | 4 | 2 | −22 |
| | 5 | 3 | −38 |
| | 6 | 4 | −50 |
| | 7 | 5 | −60 |
| | 8 | 6 | −70 |
| | 9 | 7 | −80 |
| | 10 | 8 or More | −90 |

The analysis and assessment of the T4 Trigger involves the use of the following T4 variables: T4P=Points Impacted (Weight) or Score, T4X=Delinquency activity specified as 90 or more days delinquent per trade line, T4A=Number of trades rated 90 or more days highest delinquency or derogatory trade items over last tier, T4POP=Positive opportunity points for improving for delinquency, which is the potential positive point impact when rating moves from a lower tier to a higher tier, T4POCV=Positive opportunity counseling verbiage, T4NOP=Negative opportunity points for delinquency deterioration, which is the potential negative point impact when rating moves from a higher tier to a lower tier, T4NOCV=Negative opportunity counseling verbiage, T4D=Difference between T4P and T4PO, current points less previous tier points impacted. T4CV=Conditions verbiage, T4RV=Recommendations verbiage T4, T4EL=Educational Links, and T4AV=Alerts verbiage.

To compute T4P for trigger T4, the following steps are performed by CRIE. If T4X's value is 8 or greater, then negative ninety (−90) points are assessed (T4P=−90) and the condition “Your current count of X trades rated 90 or more days highest delinquency including trade derogatories is considered extremely high by most credit analyzing companies, and has an extremely large negative impact on your score” is assigned to the variable T4CV. If T4X's value is 7, then negative eighty (−80) points are assessed (T4P=−80) and the condition “Your current count of 7 trades rated 90 or more days highest delinquency including trade derogatories is considered extremely high by most credit analyzing companies, and has an extremely large negative impact on your score” is assigned to the variable T4CV. If T4X's value is 6, then negative seventy (−70) points are assessed (T4P=−70) and the condition “Your current count of 6 trades rated 90 or more days highest delinquency including trade derogatories is considered extremely high by most credit analyzing companies, and has an extremely large negative impact on your score” is assigned to the variable T4CV. If T4X's value is 5, then negative sixty (−60) points are assessed (T4P=−60) and the condition “Your current count of 5 trades rated 90 or more days highest delinquency including trade derogatories is considered extremely high by most credit analyzing companies, and has an extremely large negative impact on your score” is assigned to the variable T4CV. If T4X's value is 4, then negative fifty (−50) points are assessed (T4P=−50) and the condition “Your current count of 4 trades rated 90 or more days highest delinquency including trade derogatories is considered extremely high by most credit analyzing companies, and has an extremely large negative impact on your score” is assigned to the variable T4CV. If T4X's value is 3, then negative thirty-eight (−38) points are assessed (T4P=−38) and the condition “Your current count of 3 trades rated 90 or more days highest delinquency including trade derogatories is considered high by most credit analyzing companies, and has a large negative impact on your score” is assigned to the variable T4CV. If T4X's value is 2, then negative twenty-two (−22) points are assessed (T4P=−22) and the condition “Your current count of 2 trades rated 90 or more days highest delinquency including trade derogatories is considered high by most credit analyzing companies, and has a large negative impact on your score” is assigned to the variable T4CV. If T4X's value is 1, then negative twelve (−12) points are assessed (T4P=−12) and the condition “Your current count of 1 trade rated 90 or more days highest delinquency including trade derogatories is considered high by most credit analyzing companies, and has a large negative impact on your score” is assigned to the variable T4CV. If T4X's value is 0, then this trigger has no impact upon your score as zero points are assessed (T4P=0) and the condition, “Your current count of 0 trades rated 90 or more days highest delinquency including trade derogatories is considered good by most credit analyzing companies. At this time, your score is not affected by the total number trades rated 90 or more days highest delinquency including trade derogatories” is assigned to the variable T4CV.

Utilizing T4, output of the analysis and assessment utilized to generate the action plan may further allow the ICRECS to provide assessment of positive opportunities and uses the formerly computed T4X variable to select the previous tier which represents the next opportunity for improvement. To assess the positive opportunity for trigger T4, the following steps are performed by CRIE. If T4X's value is 8 or greater, then the next positive opportunity counseling verbiage (T4POCV) is: “Your current count of T4X trades rated 90 or more day highest delinquency or trade derogatory is A over the previous tier. Once the delinquency/derogatory on a trade is seven years old, and no new trades become rated this delinquency, your score will improve by T4POP points.” If T4X's value is 7, then the next positive opportunity counseling verbiage (T4POCV) is: “Your current count of 7 trades rated 90 or more day highest delinquency or trade derogatory is 1 over the previous tier. Once the delinquency/derogatory on 1 trade is seven years old, and no new trades become rated this delinquency, your score will improve by 10 points.” If T4X's value is 6, then the next positive opportunity counseling verbiage (T4POCV) is: “Your current count of 6 trades rated 90 or more day highest delinquency or trade derogatory is 1 over the previous tier. Once the delinquency/derogatory on 1 trade is seven years old, and no new trades become rated this delinquency, your score will improve by 10 points.” If T4X's value is 5, then the next positive opportunity counseling verbiage (T4POCV) is: “Your current count of 5 trades rated 90 or more day highest delinquency or trade derogatory is 1 over the previous tier. Once the delinquency/derogatory on 1 trade is seven years old, and no new trades become rated this delinquency, your score will improve by 10 points.” If T4X's value is 4, then the next positive opportunity counseling verbiage (T4POCV) is: “Your current count of 4 trades rated 90 or more day highest delinquency or trade derogatory is 1 over the previous tier. Once the delinquency/derogatory on 1 trade is seven years old, and no new trades become rated this delinquency, your score will improve by 12 points.” If T4X's value is 3, then the next positive opportunity counseling verbiage (T4POCV) is: “Your current count of 3 trades rated 90 or more day highest delinquency or trade derogatory is 1 over the previous tier. Once the delinquency/derogatory on 1 trade is seven years old, and no new trades become rated this delinquency, your score will improve by 16 points.” If T4X's value is 2, then the next positive opportunity counseling verbiage (T4POCV) is: “Your current count of 2 trades rated 90 or more day highest delinquency or trade derogatory is 1 over the previous tier. Once the delinquency/derogatory on 1 trade is seven years old, and no new trades become rated this delinquency, your score will improve by 10 points.” If T4X's value is 1, then the next positive opportunity counseling verbiage (T4POCV) is: “Your current count of 1 trades rated 90 or more day highest delinquency or trade derogatory is 1 over the previous tier. Once the delinquency/derogatory on 1 trade is seven years old, and no new trades become rated this delinquency, your score will improve by 12 points.” If T4X's value is 0, then the next positive opportunity counseling verbiage (T4POCV) is: “Your current count of 0 trades rated 90 or more day highest delinquency or derogatory is the lowest tier and you now receive the best points for this.”

The output of the analysis and assessment utilized to generate the action plan may further allow the ICRECS to provide assessment of negative opportunities and may use the formerly computed T4X variable to select the next tier that represents the next opportunity for deterioration. To assess the negative opportunity for trigger T4, the following steps are performed by CRIE. If T4X's value is 0, then the next negative opportunity is: “Your current count of 0 trades rated 90 or more day highest delinquency/derogatory is the best score for this. Continue to pay your bills before the due date or your score will decrease.” It will be assigned to the trigger T4. If T4X's value is 1, then the next negative opportunity is: “You have 1 trade rated 90 or more day highest delinquency/derogatory. You need to pay your bills before the due date or your score may decrease.” It will be assigned to the trigger T4. If T4X's value is 2, then the next negative opportunity is: “You have 2 trades rated 90 or more day highest delinquency/derogatory. You need to pay your bills before the due date or your score may decrease.” It will be assigned to the trigger T4. If T4X's value is 3, then the next negative opportunity is: “You have 3 trades rated 90 or more day highest delinquency/derogatory. You need to pay your bills before the due date or your score may decrease.” It will be assigned to the trigger T4. If T4X's value is 4, then the next negative opportunity is: “You have 4 trades rated 90 or more day highest delinquency/derogatory. You need to pay your bills before the due date or your score may decrease.” It will be assigned to the trigger T4. If T4X's value is 5, then the next negative opportunity is: “You have 5 trades rated 90 or more day highest delinquency/derogatory. You need to pay your bills before the due date or your score may decrease.” It will be assigned to the trigger T4. If T4X's value is 6, then the next negative opportunity is: “You have 6 trades rated 90 or more day highest delinquency/derogatory. You need to pay your bills before the due date or your score may decrease.” It will be assigned to the trigger T4. If T4X's value is 7, then the next negative opportunity is: “You have 7 trades rated 90 or more day highest delinquency/derogatory. You need to pay your bills before the due date or your score may decrease.” It will be assigned to the trigger T4. If T4X's value is 8 or more, then the next negative opportunity is: “You have X trades rated 90 or more day highest delinquency/derogatory. This is the most negative points you can receive.” It will be assigned to the trigger T4.

In addition to the positive and negative behaviors opportunities, general recommendations are provided for trigger T4 if T4X is greater than zero. The general recommendation counseling verbiage assigned to T4RCV is: “If you had been late paying bills in the past, try not to be more delinquent on any trade than you have ever been on it in the last seven years. That is, if you were 60 days past due on a trade but never 90 days past due on it then try to never be 90 days past due on it in he future. Automobiles are often repossessed at 60 days past due so be sure to never let your car loan payment get that far past due.”

Additional statements, recommendations, and/or steps that may be taken (“action steps”) may be generated from and presented through the action plan to the consumer. For example, the action plan may provide one or more of the following: “Verify that the public record or collection information is correct as shown on the credit report”; “If not, contact the credit bureau and the appropriate creditor”; “If correct, determine whether there is anything that can be done to otherwise satisfy or remove the public record or collection item”; “Keep the credit accounts current and over time the negative impact of these items on credit will be reduced”; “Verify that the payment status and any delinquent amounts are correct for all accounts shown on the credit report”; “If not, contact the credit bureau and the appropriate creditor”; “If correct, bring as many of the past due accounts to current status as possible given budgetary and other constraints”; “If correct, determine what can be done to reduce or eliminate the delinquency status on delinquent accounts”; and “In the future, attempt to maintain all accounts in a current status.” These various statements, recommendations, and/or action steps are exemplary and not intended to limit the scope of the current invention. The presentation, through the action plan, of various additional statements, recommendations, and/or action steps, as contemplated by those of ordinary skill in the art may be employed without departing from the scope and spirit of the present invention. It is contemplated that the statements, recommendations, and or action steps may be presented in a logical order, such as a sequential progression wherein a first statement follows another, however, various presentation orders and formats may be employed.

In addition to recommendations, educational relative links are provided to the ICRECS, preferably through the educational topical library, for subject matter associated with account Delinquency. In a preferred embodiment, the links are assigned to the variable T4EL. For example, the action plan for T4 may provide the consumer access to the educational topical library which may include access to various links/recommendations, such as: AP5, “Bankruptcy”; AP6, “Budgeting”; AP7, “Build a Saving Plan”; AP9, “Collection Agencies”; “AP10, “Collection Agencies”; AP11, “Consolidation Loans”; AP12, “Consumer Protection Laws”; AP13, “Contacting Your Creditor”; AP14, “Correcting Your Credit Report”; AP15, “Credit Counseling”; AP17, “Dangers of Credit Repair”; AP19, “Debt Traps and How to Avoid Them”; AP25, “Managing Your Revolving Credit”; AP26, “Repayment”; and AP27, “Settlement”, as shown in FIGS. 20A-D. It is contemplated that the action plan part of the method of the current invention may provide the consumer with various pieces of information. This information may be educational/counseling and/or general in nature, and may be organized and presented in any manner as is contemplated by those of ordinary skill in the art.

As mentioned previously, another exemplary feature of the current invention is the identification and utilization of “Alerts”. Alerts represent an action taken by the ICRECS and provide the consumer a description of that action and what was discovered. The Alerts then provide the consumer with a recommended action to take based off what was found. In a preferred embodiment, the Alert for T2 is as follows:

| | | Associated | Technical | Consumer | Recommended |
|---|---|---|---|---|---|
| # | Name | Trigger | Action | Description | Action |
| 4 | Account | | This flag will notify | We have audited your | Examine the data flagged |
| | Not | | the consumer that | accounts and found | in your credit report. If it |
| | Reported | | the creditor has not | that the following | is not accurate then it is |
| | Recently | | reported any | credit has not reported | recommended that you |
| | | | information on the | any information to the | contact the credit bureau |
| | | | tradeline within 6 | credit bureau within | and update your |
| | | | months. When the | the last six months. | information accordingly. |
| | | | creditor does not | Failure to report this | Otherwise, a good way to |
| | | | report any | information excludes | ensure that creditors |
| | | | information then | this account from | report data to the credit |
| | | | the tradeline is | being included in your | bureaus is to periodically |
| | | | automatically | ICRECS Credit Score. | use the account. |
| | | | excluded from | Depending on the | |
| | | | being scored. | status of this account it | |
| | | | | could help or hurt your | |
| | | | | score. | |

It is contemplated that the Alert(s) provided may be associated with various Triggers, as shown in Table 1 or as further described below, and may further be associated with multiple Triggers. It is further contemplated that the Associated Trigger may provide additional descriptive language, which is generated by the current invention in response to the consumer's credit performance data. The Technical Action description may vary to align with the specific Trigger(s) and/or additional descriptive language that is/are being associated with the Alert. The Consumer Description provided may be general in nature or specific to the associated Trigger(s) and/or additional descriptive language. The Consumer Description may provide a restatement of a recommendation or AP variable or provide additional information, such as that shown above. The Recommended Action may include a specific action to take, wherein that action may be further reflected in the Action Plan. Alternatively, the recommended Action may provide additional actions that may be taken with respect to the particular Associated Trigger and/or additional descriptive language provided.

The analysis and assessment of the Trigger T5, “Length Of Time Accounts Have Been Established”, is another functional feature of the characterization step performed by the ICRECS system in performance of the exemplary methods of the instant invention. Within T5, the age of oldest trade will be analyzed and assessed. Table 7 displays the primary variable, intervals/tiers and weights associated with trigger T5.

TABLE 7
Trigger T5
Trigger T5
Length of Time Accounts have been Established.

| | | | Weights |
|---|---|---|---|
| | | | Points |
| | | | Impacted |
| Primary Variable (T5X) | Tiers | Intervals | (T5P) |
| Age of Oldest Trade | 0 | Missing | 0 |
| | 1 | No Trades | 0 |
| | 2 | 0 to 24 | −20 |
| | | months | |
| | 3 | 25 to 60 | −10 |
| | | months | |
| | 4 | 61 to 96 | 0 |
| | | months | |
| | 5 | 97 to 144 | 10 |
| | | months | |
| | 6 | 145 to 180 | 15 |
| | | months | |
| | 7 | 181 to 240 | 20 |
| | | months | |
| | 8 | 241 or more | 30 |
| | | months | |

The analysis and assessment of the T5 Trigger involves the use of the following T5 variables: T5P=Points Impacted (Weights) or Score, T5X=Delinquency activity specified as 90 or more days delinquent per trade line, T5Y=Age of oldest trade before next tier, T5Z=Age of next oldest trade; T5POP=Positive opportunity points for improving for delinquency, which is the potential positive point impact when rating moves from a lower tier to a higher tier, T5POCV=Positive opportunity counseling verbiage, T5NOP=Negative opportunity points for delinquency deterioration, which is the potential negative point impact when rating moves from a higher tier to a lower tier, T5NOCV=Negative opportunity counseling verbiage, T5D=Difference between current point impact and next tier point impact. T5CV=Conditions verbiage, T5RV=Recommendations verbiage T5, T5EL=Educational Links, and T5AV=Alerts verbiage.

To compute T5P for trigger T5, the following steps are performed by CRIE. If T5X's value is 241 months or greater (last tier), then thirty (30) points are assessed (T5P=30) and the condition “Your oldest trade date is considered very established by most credit analyzing companies, and has a very large positive impact on your score” is assigned to the variable T5CV. If T5X's value is 181 to 240 months, then twenty (20) points are assessed (T5P=20) and the condition “Your oldest trade date is considered very established by most credit analyzing companies, and has a very large positive impact on your score” is assigned to the variable T5CV. If T5X's value is 145 to 180 months, then fifteen (15) points are assessed (T5P=15) and the condition “Your oldest trade date is considered established by most credit analyzing companies, and has a very positive impact on your score” is assigned to the variable T5CV. If T5X's value is 97 to 144 months, then ten (10) points are assessed (T5P=10) and the condition “Your oldest trade date is considered established by most credit analyzing companies, and has a significant positive impact on your score” is assigned to the variable T5CV. If T5X's value is 61 to 96 months, then zero points are assessed (T5P=0) and the condition “Your oldest trade date is considered moderate by most credit analyzing companies, and has no positive or negative impact on your score” is assigned to the variable T5CV. If T5X's value is 25 to 60 months, then negative ten (−10) points are assessed (T5P=−10) and the condition “Your oldest trade date is considered recent by most credit analyzing companies, and has a significant negative impact on your score” is assigned to the variable T5CV. If T5X's value is 0 to 24 months, then negative twenty (−20) points are assessed (T5P=−20) and the condition “Your oldest trade date is considered very recent by most credit analyzing companies, and has a very large negative impact on your score” is assigned to the variable T5CV.

Utilizing T5, output of the analysis and assessment utilized to generate the action plan may further allow the ICRECS to provide assessment of positive opportunities and uses the formerly computed T5X variable to select the previous tier that represents the next opportunity for improvement. To assess the positive opportunity for trigger T5, the following steps are performed by CRIE. If T5X's value is 0 to 24 months, then the next positive opportunity counseling verbiage (T5POCV) is: “In Y months, you're oldest trade will be more than two years old, then the impact on your score will improve by D1.” If T5X's value is 25 to 60 months, then the next positive opportunity counseling verbiage (T5POCV) is: “In Y months, you're oldest trade will be more than five years old, then the impact on your score could improve by D1.” If T5X's value is 181 to 240 months, then the next positive opportunity counseling verbiage (T5POCV) is: “In Y months, you're oldest trade will be more than twenty years old, then the impact on your score could improve by D12.” If T5X's value is 241 or greater months, then the next positive opportunity counseling verbiage (T5POCV) is: “As your current oldest trade is X, which is at the highest end of the grading spectrum, you cannot incur a larger points with additional time.”

The output of the analysis and assessment utilized to generate the action plan may further allow the ICRECS to provide assessment of negative opportunities and may use the formerly computed T5X variable to select the next tier that represents the next opportunity for deterioration. To assess the negative opportunity for trigger T5, the following steps are performed by CRIE. If T5X's value is between 25 and 60 months, then the next negative opportunity is: “Your second oldest trade is Z months old. Do not close your oldest trade or you may move to a lower score category and reduce your score.” It will be assigned to the trigger T5. If T5X's value is between 25 and 60 months, then the next negative opportunity is: “Your second oldest trade is Z months old. Do not close your oldest trade or you may move to a lower score category and reduce your score.” It will be assigned to the trigger T5. If T5X's value is between 181 and 240 months, then the next negative opportunity is: “Your second oldest trade is Z months old. Do not close your oldest trade or you may move to a lower score category and reduce your score.” It will be assigned to the trigger T5. If T5X's value is 241 or greater months, then the next negative opportunity is: “Your second oldest trade is Z months old. Do not close your oldest trade or you may move to a lower score category and reduce your score.” It will be assigned to the trigger T5.

In addition to the positive and negative behaviors opportunities, general recommendations are provided for trigger T5 if T5X is greater than zero. The general recommendation counseling verbiage assigned to T5RCV is: “Your oldest trade considered an important indicator of risk. Your oldest trade is currently as old as it can be and you would like to let it get older. Do not close your oldest trade or you may move to a lower score category and reduce your score.”

Additional statements, recommendations, and/or steps that may be taken (“action steps”) may be generated from and presented through the action plan to the consumer. For example, the action plan may provide one or more of the following: “To the extent possible, verify that the account open dates as shown on the credit report are correct”; “If not, contact the credit bureau and the appropriate creditor”; “Otherwise, continue to use and maintain existing accounts”; “Over time, the credit history will exhibit the duration and stability that creditors are looking for”; “Verify that the credit bureau correctly shows all existing revolving accounts correctly and that the ‘date opened’ is correctly listed”; If one or more accounts are not shown on the credit bureau, or if the date opened is incorrect or missing, contact the credit bureau and the appropriate creditor and request that the relevant information be reported”; “Continue using (and paying) existing revolving accounts and, over time, more experience will be established with these accounts at the credit bureau”; “In general, try not to open too many new credit accounts in a short time period”; and “If possible, use already existing credit or ask for a credit line increase for an existing account rather than opening a new account.” These various statements, recommendations, and/or action steps are exemplary and not intended to limit the scope of the current invention. The presentation, through the action plan, of various additional statements, recommendations, and/or action steps, as contemplated by those of ordinary skill in the art may be employed without departing from the scope and spirit of the present invention. It is contemplated that the statements, recommendations, and or action steps may be presented in a logical order, such as a sequential progression wherein a first statement follows another, however, various presentation orders and formats may be employed.

In addition to recommendations, educational relative links are provided to the ICRECS, preferably through the educational topical library, for subject matter associated with account Delinquency. In a preferred embodiment, the links are assigned to the variable T5EL. For example, the action plan for T5 may provide the consumer access to the educational topical library, which may include access to various links/recommendations, such as: AP1, “Age”; AP2, “Applying for Credit”; AP13, “Contacting Your Creditor”; AP14, “Correcting Your Credit Report”; AP15, “Credit Counseling”; AP19, “Debt Traps and How to Avoid Them”; AP24, “Keep Open Revolving Credit Accounts”; and AP25, “Managing Your Revolving Credit”, as shown in FIGS. 20A-D. It is contemplated that the action plan part of the method of the current invention may provide the consumer with various pieces of information. This information may be educational/counseling and/or general in nature, and may be organized and presented in any manner as is contemplated by those of ordinary skill in the art.

As mentioned previously, another exemplary feature of the current invention is the identification and utilization of “Alerts”. Alerts represent an action taken by the ICRECS and provide the consumer a description of that action and what was discovered.

The Alerts then provide the consumer with a recommended action to take based off what was found. In a preferred embodiment, the Alert for T5 is as follows:

| | | Associated | Technical | Consumer | |
|---|---|---|---|---|---|
| # | Name | Trigger | Action | Description | Recommended Action |
| 5 | Account | | This alert will | We have audited your | Examine the data flagged |
| | Closed By | | identify any | credit report and | in your credit report. If it |
| | Consumer | | accounts that the | discovered that you | is not accurate then it is |
| | | | consumer | have closed some | recommended that you |
| | | | closed. The | accounts. Closing | contact the credit bureau |
| | | | closed accounts | accounts can never | and update your |
| | | | will not have an | help your ICRECS | information accordingly. |
| | | | impact on the | Credit Score. In most | Otherwise, it is |
| | | | current score. | cases closing accounts | recommended that you no |
| | | | | will only hurt your | longer close accounts. |
| | | | | credit utilization | |
| | | | | variable. | |

It is contemplated that the Alert(s) provided may be associated with various Triggers, as shown in Table 1 or as further described below, and may further be associated with multiple Triggers. It is further contemplated that the Associated Trigger may provide additional descriptive language, which is generated by the current invention in response to the consumer's credit performance data. The Technical Action description may vary to align with the specific Trigger(s) and/or additional descriptive language that is/are being associated with the Alert. The Consumer Description provided may be general in nature or specific to the associated Trigger(s) and/or additional descriptive language. The Consumer Description may provide a restatement of a recommendation or AP variable or provide additional information, such as that shown above. The Recommended Action may include a specific action to take, wherein that action may be further reflected in the Action Plan. Alternatively, the recommended Action may provide additional actions that may be taken with respect to the particular Associated Trigger and/or additional descriptive language provided.

The analysis and assessment of the Trigger T6, “Too Many Accounts with Balance”, is another functional feature of the characterization step performed by the ICRECS system in performance of the exemplary methods of the instant invention. Within T6, the utilization of your existing credit or the absence of existing credit usage may be analyzed and assessed. Table 8 displays the primary variable, intervals/tiers and weights associated with trigger T6.

TABLE 8
Trigger T6
Trigger T6
Too Many Accounts with Balance

| | | | Weights |
|---|---|---|---|
| | | | Points |
| | | | Impacted |
| Primary Variable (T6X) | Tiers | Intervals | (T6P) |
| Number of Open Trades | 0 | Missing | 0 |
| with Balance >0 in the | 1 | No Trades | −80 |
| Last 12 Months | 2 | 0 | −16 |
| | 3 | 1 | −8 |
| | 4 | 2 or more | 0 |

The analysis and assessment of the T6 Trigger involves the use of the following T6 variables: T6P=Points Impacted (Weights) or Score, T6X=Total number of open trades with a balance reported in the last 12 months, T6POP=Positive opportunity points for improving for delinquency, which is the potential positive point impact when rating moves from a lower tier to a higher tier, T6POCV=Positive opportunity counseling verbiage, T6NOP=Negative opportunity points for delinquency deterioration, which is the potential negative point impact when rating moves from a higher tier to a lower tier, T6NOCV=Negative opportunity counseling verbiage, T6D=Difference between current point impact and next tier point impact. T6CV=Conditions verbiage, T6RV=Recommendations verbiage T6, T6EL=Educational Links, and T6AV=Alerts verbiage.

To compute T6P for trigger T6, the following steps are performed by CRIE. If T6X's value is No Trades, then negative eighty (−80) points are assessed (T6P=−80) and the condition “Your current count of no trades is considered a serious problem by most credit analyzing companies, and has a very serious negative impact on your score” is assigned to the variable T6CV. If T6X's value is Zero, then negative sixteen (−16) points are assessed (T6P=−16) and the condition “Your current count of no open trades with a balance is considered very low by most credit analyzing companies, and has a very large negative impact on your score” is assigned to the variable T6CV. If T6X's value is 1, then negative eight (−8) points are assessed (T6P=−8) and the condition “Your current count of no open trades with a balance is considered low by most credit analyzing companies, and has a significant negative impact on your score” is assigned to the variable T6CV. If T6X's value is 2 or more, then Zero points are assessed (T6P=0) and the condition “Your current count of X with a balance is considered neutral by most credit analyzing companies, and has no impact on your score” is assigned to the variable T5CV.

Utilizing T6, output of the analysis and assessment utilized to generate the action plan may further allow the ICRECS to provide assessment of positive opportunities and uses the formerly computed T6X variable to select the previous tier that represents the next opportunity for improvement. To assess the positive opportunity for trigger T6, the following steps are performed by CRIE. If T6X's value is No Trades=You have no credit yet, then the next positive opportunity counseling verbiage (T6POCV) is: “You should apply for specialty retail store or department store credit cards. This is often the easiest credit to get when you don't already have credit.” If T6X's value is Zero=You have credit but aren't using it, then the next positive opportunity counseling verbiage (T6POCV) is: “If you have a retail and an bankcard you should charge a small amount periodically on each and pay the bill in full each month.” If T6X's value is 1=You have credit but are only using one trade, then the next positive opportunity counseling verbiage (T6POCV) is: “If you have a retail and bankcard you should charge a small amount periodically on one of these and pay the bill in full each month.” If T6X's value is more than 1=You have credit and have balances on X trades, then the next positive opportunity counseling verbiage (T6POCV) is: “Several of your trades show open balances. It is in your best interest to limit trades with balances to a number that you can manage but to use a few trades periodically to demonstrate your ability to manage your credit.”

The output of the analysis and assessment utilized to generate the action plan may further allow the ICRECS to provide assessment of negative opportunities and may use the formerly computed T6X variable to select the next tier that represents the next opportunity for deterioration. To assess the negative opportunity for trigger T6, the following steps are performed by CRIE. If T6X's value is 2 or greater, then the next negative opportunity is: “As your current trades total is X, which is at the highest end of the grading spectrum, you cannot incur more points for additional trades with a balance.” It will be assigned to the trigger T6. If T6X's value is No Trade, 0 to 1, then the next negative opportunity is: “Your current number of trades with a balance does impact your score negatively. Increasing the number of trades with a balance could improve you score as you demonstrate your ability to get and manage credit.” It will be assigned to the trigger T6.

In addition to the positive and negative behaviors opportunities, general recommendations are provided for trigger T6 if T6X is greater than zero. The general recommendation counseling verbiage assigned to T6RCV is: “If you have no trades or have trades but do not use them or only use one trade you may be considered a higher credit risk by many creditors because they cannot judge how well you manage your credit. If you don't have any credit you should apply for specialty retail store or department store credit cards. This is often the easiest first credit to get. Once you have credit you should use it, but don't charge too much and try to pay the balance in full at every bill. You should then have the opportunity to get additional credit when you need it for large purchases such as a car or a home. You should try to not have a lot of trades with balances unless you have a high income to afford them.”

Additional statements, recommendations, and/or steps that may be taken (“action steps”) may be generated from and presented through the action plan to the consumer. For example, the action plan may provide one or more of the following: “Identify all accounts that are shown with a balance”; “Primary emphasis should be put on revolving accounts such as credit cards, retail cards, etc., or installment loans with a small balance remaining”; “Verify that the balances are correct”; “If not correct, notify the credit bureau and the appropriate creditor; “If correct, pay off as many of the balances as possible given the budgetary and other constraints”; and “Generally, begin by paying off the smaller balances first.” These various statements, recommendations, and/or action steps are exemplary and not intended to limit the scope of the current invention. The presentation, through the action plan, of various additional statements, recommendations, and/or action steps, as contemplated by those of ordinary skill in the art may be employed without departing from the scope and spirit of the present invention. It is contemplated that the statements, recommendations, and or action steps may be presented in a logical order, such as a sequential progression wherein a first statement follows another, however, various presentation orders and formats may be employed.

In addition to recommendations, educational relative links are provided to the ICRECS, preferably through the educational topical library, for subject matter associated with account delinquency. In a preferred embodiment, the links are assigned to the variable T6EL. For example, the action plan for T6 may provide the consumer access to the educational topical library that may include access to various links/recommendations, such as: AP4, “Balance Transfers”; AP6, “Budgeting”; AP11, “Consolidation Loans”; AP12, “Consumer Protection Laws”; AP13, “Contacting Your Creditor”; AP14, “Correcting Your Credit Report”; AP15, “Credit Counseling”; AP17, “Dangers of Credit Repair”; AP19, “Debt Traps and How to Avoid Them”; AP22, “Importance of Paying Bills on Time”; AP25, “Managing Your Revolving Credit”; AP26, “Repayment”; and AP31, “Value of a Spending Plan”, as shown in FIGS. 20A-D. It is contemplated that the action plan part of the method of the current invention may provide the consumer with various pieces of information. This information may be educational/counseling and/or general in nature, and may be organized and presented in any manner as is contemplated by those of ordinary skill in the art.

As mentioned previously, another exemplary feature of the current invention is the identification and utilization of “Alerts”. Alerts represent an action taken by the ICRECS and provide the consumer a description of that action and what was discovered. The Alerts then provide the consumer with a recommended action to take based off what was found. In a preferred embodiment, the Alert for T6 is as follows:

| | | Associated | Technical | Consumer | Recommended |
|---|---|---|---|---|---|
| # | Name | Trigger | Action | Description | Action |
| 6 | Account | | This alert will | We have audited your | You will need to wait X |
| | Too | | indicate that the | tradelines for their age | months before the |
| | New | | account is not yet | and discovered that you | following accounts will |
| | | | old enough to be | have accounts that are too | be included in the |
| | | | used in any | new to rate. As a result, | ICRECS Credit Score. |
| | | | calculations. | they have not been | |
| | | | | included in your ICRECS | |
| | | | | Credit Score. | |

It is contemplated that the Alert(s) provided may be associated with various Triggers, as shown in Table 1 or as further described below, and may further be associated with multiple Triggers. It is further contemplated that the Associated Trigger may provide additional descriptive language, which is generated by the current invention in response to the consumer's credit performance data. The Technical Action description may vary to align with the specific Trigger(s) and/or additional descriptive language that is/are being associated with the Alert. The Consumer Description provided may be general in nature or specific to the associated Trigger(s) and/or additional descriptive language. The Consumer Description may provide a restatement of a recommendation or AP variable or provide additional information, such as that shown above. The Recommended Action may include a specific action to take, wherein that action may be further reflected in the Action Plan. Alternatively, the recommended Action may provide additional actions that may be taken with respect to the particular Associated Trigger and/or additional descriptive language provided.

The analysis and assessment of the Trigger T7, “Proportion of Balances to Credit Limits is too High on Bank Revolving or Other Revolving Accounts”, is another functional feature of the characterization step performed by the ICRECS system in performance of the exemplary methods of the instant invention. Within T7, the percent of revolving credit being utilized may be analyzed and assessed. Table 9 displays the primary variable, intervals/tiers and weights associated with trigger T7.

TABLE 9
Trigger T7
Trigger T7
Proportion of Balances to Credit Limits is to High on Bank
Revolving or Other Revolving Accounts

| | | | Weights |
|---|---|---|---|
| | | | Points |
| | | | Impacted |
| Primary Variable (T7X) | Tiers | Intervals | (T7P) |
| Ratio of Total Balance to | 0 | No Trades | 0 |
| Total High Credit for | 1 | No Rev. | −10 |
| Revolving Trades, | | Trades | |
| Reported in the Last 12 | | Missing | |
| Months | 2 | 0.00% to | 0 |
| | | 10% | |
| | 3 | 10.01% to | 30 |
| | | 20% | |
| | 4 | 20.01% to | 24 |
| | | 40% | |
| | 5 | 40.01% to | 0 |
| | | 60% | |
| | 6 | 60.01% to | −10 |
| | | 75% | |
| | 7 | 75.01% to | −15 |
| | | 90% | |
| | 8 | 90.01% to | −20 |
| | | 100% | |
| | 9 | 100.01% or | −35 |
| | | more | |
| | 10 | 0 | −60 |

The analysis and assessment of the T7 Trigger involves the use of the following T7 variables: T7P=Points Impact (Weight) or Score, T7X=Utilization Percentage, T7Y=Percentage before next tier, T7A=Percent over last tier, T7E=Debt amount required to increase/decrease debt, T7F=Available credit amount required to decrease credit utilization: T7POP=Positive opportunity points for improving for delinquency, which is the potential positive point impact when rating moves from a lower tier to a higher tier, T7POCV=Positive opportunity counseling verbiage, T7NOP=Negative opportunity points for delinquency deterioration, which is the potential negative point impact when rating moves from a higher tier to a lower tier, T7NOCV=Negative opportunity counseling verbiage, T7D=Difference between current point impact and previous tier point impact. T7CV=Conditions verbiage, T7RV=Recommendations verbiage T7, T7EL=Educational Links, and T7AV=Alerts verbiage.

To compute T7P for trigger T7, the following steps are performed by CRIE. If T7X's value is 0 to 10%, then thirty (30) points are assessed (T7P=30) and the condition “Your current credit utilization is X % and is low by most creditor standards and has an extremely large positive impact on your score” is assigned to the variable T7CV. If T7X's value is 10.01 to 20%, then twenty-four (24) points are assessed (T7P=24) and the condition “Your current credit utilization is X % and is low by most creditor standards and has a large positive impact on your score. Your credit utilization is helping your score” is assigned to the variable T7CV. If T7X's value is 20.01 to 40%, then Zero points are assessed (T7P=0) and the condition “Your current credit utilization is X % and is relatively low by most creditor standards and has no positive or negative impact on your score. Your credit utilization is neither helping nor hurting your score” is assigned to the variable T7CV. If T7X's value is 40.01 to 60%, then negative ten (−10) points are assessed (T7P=−10) and the condition “Your current credit utilization is X %. You have a medium credit utilization and has a negative impact on your score. The following account(s) are contributing most to this (list accounts) and percent of contribution” is assigned to the variable T7CV. If T7X's value is 60.01 to 75%, then negative fifteen (−15) points are assessed (T7P=−15) and the condition “Your current credit utilization is X % and has a moderate negative impact on your score. Your credit utilization is moderately high. The following account(s) are contributing most to this list accounts and percent of contribution” is assigned to the variable T7CV. If T7X's value is 75.01 to 90%, then negative twenty (−20) points are assessed (T7P=−20) and the condition “Your current credit utilization is X % and has a large negative impact on your score. Your credit utilization is high. The following account(s) are contributing most to this list accounts and percent of contribution” is assigned to the variable T7CV. If T7X's value is 90.01 to 100%, then negative thirty-five (−35) points are assessed (T7P=−35) and the condition “Your current credit utilization is X % and has a large negative impact on your score. Your credit utilization is very high. The following account(s) are contributing most to this list accounts and percent of contribution” is assigned to the variable T7CV. If T7X's value is 100.01% or more, the condition “Your current credit utilization is X %. Your credit utilization is extremely high. The following account(s) are contributing most to this list accounts and percent of contribution” is assigned to the variable T7CV.

Utilizing T7, output of the analysis and assessment utilized to generate the action plan may further allow the ICRECS to provide assessment of positive opportunities and uses the formerly computed T7X variable to select the previous tier that represents the next opportunity for improvement. To assess the positive opportunity for trigger T7, the following steps are performed by CRIE. If T7X's value is between 60.01 and 75%, then the next positive opportunity counseling verbiage (T7POCV) is: “If your credit utilization was to decrease by A % your score would your score would improve by D1. In order for you to achieve A % you would either need to decrease your revolving balances by E$ or increase your available revolving credit by F$, and not acquire any additional revolving debt or both. The fastest way to reduce your credit utilization is to do all three. When paying down your revolving balances it is recommended that you pay the creditors with the highest interest rate first. This will save you money in interest. Based upon your current standing it is recommended that if you choose to increase your available credit that you do so with the following creditors.” If T7X's value is between 75.01 and 90%, then the next positive opportunity counseling verbiage (T7POCV) is: “If your credit utilization was to decrease by A % your score would improve by D1. In order for you to achieve A % you would either need to decrease your revolving balances by E$ or increase your available revolving credit by F$, and not acquire any additional revolving debt or both. The fastest way to reduce your credit utilization is to do all three. When paying down your revolving balances it is recommended that you pay the creditors with the highest interest rate first. This will save you money in interest. Based upon your current standing it is recommended that if you choose to increase your available credit that you do so with the following creditors.”

If T7X's value is between 90.01 and 100%, then the next positive opportunity counseling verbiage (T7POCV) is: “If your credit utilization was to decrease by A % your score would your score would improve by D1. In order for you to achieve A % you would either need to decrease your revolving balances by E$ or increase your available revolving credit by F$, and not acquire any additional revolving debt or both. The fastest way to reduce your credit utilization is to do all three. When paying down your revolving balances it is recommended that you pay the creditors with the highest interest rate first. This will save you money in interest. Based upon your current standing it is recommended that if you choose to increase your available credit that you do so with the following creditors.” If T7X's value is greater than 100%, then the next positive opportunity counseling verbiage (T7POCV) is: “If your credit utilization was to decrease by A % your score would your score would improve by D1. In order for you to achieve A % you would either need to decrease your revolving balances by E$ or increase your available revolving credit by F$, and not acquire any additional revolving debt or both. The fastest way to reduce your credit utilization is to do all three. When paying down your revolving balances it is recommended that you pay the creditors with the highest interest rate first. This will save you money in interest. Based upon your current standing it is recommended that if you choose to increase your available credit that you do so with the following creditors.”

The output of the analysis and assessment utilized to generate the action plan may further allow the ICRECS to provide assessment of negative opportunities and may use the formerly computed T7X variable to select the next tier that represents the next opportunity for deterioration. To assess the negative opportunity for trigger T7, the following steps are performed by CRIE. If T7X's value is between 20.01 and 40%, then the next negative opportunity is: “If your revolving balances increased by AMOUNT your utilization would increase by Y %. As a result your score would decrease by D2.” It will be assigned to the trigger T7. If T7X's value is between 40.01 and 60%, then the next negative opportunity is: “If your revolving balances increased by AMOUNT your utilization would increase by Y %. As a result your score would decrease by D2.” It will be assigned to the trigger T7. If T7X's value is between 60.01 and 75%, then the next negative opportunity is: “If your revolving balances increased by AMOUNT your utilization would increase by Y %. As a result your score would decrease by D2. This would have a significant impact to your score and would possibly affect how lenders view an application for credit.” It will be assigned to the trigger T7. If T7X's value is 75.01 to 90%, then the next negative opportunity is: “If your revolving balances increased by AMOUNT your utilization would increase by Y %. As a result your score would decrease by D2 and you would have lost the maximum amount of points for this variable. This would have a significant impact to your score and would possibly affect how lenders view an application for credit.” It will be assigned to the trigger T7.

In addition to the positive and negative behaviors opportunities, general recommendations are provided for trigger T7 if T7X is greater than zero. The general recommendation counseling verbiage assigned to T7RCV is: “If you can pay down the balances on your bank revolving credit accounts so that they are lower relative to the credit limits then you should score better. If you are acquiring additional credit it is recommended that you do so with an existing bank revolving creditor that has the lowest interest rate who you have paid on time and are not over your credit limit. It should be an account that you have had for at least 12 months. A third approach, if possible, may be to balance transfer from your highly utilized accounts to another account(s).”

Additional statements, recommendations, and/or steps that may be taken (“action steps”) may be generated from and presented through the action plan to the consumer. For example, the action plan may provide one or more of the following: “Identify all revolving accounts (primarily bank credit cards and retail cards—but also could include lines of credit <$50,000) and verify that the balances and credit limits are correct”; “If not correct, notify the credit bureau and the appropriate creditor; “In general pay down existing balances as much as possible given budgetary and other constraints”; and “If the credit report shows little or no delinquency during the previous 12 months, and the total amount that the consumer owes is manageable given finances, then consider asking one or two creditors to increase the credit limit on an existing account.” These various statements, recommendations, and/or action steps are exemplary and not intended to limit the scope of the current invention. The presentation, through the action plan, of various additional statements, recommendations, and/or action steps, as contemplated by those of ordinary skill in the art may be employed without departing from the scope and spirit of the present invention. It is contemplated that the statements, recommendations, and or action steps may be presented in a logical order, such as a sequential progression wherein a first statement follows another, however, various presentation orders and formats may be employed.

In addition to recommendations, educational relative links are provided to the ICRECS, preferably through the educational topical library, for subject matter associated with account delinquency. In a preferred embodiment, the links are assigned to the variable T7EL. For example, the action plan for T7 may provide the consumer access to the educational topical library which may include access to various links/recommendations, such as: AP3, “Applying for Credit Accounts”; AP6, “Budgeting”; AP13, “Contacting Your Creditor”; AP14, “Correcting Your Credit Report”; AP15, “Credit Counseling”; AP18, “Debt to Income”; AP19, “Debt Traps and How to Avoid Them”; AP24, “Keep Open Revolving Credit Accounts”; AP25, “Managing Your Revolving Credit”; AP26, “Repayment”; and AP30, “Utilization”, as shown in FIGS. 20A-D. It is contemplated that the action plan part of the method of the current invention may provide the consumer with various pieces of information. This information may be educational/counseling and/or general in nature, and may be organized and presented in any manner as is contemplated by those of ordinary skill in the art.

As mentioned previously, another exemplary feature of the current invention is the identification and utilization of “Alerts”. Alerts represent an action taken by the ICRECS and provide the consumer a description of that action and what was discovered. The Alerts then provide the consumer with a recommended action to take based off what was found. In a preferred embodiment, the Alert for T7 is as follows:

| | | Associated | | Consumer | Recommended |
|---|---|---|---|---|---|
| # | Name | Trigger | Technical Action | Description | Action |
| 7 | Possible | | This alert will identify | We have audited | Examine the data |
| | Duplicate | | if an account has been | your credit report | flagged in your credit |
| | | | reported multiple | and discovered that | report. If it is not |
| | | | times. The score | you have accounts | accurate then it is |
| | | | automatically removes | that have been | recommended that you |
| | | | duplicates from the | reported multiple | contact the credit bureau |
| | | | calculation. As a | times. Duplicates | and update your |
| | | | result, this will not | are not included in | information accordingly. |
| | | | impact their score. (we | the ICRECS Credit | |
| | | | could display this | Score. | |
| | | | outside of | | |

It is contemplated that the Alert(s) provided may be associated with various Triggers, as shown in Table 1 or as further described below, and may further be associated with multiple Triggers. It is further contemplated that the Associated Trigger may provide additional descriptive language, which is generated by the current invention in response to the consumer's credit performance data. The Technical Action description may vary to align with the specific Trigger(s) and/or additional descriptive language that is/are being associated with the Alert. The Consumer Description provided may be general in nature or specific to the associated Trigger(s) and/or additional descriptive language. The Consumer Description may provide a restatement of a recommendation or AP variable or provide additional information, such as that shown above. The Recommended Action may include a specific action to take, wherein that action may be further reflected in the Action Plan. Alternatively, the recommended Action may provide additional actions that may be taken with respect to the particular Associated Trigger and/or additional descriptive language provided.

The analysis and assessment of the Trigger T8, “Trade Accounts”, is another functional feature of the characterization step performed by the ICRECS system in performance of the exemplary methods of the instant invention. Within T8, the number of trades opened in the last six months will be analyzed and assessed. Table 10 displays the primary variable, intervals/tiers and weights associated with trigger T8.

TABLE 10
Trigger T8
Trigger T8
Trade Accounts

| | | | Weights |
|---|---|---|---|
| | | | Points |
| | | | Impacted |
| Primary Variable (T8X) | Tiers | Intervals | (T8P) |
| Number of Trades | 0 | Missing | 0 |
| Opened in the Last 6 | 1 | No Trades | 0 |
| Months | 2 | 0-1 | 0 |
| | 3 | 2-3 | −4 |
| | 4 | 4 | −10 |
| | 5 | 5 | −16 |
| | 6 | 6 or more | −20 |

The analysis and assessment of the T8 Trigger involves the use of the following T8 variables: T8P=Points Impacted (Weights) or Score, T8X=Total number of trades opened recently, T8Y=Number of trades opened recently before next tier, T8A=Number of trades opened recently over last tier, T8POP=Positive opportunity points for improving for delinquency, which is the potential positive point impact when rating moves from a lower tier to a higher tier, T8POCV=Positive opportunity counseling verbiage, T8NOP=Negative opportunity points for delinquency deterioration, which is the potential negative point impact when rating moves from a higher tier to a lower tier, T8NOCV=Negative opportunity counseling verbiage, T8D=Difference between current point impact and previous tier point impact. T8CV=Conditions verbiage, T87RV=Recommendations verbiage T8, T8EL=Educational Links, and T8AV=Alerts verbiage.

To compute T8P for trigger T8, the following steps are performed by CRIE. If T8X's value is 6 or greater, then negative twenty (−20) points are assessed (T8P=−20) and the condition “Your current count of X new trades opened in the last 6 months is considered very high by most credit analyzing companies, and has a very large negative impact on your score” is assigned to the variable T8CV. If T8X's value is five (5), then negative sixteen (−16) points are assessed (T8P=−16) and the condition “Your current count of 5 new trades in the last 6 months is considered high by most credit analyzing companies, and has a very large negative impact on your score” is assigned to the variable T8CV. If T8X's value is four (4), then negative ten (−10) points are assessed (T8P=−10) and the condition “Your current count of 4 new trades in the last 6 months is considered high by most credit analyzing companies, and has a significant negative impact on your score” is assigned to the variable T8CV. If T8X's value is three 2 to 3, then negative four (−4) points are assessed (T8P=−4) and the condition “Your current count of X new trades in the last 6 months is considered high by most credit analyzing companies, and has a moderate negative impact on your score” is assigned to the variable T8CV. If T8X's value is Zero to 1, then Zero points are assessed (T8P=0) and the condition “Your current count of X new trades in the last 6 months is considered few by most credit analyzing companies. At this time, your score is not affected by the number of new trades in the last 6 months (0)” is assigned to the variable T8CV.

Utilizing T8, output of the analysis and assessment utilized to generate the action plan may further allow the ICRECS to provide assessment of positive opportunities and uses the formerly computed T8X variable to select the previous tier that represents the next opportunity for improvement. To assess the positive opportunity for trigger T8, the following steps are performed by CRIE. If T8X's value is 2 or greater than if Dates of A trades opened fall more than 6 months in past: then the next positive opportunity counseling verbiage (T8POCV) is either,
(i) “In 2 months, A of your current trades will be more than six months old. If no new trades are opened during this time, then the impact on your score could improve by D1.”; or
(ii) “Many of your trades show recent dates. It is in your best interest to limit new trades opened as much as possible over the next six months, to bring the total number of new trades within six month's time down, and improve your credit score.”

The output of the analysis and assessment utilized to generate the action plan may further allow the ICRECS to provide assessment of negative opportunities and may use the formerly computed T8X variable to select the next tier that represents the next opportunity for deterioration. To assess the negative opportunity for trigger T8, the following steps are performed by CRIE. If T8X's value is between 2 and 6, then the next negative opportunity is: “You are Y trades away from incurring a larger penalty on your score. Remember that at the time of scoring only those trades that have occurred within six month's time count against your score.” It will be assigned to the trigger T8. If T8X's value is 6 or greater, then the next negative opportunity is: “As your current new trades in last 6 months is X, which is at the highest end of the grading spectrum, you cannot incur a bigger penalty with additional trades opened. However, if you avoid new trades opened as much as possible over the next six months, you can bring down your total count at that time, which can reduce the penalty against your score.” It will be assigned to the trigger T8. If T8X's value is between Zero to 1, then the next negative opportunity is: “While your current trades opened total of X does not impact your score negatively, increasing the frequency of trades opened in the future could reduce your score.” It will be assigned to the trigger T8.

In addition to the positive and negative behaviors opportunities, general recommendations are provided for trigger T8 if T8X is greater than zero. The general recommendation counseling verbiage assigned to T8RCV is: “If you must seek additional credit it is recommended that you do so with an existing creditor who you have paid on time and are not over your credit limit and who you have had credit with for at least 12 months. Ask if they can increase your credit limit without opening a new trade. When seeking credit with a lender who you already have an established relationship with, they may not need to evaluate your credit in a way that generates an inquiry on your credit report.”

Additional statements, recommendations, and/or steps that may be taken by the consumer (“action steps”) may be generated from and presented through the action plan to the consumer. The presentation, through the action plan, of various additional statements, recommendations, and/or action steps, as contemplated by those of ordinary skill in the art may be employed without departing from the scope and spirit of the present invention. It is contemplated that the statements, recommendations, and or action steps may be presented in a logical order, such as a sequential progression wherein a first statement follows another, however, various presentation orders and formats may be employed.

In addition to recommendations, educational relative links are provided to the ICRECS, preferably through the educational topical library, for subject matter associated with account Delinquency. In a preferred embodiment, the links are assigned to the variable T8EL. For example, the action plan for T8 may provide the consumer access to the educational topical library which may include access to various links/recommendations, such as: AP1, “Age”; AP2, “Applying for Credit”; AP3, “Applying for Credit Accounts”; AP4, “Balance Transfers”; AP5, “Bankruptcy”; AP6, “Budgeting”; AP7, “Build a Saving Plan”; AP8, “Buying a Car”; AP9, “Collection Agencies”; “AP10, “Collection Agencies”; AP11, “Consolidation Loans”; AP12, “Consumer Protection Laws”; AP13, “Contacting Your Creditor”; AP14, “Correcting Your Credit Report”; AP15, “Credit Counseling”; AP16, “Creating a Savings Plan”; AP17, “Dangers of Credit Repair”; AP18, “Debt to Income”; AP19, “Debt Traps and How to Avoid Them”; AP20, “Homeownership”; AP21, “How You Can Save”; AP22, “Importance of Paying Bills on Time”; AP23, “Importance of Paying Bills on Time”; AP24, “Keep Open Revolving Credit Accounts”; AP25, “Managing Your Revolving Credit”; AP26, “Repayment”; AP27, “Settlement”; AP28, “Strategy”; AP29, “Time-wise Record-keeping”; AP30, “Utilization”; AP31, “Value of a Spending Plan”, as shown in FIGS. 20A-D. It is contemplated that the action plan part of the method of the current invention may provide the consumer with various pieces of information. This information may be educational/counseling and/or general in nature, and may be organized and presented in any manner as is contemplated by those of ordinary skill in the art.

As mentioned previously, another exemplary feature of the current invention is the identification and utilization of “Alerts”. Alerts represent an action taken by the ICRECS and provide the consumer a description of that action and what was discovered. The Alerts then provide the consumer with a recommended action to take based off what was found. In a preferred embodiment, the Alert for T8 is as follows:

| | | Associated | Technical | Consumer | Recommended |
|---|---|---|---|---|---|
| # | Name | Trigger | Action | Description | Action |
| 8 | Bankruptcy | | This alert will | We have audited your | Examine the data |
| | Accuracy | | cross-check the | credit report and found | flagged in your credit |
| | | | dates of discharge | that you have varying | report. If it is not |
| | | | for each tradeline | dates of discharge for | accurate then it is |
| | | | affected and notify | your bankruptcy. | recommended that you |
| | | | the consumer if | Although this does not | contact the credit |
| | | | there is a | affect your ICRECS | bureau and update |
| | | | difference. It is | Credit Score lenders | your information |
| | | | wise credit | will often use the most | accordingly. |
| | | | management to | recent date to determine | |
| | | | have them all equal | if you qualify for a | |
| | | | the oldest date. | loan. As a result, it is | |
| | | | ALERT | important that these | |
| | | | Bankruptcy is a | dates are uniform. | |

It is contemplated that the Alert(s) provided may be associated with various Triggers, as shown in Table 1 or as further described below, and may further be associated with multiple Triggers. It is further contemplated that the Associated Trigger may provide additional descriptive language, which is generated by the current invention in response to the consumer's credit performance data. The Technical Action description may vary to align with the specific Trigger(s) and/or additional descriptive language that is/are being associated with the Alert. The Consumer Description provided may be general in nature or specific to the associated Trigger(s) and/or additional descriptive language. The Consumer Description may provide a restatement of a recommendation or AP variable or provide additional information, such as that shown above. The Recommended Action may include a specific action to take, wherein that action may be further reflected in the Action Plan. Alternatively, the recommended Action may provide additional actions that may be taken with respect to the particular Associated Trigger and/or additional descriptive language provided.

The analysis and assessment of the Trigger T9, “High Ration Revolving Trades”, is another functional feature of the characterization step performed by the ICRECS system in performance of the exemplary methods of the instant invention. Within T9, the number of bank revolving trades that are highly utilized will be analyzed and assessed. Table 11 displays the primary variable, intervals/tiers and weights associated with trigger T9.

TABLE 11
Trigger T9
Trigger T9
High Radio Revolving Trades

| | | | Weights |
|---|---|---|---|
| | | | Points |
| | | | Impacted |
| Primary Variable (T9X) | Tiers | Intervals | (T9P) |
| Number of Bank | 0 | No Trades | 0 |
| Revolving Trades with | 1 | No Bank | −10 |
| Balance to High Credit | | Rev Trades | |
| Ratio >75%, Reported in | 2 | Missing | 0 |
| the Last 6 Months | 3 | 0 | 15 |
| | 4 | 1 | 0 |
| | 5 | 2 | −20 |
| | 6 | 3 | −30 |
| | 7 | 4 or more | −50 |

The analysis and assessment of the T9 Trigger involves the use of the following T9 variables: T9P=Points Impacted (Weights) or Score, T9X=Utilization Percentage, T9Y=Percentage before next tier, T9A=Percentage over last tier; T9POP=Positive opportunity points for improving for delinquency, which is the potential positive point impact when rating moves from a lower tier to a higher tier, T9POCV=Positive opportunity counseling verbiage, T9NOP=Negative opportunity points for delinquency deterioration, which is the potential negative point impact when rating moves from a higher tier to a lower tier, T9NOCV=Negative opportunity counseling verbiage, T9D=Difference between current point impact and previous tier point impact. T9CV=Conditions verbiage, T9RV=Recommendations verbiage T9, T9EL=Educational Links, and T9AV=Alerts verbiage.

To compute T9P for trigger T9, the following steps are performed by CRIE. If T9X's value is 4 or greater, then negative fifty (−50) points are assessed (T9P=−50) and the condition “Your current count is considered very high by most credit analyzing companies, and has an extremely large negative impact on your score” is assigned to the variable T9CV. If T9X's value is three (3), then negative thirty (−30) points are assessed (T9P=−30) and the condition “Your current count of 3 is considered very high by most credit analyzing companies, and has a very large negative impact on your score” is assigned to the variable T9CV. If T9X's value is two (2), then negative twenty (−20) points are assessed (T9P=−20) and the condition “Your current count of 2 is considered high by most credit analyzing companies, and has a significant negative impact on your score” is assigned to the variable T9CV. If T9X's value is one (1), then Zero points are assessed (T9P=0) and the condition “Your current count of 1 is considered moderate by most credit analyzing companies, and has a no impact on your score” is assigned to the variable T9CV. If T9X's value is Zero, then fifteen (15) points are assessed (T9P=15) and the condition “Your current count of 0 is considered good by most credit analyzing companies and has a positive impact on your score” is assigned to the variable T9CV. If T9X's value is No Bank Revolving Trades, then negative ten (−10) points are assessed (T9P=−10) and the condition “The fact that you have No Bank Revolving Trades is considered a negative by most credit analyzing companies and has a negative impact on your score” is assigned to the variable T9CV.

Utilizing T9, output of the analysis and assessment utilized to generate the action plan may further allow the ICRECS to provide assessment of positive opportunities and uses the formerly computed T9X variable to select the previous tier that represents the next opportunity for improvement. To assess the positive opportunity for trigger T9, the following steps are performed by CRIE. If T9X's value is 4 or greater, then the next positive opportunity counseling verbiage (T9POCV) is: “Your current count of X highly utilized bank revolving trades is A over the previous tier. Once Y of these utilized less than 75%, and no new ones occur, your score will improve by D1 points. You should reduce your balance on A bank revolving trades to less than 75% of the credit limit. You can do this by requesting a credit limit increase from one or more of your bank revolving card companies who you have paid on time and are not over your credit limit. It should be an account that you have had for at least 12 months. Alternatively, you might be able to pay down the balance(s) on A of your bank revolving credit accounts so that the balance is less than 75% of the credit limit. A third approach, if possible, may be to balance transfer from your highly utilized account to another account.”

If T9X's value is 3, then the next positive opportunity counseling verbiage (T9POCV) is: “Your current count of 3 highly utilized bank revolving trades is 1 over the previous tier. Once Y of these utilized less than 75%, and no new ones occur, your score will improve by D1 points. You should reduce your balance on A bank revolving trades to less than 75% of the credit limit. You can do this by requesting a credit limit increase from one or more of your bank revolving card companies who you have paid on time and are not over your credit limit. It should be an account that you have had for at least 12 months. Alternatively, you might be able to pay down the balance(s) on 1 of your bank revolving credit accounts so that the balance is less than 75% of the credit limit. A third approach, if possible, may be to balance transfer from your highly utilized account to another account.” If T9X's value is 2, then the next positive opportunity counseling verbiage (T9POCV) is: “Your current count of 2 highly utilized bank revolving trades is 1 over the previous tier. Once Y of these utilized less than 75%, and no new ones occur, your score will improve by D1 points. You should reduce your balance on A bank revolving trades to less than 75% of the credit limit. You can do this by requesting a credit limit increase from one or more of your bank revolving card companies who you have paid on time and are not over your credit limit. It should be an account that you have had for at least 12 months. Alternatively, you might be able to pay down the balance(s) on 1 of your bank revolving credit accounts so that the balance is less than 75% of the credit limit. A third approach, if possible, may be to balance transfer from your highly utilized account to another account.” If T9X's value is 1, then the next positive opportunity counseling verbiage (T9POCV) is: “Your current count of 1 highly utilized bank revolving trades is 1 over the previous tier. Once 1 of these utilized less than 75%, and no new ones occur, your score will improve by D1 points. You should reduce your balance on A bank revolving trades to less than 75% of the credit limit. You can do this by requesting a credit limit increase from one or more of your bank revolving card companies who you have paid on time and are not over your credit limit. It should be an account that you have had for at least 12 months. Alternatively, you might be able to pay down the balance(s) on 1 of your bank revolving credit accounts so that the balance is less than 75% of the credit limit. A third approach, if possible, may be to balance transfer from your highly utilized account to another account.” If T9X's value is No Bank Revolving Trades, then the next positive opportunity counseling verbiage (T9POCV) is: “If possible you should apply for a bank revolving trade/bank card trade. If you have been turned down for this in the recent past, you should wait until your credit improves. If you don't have any credit or much credit, consider first applying for a retail or department store credit card. After using it carefully for a few months then apply for a bank card at you bank or credit union.”

The output of the analysis and assessment which is utilized to generate the action plan may further allow the ICRECS to provide assessment of negative opportunities and may use the formerly computed T9X variable to select the next tier which represents the next opportunity for deterioration. To assess the negative opportunity for trigger T9, the following steps are performed by CRIE. If T9X's value is 1, then the next negative opportunity is: “Your current count of 1 highly utilized bank revolving trades is 1 away from incurring a larger penalty on your score. Be careful not to increase the balance of another bank revolving trade so that it will be over 75% of its credit limit.” It will be assigned to the trigger T9. If T9X's value is 2, then the next negative opportunity is: “Your current count of 2 highly utilized bank revolving trades is 1 away from incurring a larger penalty on your score. Be careful not to increase the balance of another bank revolving trade so that it will be over 75% of its credit limit.” It will be assigned to the trigger T9. If T9X's value is 3, then the next negative opportunity is: “Your current count of 3 highly utilized bank revolving trades is 1 away from incurring a larger penalty on your score. Be careful not to increase the balance of another bank revolving trade so that it will be over 75% of it s credit limit.” It will be assigned to the trigger T9. If T9X's value is 4 or more, then the next negative opportunity is: “Your current count of X highly utilized bank revolving trades is the largest penalty on your score.” It will be assigned to the trigger T9.

In addition to the positive and negative behaviors opportunities, general recommendations are provided for trigger T9 if T9X is greater than zero. The general recommendation counseling verbiage assigned to T9RCV is: “If you must seek additional credit it is recommended that you do so with an existing bank revolving card creditor who you have paid on time and are not over your credit limit. It should be an account that you have had for at least 12 months. Alternatively, you might be able to pay down the balance(s) on one or more of your bank revolving credit accounts so that the balances are less than 75% of the credit limit. A third approach, if possible, may be to balance transfer from your highly utilized accounts to another account(s). Don't consolidate bank revolving accounts so that you'll have anymore that have the balance at least 75% of the credit limit.”

Additional statements, recommendations, and/or steps that may be taken by the consumer (“action steps”) may be generated from and presented through the action plan to the consumer. The presentation, through the action plan, of various additional statements, recommendations, and/or action steps, as contemplated by those of ordinary skill in the art may be employed without departing from the scope and spirit of the present invention. It is contemplated that the statements, recommendations, and or action steps may be presented in a logical order, such as a sequential progression wherein a first statement follows another, however, various presentation orders and formats may be employed.

In addition to recommendations, educational relative links are provided to the ICRECS, preferably through the educational topical library, for subject matter associated with account Delinquency. In a preferred embodiment, the links are assigned to the variable T9EL. For example, the action plan for T9 may provide the consumer access to the educational topical library which may include access to various links/recommendations, such as: AP1, “Age”; AP2, “Applying for Credit”; AP3, “Applying for Credit Accounts”; AP4, “Balance Transfers”; AP5, “Bankruptcy”; AP6, “Budgeting”; AP7, “Build a Saving Plan”; AP8, “Buying a Car”; AP9, “Collection Agencies”; “AP10, “Collection Agencies”; AP11, “Consolidation Loans”; AP12, “Consumer Protection Laws”; AP13, “Contacting Your Creditor”; AP14, “Correcting Your Credit Report”; AP15, “Credit Counseling”; AP16, “Creating a Savings Plan”; AP17, “Dangers of Credit Repair”; AP18, “Debt to Income”; AP19, “Debt Traps and How to Avoid Them”; AP20, “Homeownership”; AP21, “How You Can Save”; AP22, “Importance of Paying Bills on Time”; AP23, “Importance of Paying Bills on Time”; AP24, “Keep Open Revolving Credit Accounts”; AP25, “Managing Your Revolving Credit”; AP26, “Repayment”; AP27, “Settlement”; AP28, “Strategy”; AP29, “Time-wise Record-keeping”; AP30, “Utilization”; AP31, “Value of a Spending Plan”, as shown in FIGS. 20A-D. It is contemplated that the action plan part of the method of the current invention may provide the consumer with various pieces of information. This information may be educational/counseling and/or general in nature, and may be organized and presented in any manner as is contemplated by those of ordinary skill in the art.

As mentioned previously, another exemplary feature of the current invention is the identification and utilization of “Alerts”. Alerts represent an action taken by the ICRECS and provide the consumer a description of that action and what was discovered. The Alerts then provide the consumer with a recommended action to take based off what was found. In a preferred embodiment, the Alert for T9 is as follows:

| | | Associated | Technical | | Recommended |
|---|---|---|---|---|---|
| # | Name | Trigger | Action | Consumer Description | Action |
| 9 | Name | | This alert will | We have audited your credit | Examine the data flagged |
| | | | identify if there | report and found that the | in your credit report. If it |
| | | | is a difference in | spelling of the name you | is not accurate then it is |
| | | | the name on file | provided differs from what | recommended that you |
| | | | and the name in | is on your credit report. | contact the credit bureau |
| | | | the credit report. | This does not affect your | and update your |
| | | | | ICRECS Credit Score. It is | information accordingly. |
| | | | | wise to keep the most up to | |
| | | | | date and accurate credit | |
| | | | | report as possible. | |

It is contemplated that the Alert(s) provided may be associated with various Triggers, as shown in Table 1 or as further described below, and may further be associated with multiple Triggers. It is further contemplated that the Associated Trigger may provide additional descriptive language, which is generated by the current invention in response to the consumer's credit performance data. The Technical Action description may vary to align with the specific Trigger(s) and/or additional descriptive language that is/are being associated with the Alert. The Consumer Description provided may be general in nature or specific to the associated Trigger(s) and/or additional descriptive language. The Consumer Description may provide a restatement of a recommendation or AP variable or provide additional information, such as that shown above. The Recommended Action may include a specific action to take, wherein that action may be further reflected in the Action Plan. Alternatively, the recommended Action may provide additional actions that may be taken with respect to the particular Associated Trigger and/or additional descriptive language provided.

The analysis and assessment of the Trigger T10, “Too Many Inquiries in the Last 12 months”, is another functional feature characterization step performed by the ICRECS system in performance of the exemplary methods of the instant invention. Within T10, the number of inquiries made into your credit history within the last 12 months will be analyzed and assessed. Table 12 displays the primary variable, intervals/tiers and weights associated with trigger T10.

TABLE 12
Trigger T10
Trigger T10
Too Many Inquiries in the Last 12 Months

| | | | Weights |
|---|---|---|---|
| | | | Points |
| | | | Impacted |
| Primary Variable (T10X) | Tiers | Intervals | (T10P) |
| Number of Inquiries in | 0 | Missing/No | 25 |
| the Last 12 Months | | Inquiries | |
| | 1 | 0 | 0 |
| | 2 | 0 | 20 |
| | 3 | 1 | 10 |
| | 4 | 2 | 5 |
| | 5 | 3 | 0 |
| | 6 | 4-5 | −3 |
| | 7 | 6-7 | −8 |
| | 8 | 8-9 | −15 |
| | 9 | 10 or more | −25 |

The analysis and assessment of the T10 Trigger involves the use of the following T10 variables: T10P=Points Impacted (Weights) or Score, T10X=Total number of inquiries, T10Y=Number of inquiries before next tier, T10A=Number of inquiries over last tier; T10POP=Positive opportunity points for improving for delinquency, which is the potential positive point impact when rating moves from a lower tier to a higher tier, T10POCV=Positive opportunity counseling verbiage, T10NOP=Negative opportunity points for delinquency deterioration, which is the potential negative point impact when rating moves from a higher tier to a lower tier, T10NOCV=Negative opportunity counseling verbiage, T10D=Difference between current point impact and previous tier point impact. T10CV=Conditions verbiage, T10RV=Recommendations verbiage T10, T10EL=Educational Links, and T10AV=Alerts verbiage.

To compute T10P for trigger T10, the following steps are performed by CRIE. If T10X's value is 10 or greater, then negative twenty-five (−25) points are assessed (T10P=−25) and the condition “Your current count of X inquiries in the last year is considered very high by most credit analyzing companies, and has a very large negative impact on your score” is assigned to the variable T10CV. If T10X's value is 8 to 9, then negative fifteen (−15) points are assessed (T10P=−15) and the condition “Your current count of X inquiries in the last year is considered very high by most credit analyzing companies, and has a very large negative impact on your score” is assigned to the variable T10CV. If T10X's value is 6 to 7, then negative eight (−8) points are assessed (T10P=−8) and the condition “Your current count of X inquiries in the last year is considered high by most credit analyzing companies, and has a significant negative impact on your score” is assigned to the variable T10CV. If T10X's value is 4 to 5, then negative three (−3) points are assessed (T10P=−3) and the condition “Your current count of X inquiries in the last year is considered high by most credit analyzing companies, and has a moderate negative impact on your score” is assigned to the variable T10CV. If T10X's value is 3, then Zero points are assessed (T10P=0) and the condition “Your current count of X inquiries in the last year is considered moderate by most credit analyzing companies. At this time, your score is generally not helped or hurt by the impact on your score” is assigned to the variable T10CV. If T10X's value is 2, then five (5) points are assessed (T10P=5) and the condition “Your current count of X inquiries in the last year is considered low by most credit analyzing companies, and has a moderate positive impact on your score” is assigned to the variable T10CV. If T10X's value is 1, then ten (10) points are assessed (T10P=10) and the condition “Your current count of X inquiries in the last year is considered very low by most credit analyzing companies, and has a significant positive impact on your score” is assigned to the variable T10CV. If T10X's value is Zero (Inquiries not in the last 12 months), then twenty (20) points are assessed (T10P=20) and the condition “Your current count of X inquires is considered very low by most credit analyzing companies, and has a very positive impact on your score” is assigned to the variable T10CV. If T10X's value is No Inquiries, then twenty-five (25) points are assessed (T10P=20) and the condition “Your current count of X inquires is considered extremely low by most credit analyzing companies, and has a very large positive impact on your score” is assigned to the variable T10CV.

Utilizing T10, output of the analysis and assessment utilized to generate the action plan may further allow the ICRECS to provide assessment of positive opportunities and uses the formerly computed T10X variable to select the previous tier that represents the next opportunity for improvement. To assess the positive opportunity for trigger T10, the following steps are performed by CRIE. If T10X's value is 10 or more then, if Dates of A inquiries fall more than 8 months in past, the next positive opportunity counseling verbiage (T8POCV) is either,
(i) “In 4 months, A of your current inquiries will be more than a year old. If no new inquiries are made during this time, then the impact on your score could improve by D1.”; or
(ii) “Many of your inquiries show recent dates. It is in your best interest to limit new inquiries as much as possible over the next year, to bring the total number of inquiries within a year's time down, and improve your credit score.”

The output of the analysis and assessment utilized to generate the action plan may further allow the ICRECS to provide assessment of negative opportunities and may use the formerly computed T10X variable to select the next tier that represents the next opportunity for deterioration. To assess the negative opportunity for trigger T10, the following steps are performed by CRIE. If T10X's value is between 4 and 5, then the next negative opportunity is: “You are Y inquiries away from incurring a larger penalty on your score. Remember that at the time of scoring only those inquiries that have occurred within one year's time count against your score.” It will be assigned to the trigger T10. If T10X's value is 10 or greater, then the next negative opportunity is: “As your current annual inquiry total is X, which is at the highest end of the grading spectrum, you cannot incur a bigger penalty with additional inquiries. However, if you avoid new inquiries as much as possible over the next year, you can bring down your total annual count at that time, which can reduce the penalty against your score.” It will be assigned to the trigger T10. If T10X's value is 3, then the next negative opportunity is: “While your current inquiry total of X does not impact your score negatively, increasing the frequency of inquiries in the future could reduce your score.” It will be assigned to the trigger T10.

In addition to the positive and negative behaviors opportunities, general recommendations are provided for trigger T10 if T10X is greater than zero. The general recommendation counseling verbiage assigned to T10RCV is: “If you must seek additional credit it is recommended that you do so with an existing creditor who you have paid on time and are not over your credit limit. When seeking credit with a lender who you already have an established relationship with, they may not need to evaluate your credit in a way that generates an inquiry on your credit report. You should avoid credit inquiries by a ‘finance company’ because these usually indicate a higher risk applicant. This is because these companies often charge higher interest rates. Sometimes some retail products are financed by finance companies including furniture, electronics and home services (e.g. security services) even though you may be at a retail store not related to the finance company. Some finance companies offer appealing promotions such as 6 and 12 months same as cash. The inquiry by such companies is often an indicator of higher risk. A loan or account with such a finance company may also indicate a higher risk person.”

Additional statements, recommendations, and/or steps that may be taken (“action steps”) may be generated from and presented through the action plan to the consumer. For example, the action plan may provide one or more of the following: “Seek credit with established relationship”; “Use credit report to shop rates”; and “Provide written authorization to pull credit report.” These various statements, recommendations, and/or action steps are exemplary and not intended to limit the scope of the current invention. The presentation, through the action plan, of various additional statements, recommendations, and/or action steps, as contemplated by those of ordinary skill in the art may be employed without departing from the scope and spirit of the present invention. It is contemplated that the statements, recommendations, and or action steps may be presented in a logical order, such as a sequential progression wherein a first statement follows another, however, various presentation orders and formats may be employed.

In addition to recommendations, educational relative links are provided to the ICRECS, preferably through the educational topical library, for subject matter associated with account delinquency. In a preferred embodiment, the links are assigned to the variable T10EL. For example, the action plan for T10 may provide the consumer access to the educational topical library which may include access to various links/recommendations, such as: AP2, “Applying for Credit”; AP 8, “Buying a Car”; AP13, “Contacting Your Creditor”; AP15, “Credit Counseling”; AP19, “Debt Traps and How to Avoid Them”; AP20, “Homeownership”; AP23, “Inquiries”, as shown in FIGS. 20A-D. It is contemplated that the action plan part of the method of the current invention may provide the consumer with various pieces of information. This information may be educational/counseling and/or general in nature, and may be organized and presented in any manner as is contemplated by those of ordinary skill in the art.

As mentioned previously, another exemplary feature of the current invention is the identification and utilization of “Alerts”. Alerts represent an action taken by the ICRECS and provide the consumer a description of that action and what was discovered. The Alerts then provide the consumer with a recommended action to take based off what was found. In a preferred embodiment, the Alert for T10 is as follows:

| | | Associated | Technical | Consumer | Recommended |
|---|---|---|---|---|---|
| # | Name | Trigger | Action | Description | Action |
| 10 | Address | | This alert will | We have audited your | Examine the data flagged |
| | | | identify if there | credit report and found | in your credit report. If it |
| | | | is a difference in | that the address you | is not accurate then it is |
| | | | the address | provided differs from | recommended that you |
| | | | listed on file and | what is on your credit | contact the credit bureau |
| | | | the address on | report. This does not | and update your |
| | | | the credit report. | affect your ICRECS | information accordingly. |
| | | | | Credit Score. It is wise to | |
| | | | | keep the most up to date | |
| | | | | and accurate credit report | |
| | | | | as possible. | |

It is contemplated that the Alert(s) provided may be associated with various Triggers, as shown in Table 1 or as further described below, and may further be associated with multiple Triggers. It is further contemplated that the Associated Trigger may provide additional descriptive language, which is generated by the current invention in response to the consumer's credit performance data. The Technical Action description may vary to align with the specific Trigger(s) and/or additional descriptive language that is/are being associated with the Alert. The Consumer Description provided may be general in nature or specific to the associated Trigger(s) and/or additional descriptive language. The Consumer Description may provide a restatement of a recommendation or AP variable or provide additional information, such as that shown above. The Recommended Action may include a specific action to take, wherein that action may be further reflected in the Action Plan. Alternatively, the recommended Action may provide additional actions that may be taken with respect to the particular Associated Trigger and/or additional descriptive language provided.

Additional Alerts may also be included and associated with various Triggers of the present invention, for example, an Alert for a T11 may be as follows:

| | | Associated | Technical | Consumer | Recommended |
|---|---|---|---|---|---|
| # | Name | Trigger | Action | Description | Action |
| 11 | Employer | | Identifies if | We have audited your | Examine the data flagged |
| | | | there is a | credit report and found | in your credit report. If it |
| | | | difference in | that the Employer's name | is not accurate then it is |
| | | | the employer | you provided differs from | recommended that you |
| | | | listed on file | what is on your credit | contact the credit bureau |
| | | | and employer | report. This does not | and update your |
| | | | on the credit | affect your ICRECS | information accordingly. |
| | | | report | Credit Score. It is wise to | |
| | | | | keep the most up to date | |
| | | | | and accurate credit report | |
| | | | | as possible. | |

It is contemplated that the Alert(s) provided may be associated with various Triggers, as shown in Table 1 or as further described below, and may further be associated with multiple Triggers. It is further contemplated that the Associated Trigger may provide additional descriptive language, which is generated by the current invention in response to the consumer's credit performance data. The Technical Action description may vary to align with the specific Trigger(s) and/or additional descriptive language that is/are being associated with the Alert. The Consumer Description provided may be general in nature or specific to the associated Trigger(s) and/or additional descriptive language. The Consumer Description may provide a restatement of a recommendation or AP variable or provide additional information, such as that shown above. The Recommended Action may include a specific action to take, wherein that action may be further reflected in the Action Plan. Alternatively, the recommended Action may provide additional actions that may be taken with respect to the particular Associated Trigger and/or additional descriptive language provided.

It is to be understood that the exemplary “Triggers” and “Variables” associated with each Trigger are explanatory only and are not intended to limit the scope of the present invention. For example, additional Triggers may be added or Triggers may be removed from the ICRECS process and functionality within the CRIE. Similarly, the Variables associated with the different Triggers may be altered in number, identification, meaning, and the like. As previously mentioned the number of Tiers and/or Intervals (and the numeric range of the intervals) may be varied. Further, the points (weighting) associated with the Tiers and Intervals may be varied to reflect an alternative ICRECS processing technique.

It is further contemplated that the ICRECS may utilize different information to provide information to an individual. In the current embodiment, the Triggers are analyzed. Alternatively, different formats for positive and negative impact indicators upon a credit report may be utilized.

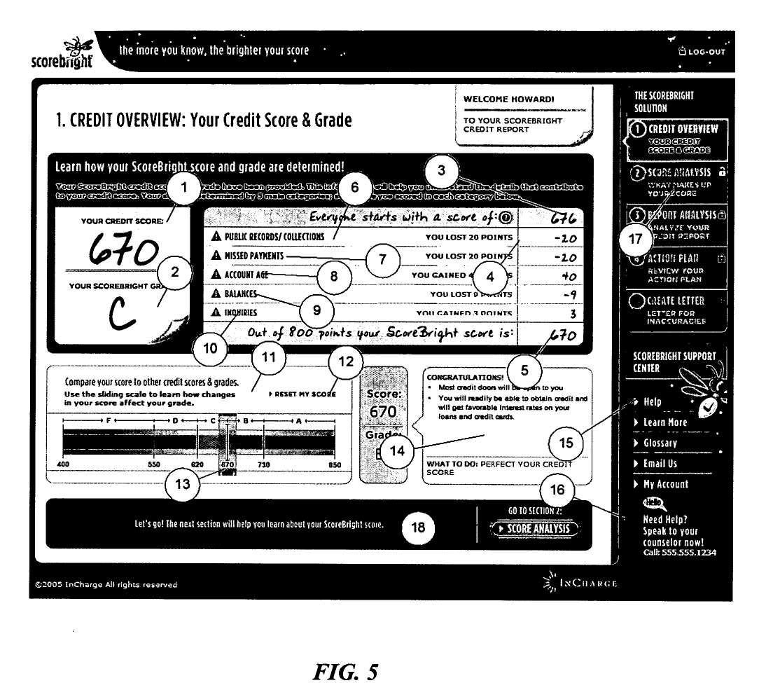

The ICRECS system, through the CRIID, presents the consumer with various displays providing a breakdown analysis of their credit performance information. In a preferred embodiment, the characterization step, within the exemplary methods of the current invention, utilize the information provided from the CRIE processing to perform a breakdown analysis and provide a Credit Score Overview (CSO). The results of the analysis are displayed to the user through a Credit Score Overview (CSO) screen. The CSO screen is presented to the consumer through the CRIID digital dashboard, as shown in FIG. 5. Summarized information factors from the CRIE analysis and assessment process will be presented in various positions throughout the screen, such as the information panels shown in FIG. 5. The CSO screen may provide a summary of the credit report along with an interactive sliding grading scale. The CSO screen may also provide a display of the information provided by the current invention as it starts to reconcile scores (Trigger scores) at the Grouping Level. This reconciliation process by the present invention allows an individual to more thoroughly understand their credit report/score by explaining the factors involved, the weighting they are given, and how the individual's particular “trade lines” affect the overall result. Thus, the education method of the present invention does not just present the credit report information, it also assists in explaining how the credit report, particularly the credit score, was generated. The current invention provides customized information for the consumer allowing them to better understand their credit. By combining this education of the credit report with the counseling process, the current invention also assists consumers by providing counseling on how the consumer may improve their credit rating.

Referring now to FIG. 5, a CRO screen is shown including the various panels and sub-panels which are utilized for the display of relevant information regarding the analysis of the consumer's credit rating. It is contemplated that the configuration of the CRO screen may be varied without departing from the scope and spirit of the present invention. In the current embodiment, the credit score 1 is presented, which is the variable Computed Credit Score (CCS), along with the ICRECS variable Computed Credit Grade (CCG) 2. The baseline of 676 is displayed at 3 and the positive or negative points are displayed at 4. The total score is presented at 5. At 6, the score total for the grouping “Public Records/Collections” is presented. At 7, the score total for the grouping “Missed Payments” is presented. At 8, the score total for the grouping “Account Age” is presented. At 9, the score total for the grouping “Balances” is presented. At 10, the score total for “Inquires” is presented. It is to be understood that each of the Grouping identifiers, 6 through 10, may be enabled as a “link” that allows a user to click-on the link and be taken to another screen providing certain information depending on the link clicked-on. At 11, the compare your score to other credit scores and grades is presented. Within this information panel, a consumer may move a sliding bar, 13 and review the characteristics of that score at 14. At 12, the consumer may reset the bar to match the original credit score. Support may be made available at 15 and may allow the consumer to access and review the topical library. At 16, the consumer may be provided instructions for talking to a counselor with questions about their credit report. At 17 or 18, the consumer may be allowed to navigate to the “Score Analysis” screen within CRIID. The information panel within which “Road Map” 17 is displayed, may be structured to provide the following indicators: 1. Credit Overview, 2. Score Analysis, 3. Report Analysis, 4. action plan, and 5. Create Letter. This information panel provides the user an interactive “Road Map” through which the user has their credit report broken down and explained from the Grouping level, as shown in FIG. 5, to numerous “Detail” levels, as will be described below.

The location upon the screen of the various elements described above and shown in FIG. 5 may be changed. For instance, the Groupings display, 6 through 10, may be located proximal to the left side of the screen and/or proximal to the bottom of the screen with the credit score 1 and credit grade 2 located towards the right side of the screen and/or proximal to the bottom of the screen. The sliding bar 13 may be located proximal to the top of the screen on the right or left side. The BrightScore™ (InCharge Institute of America, Inc.) solution “Road Map”, as represented by number 17 may also be moved to the left side of the screen nearer the top or bottom.

It is to be understood that the display of information shown in FIG. 5 and throughout the drawing figures of the instant application is exemplary and not intended to limit the scope of the current invention. It is contemplated that the relevant information displayed through the various screens may vary as contemplated by those of ordinary skill in the art. Thus, additional information may be added and/or outdated information may be removed from any of the screens shown in the drawing figures. It is further contemplated that the formatting for the display of the information may be varied to accommodate changes in the reporting of credit rating information. For instance, the sliding scale may be replaced by another gross rating format and the numbering and grading scales may change. It is further contemplated that greater or fewer links may be included upon the exemplar screens of the drawing figures of the instant application without departing from the scope and spirit of the present invention.

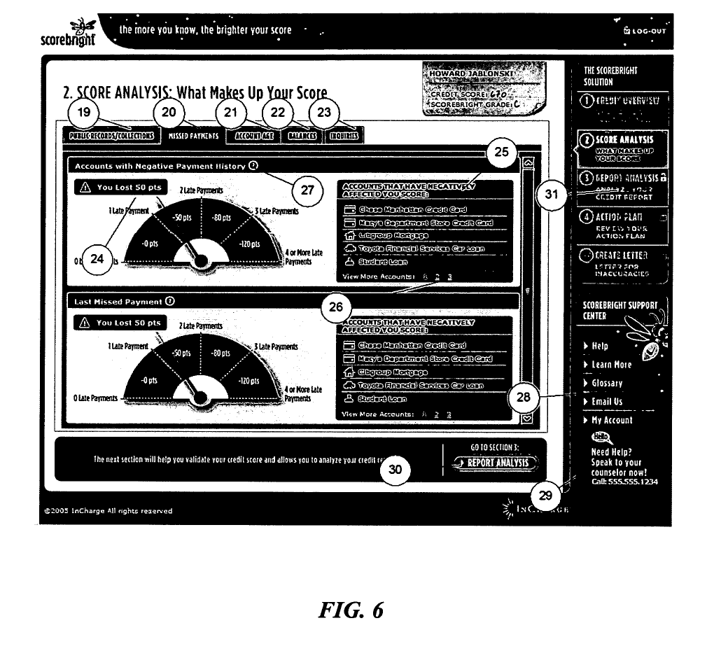

From the interactive “Road Map” another feature of the characterization step of the exemplary methods of the current invention allows the user, through the CRIID, access to the display of a “2. Score Analysis” screen as shown in FIG. 6. The Score Analysis is a “drill down” level or level of detailed description about the consumer's credit report below the Grouping level. The score analysis option is provided on the CSO, as shown in FIG. 5. Within the score analysis screen are information panels for each Grouping: Public Records/Collections at 19, Missed Payments at 20, Account Age at 21, Balances at 22 and Inquiries at 23. Support is available at 28 and allows the consumer review the topical library. At 29, the consumer is provided instructions for talking to a counselor with questions about their credit report.

In the current embodiment, the Grouping of Missed Payments 20, has been selected. It is to be understood that the various other Groupings that may be selected through the Score Analysis section may be similar to the Grouping of Missed Payments 20 or include more or less information, different screen configuration of the information panels and sub-panels, and the like as contemplated by those of skill in the art. Representative of the detail or drill down information provided by the present invention is the presentation of information panel 27 entitled: Accounts with Negative Payment History. On the display screen, under information panel 27, is another information sub-panel 24 that is identifying the total number of points lost/gained for this grouping and a scale provides another visual indication of where the consumer is rated. Another information sub-panel 25 provides a listing of the individual trade lines that are affecting the score provided in information sub-panel 24 for the missed payments grouping. The individual trade lines may be linked to further information that may be selected and accessed by the user. Information sub-panel 26 allows a user to scroll to different pages of listings of individual trade lines that are affecting the score provided in information sub-panel 24. Each of the individual trade lines have been analyzed by the ICRECS as outlined above, and each trade line is given a points weighting. The total points determined by the addition of each trade line's individual points weighting is what makes up the score determination that is shown in information sub-panel 24.

In the current embodiment shown in FIG. 6, the display screen provides a second information panel with the title of Last Missed Payment. This information panel includes further information sub-panels, similar to those described above for information panel 27, that provide score, rating, and individual trade line information. It is contemplated that the display may be divided/sub-divided into less than two different information panels or greater than two information panels. The number of information sub-panels may also vary as contemplated by those of skill in the art. Further, the sub-panels may allow the consumer to drill down into various sub-sub-panels and continue to drill down further as is contemplated by those of skill in the art.

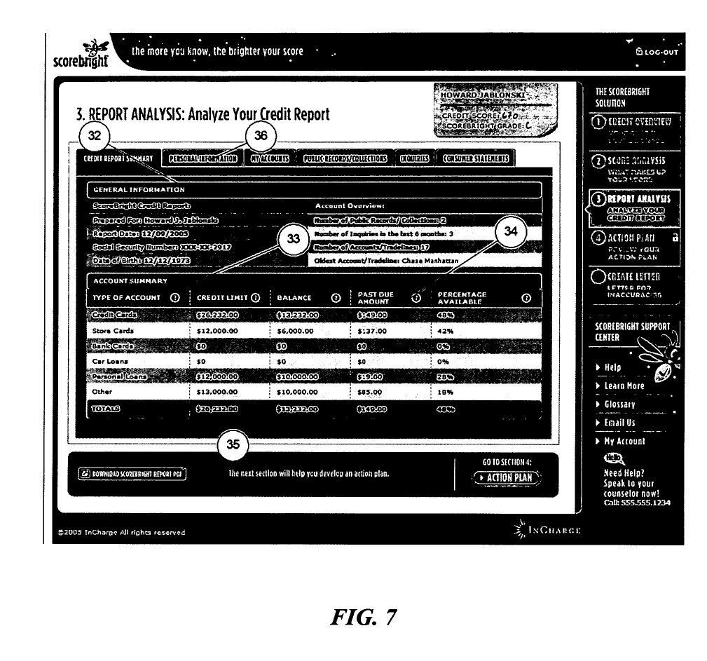

From the interactive “Road Map” another feature of the characterization step of the exemplary methods of the current invention allows the user, through the CRIID, access to the display of a “3. Report Analysis” screen, as shown in FIG. 7. Thus, when the user has examined all the information they wish to under the Score Analysis section of the “Road Map”, the current invention may allow the user to elect to go back to the CSO screen (FIG. 5) or elect the “Report Analysis” from the Road Map. The digital dashboard/CRIID allows the consumer to navigate within the detailed sections of their credit report in a systematic manner and provides the information in an easier to read and understandable format. Further, the information is presented in a prioritized/ranked manner. Preferably, a color coding scheme is employed to highlight those pieces of information identified as critical to the consumer. It is to be understood that other prioritization and ranking schemes, such as numeric ordering, iconic identification, and the like may be employed without departing from the scope and spirit of the present invention. In FIG. 6, the “Report Analysis” may be selected at numeral 30 or through the “Road Map” section of the displayed screen. FIG. 7 is an illustration of a Report Analysis screen wherein the grouping credit report summary has been selected from the tabs presented in information panel 36. It is to be understood that the Report Analysis section of the Road Map provides a detailed breakdown of the actual credit report of the individual consumer. In the Report Analysis, the user may use the information panel 35 to select and download a copy of their credit report in various formats. In the current embodiment, the credit report copy is provided in .pdf format but may be provided in other formats as contemplated. In FIG. 7, the Report Analysis further includes the general information panel 32, which provides information about the consumer and overview information about the consumer's accounts. The type of information provided may vary and the configuration of the information on the screen within the information panel may vary.

Information panel 33 provides a summary of the accounts that the consumer holds. The summary is broken down by information sub-panels into various categories, such as credit items, balance, past due amount 34, and percentage available. Information sub-panel 34, past due amount is representative of the type of category that may be utilized to provide the account summary of information panel 33. The types of accounts and categories provided within information panel 33 may vary, for instance the types of accounts may include greater or fewer listings and the information sub-panels may include greater or fewer categories as contemplated by those of ordinary skill in the art.

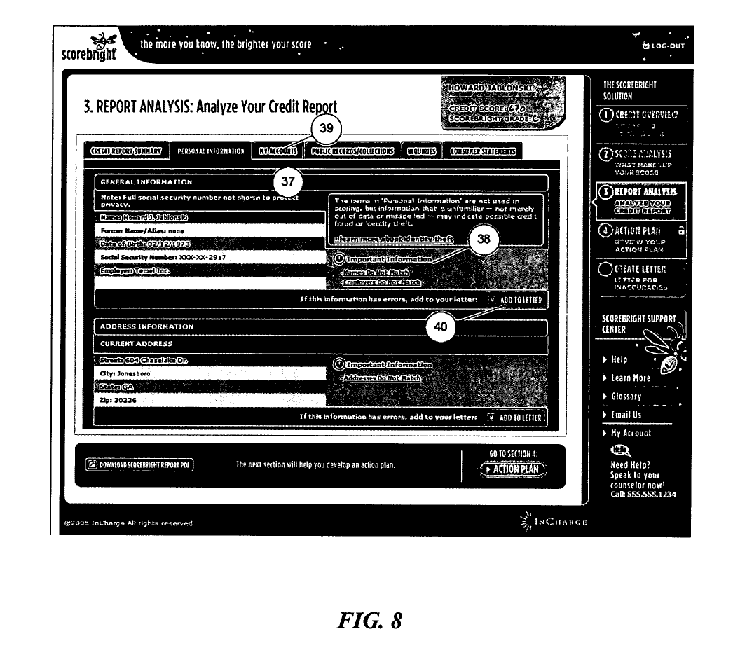

FIG. 8 is an illustration of the Personal Information screen within the Report Analysis section of the Road Map. Information panel 37 provides a listing of various items of personal information about the consumer. This information has been gathered from the credit report and/or the personal information questionnaire completed by the consumer in the first step of the exemplary methods of this invention. Various items of personal information may be displayed in this screen and the screen configuration may include only one panel, multiple panels, panels with one or more sub-panels, and/or multiple panels with one or more sub-panels of information. For instance, information sub-panel 38 displays to a user Important Information, which in this screen is the “Names Do Not Match” and the “Employers do Not Match.” This type of sub-panel, along with the learn more about identity theft sub-panel may provide the user with information that needs to be addressed, such as by correcting the information or ensuring that improper entries have not been made. Information sub-panel 40 “Add to Letter” allows a user access to a letter drafting screen within the current invention and then input information related to information the user wishes to dispute or feels is incorrect in their credit report. The sub-panels described above with respect to FIG. 8 may provide “links” to other screens provided by the ICRECS system through the CRIID. It is contemplated that the various panels, sub-panels, sub-sub-panels, and the like included on the screens of the present invention may include one or more “links” that may allow the user to more easily navigate the ICRECS system of the present invention.

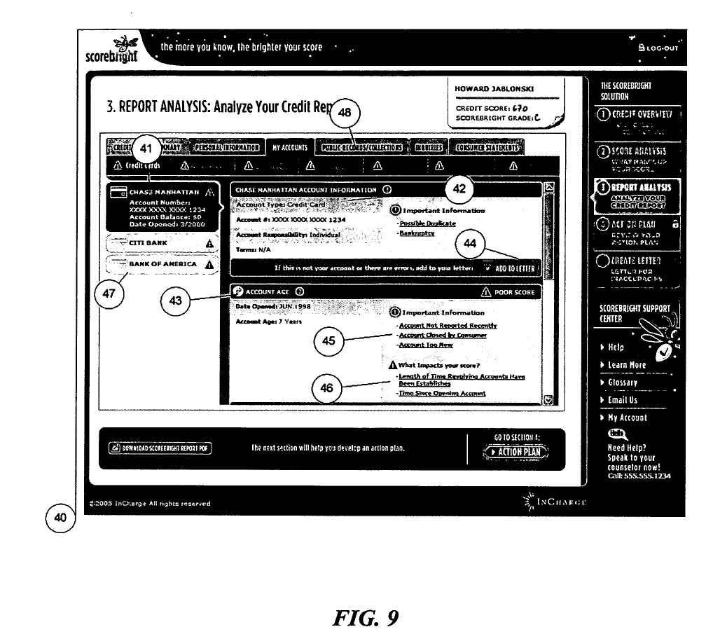

The “My Accounts” tab 39 allows the user to proceed to another screen display within the Report Analysis section. As shown in FIG. 9, the My Accounts screen allows the user to view information from the credit report related to individual accounts. In the current embodiment, the user in information sub-panel 41 is viewing the Chase Manhattan account. As indicated by Bank of America 47, other accounts may be listed in this or other areas of the screen. Information sub-panel 42 identifies the account type and other relevant information and information sub-panel 44 is similar to that described in FIG. 8 for information sub-panel 40. Information sub-panel 43 identifies the account age and provides a listing of the date the account was opened. Information sub-panel 45 provides a display of Important Information for the user to review by clicking-on the links provided. Information sub-panel 46 provides links the user may select to access further explanation about those factors that are affecting their score. The tab Public Records/Collections 48 allows the user to access the screen associated with that tab by clicking-on the tab.

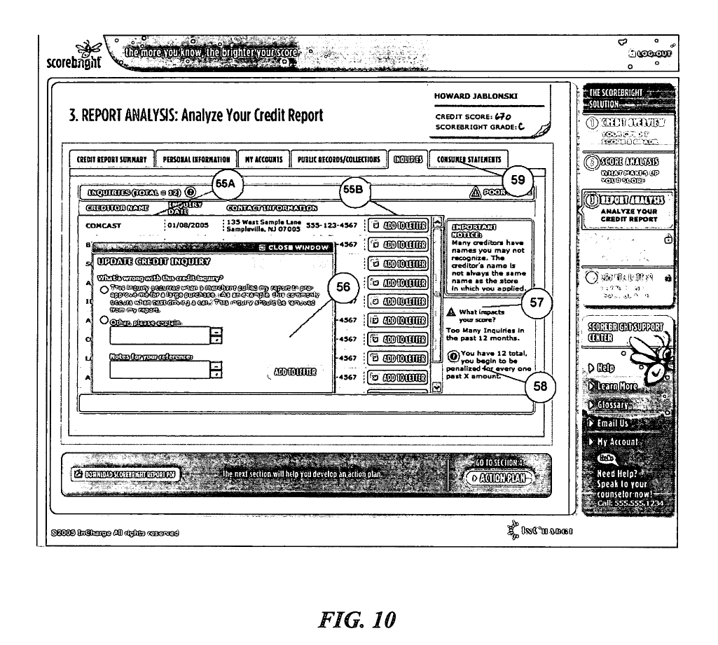

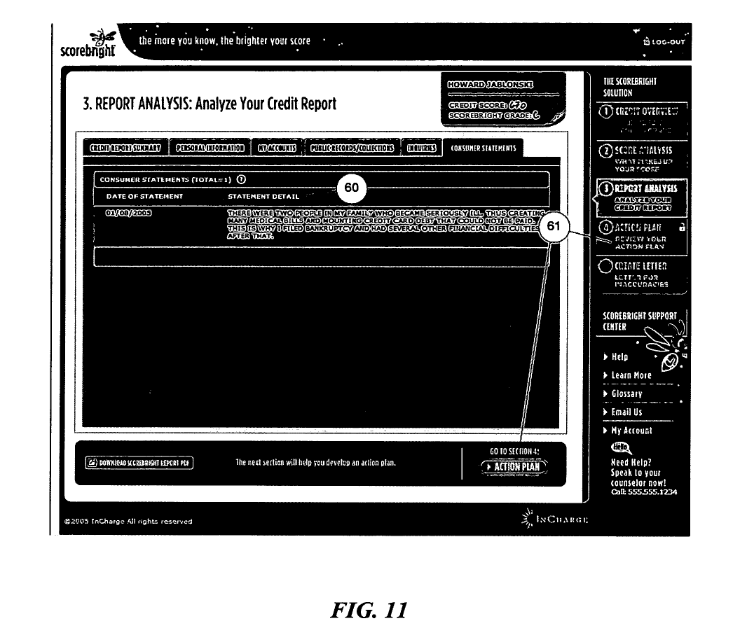

FIG. 10 shows the screen associated with the Inquiries tab within the Report Analysis section. Tab 59, Consumer Statements allows the user to view the screen associated with this tab. Information sub-panel 55B includes an Add To Letter link, similar to information sub-panels 40 and 44 from FIGS. 8 and 9. This panel also includes a listing of the inquiries that have been made into the consumer's credit, by whom, when, and contact information for that company. The number of fields which populate this information sub-panel 50 may vary greatly from 1 to 500. Information sub-panel 57 provides the user an identification of what is impacting their score and information sub-panel 58 provides a statement of possible future activity and its consequences. Information sub-panel 56 allows the user to provide written description regarding an individual inquiry listed on information sub-panel 55A. Panel 56 may provide a form paragraph, such as that shown, or not and may allow for the entry of a unique description. It also may allow the user to make notes regarding this inquiry and include the selected written description in a letter. FIG. 11 is an illustration of a Consumer Statements screen within the Report Analysis section. This screen allows the consumer to view and/or enter statements regarding their credit situation. Information sub-panel 60 provides a listing of the statements and/or may allow for the entry of a statement into the credit record. This explanatory section may be expanded and allowed to be linked to the Create a Letter section of the Road Map. Numeral 61 identifies the action plan section of the Road Map, in particular, the location(s) on the screen where a user may click-on and be directed to the action plan screen.

It is understood that the various screens shown within the different sections of the Road Map may be updated and/or otherwise changed without departing from the scope and spirit of the present invention. Changes may include the formatting of the display (hidden and pop-ups), the size of the displayed screen, the configuration of the information panels/sub-panels on the screen, the information asked for and provided on the screen, the links to further information provided on the screen, and the like.

As described previously, a method of the current invention includes the step of generating an action plan, which is a group of actions that are particular to the consumer's trigger data and intervals. The actions come from the analysis of the consumer's credit report and may include some of the behavioral counseling described above. In this step of the exemplary method of generating an action plant, the Alerts may be presented to facilitate the counseling and education. It is contemplated that the Alerts may be displayed in an alternative section without departing from the scope and spirit of the present invention. In a preferred embodiment, the actions may suggest positive behaviors which may be practiced by the consumer that build a strategy from which a consumer may work towards improved credit ratings and long-term creditworthiness. The actions may be utilized to point out past positive behaviors that have contributed to a consumer's good credit standing. In this way, the current invention promotes the consumer's use of positive credit usage decisions. The action plan may also identify, through a “warning section” or alternative section, negative behaviors that may have a negative impact on the consumer's score. Through the action plan, a consumer may be able to access the “Learn More” section, which may provide further explanation as to why the creditor's look at this, how long the information stays on your report, and various other aspects of the credit reporting process.

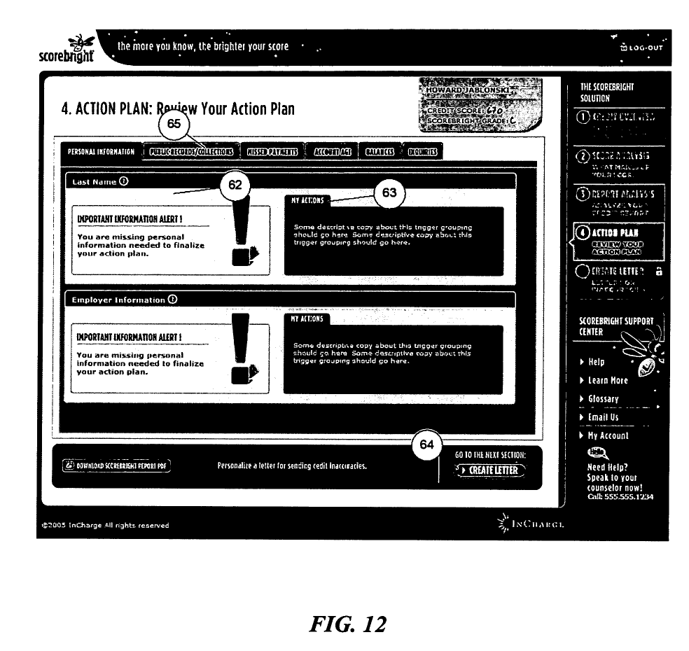

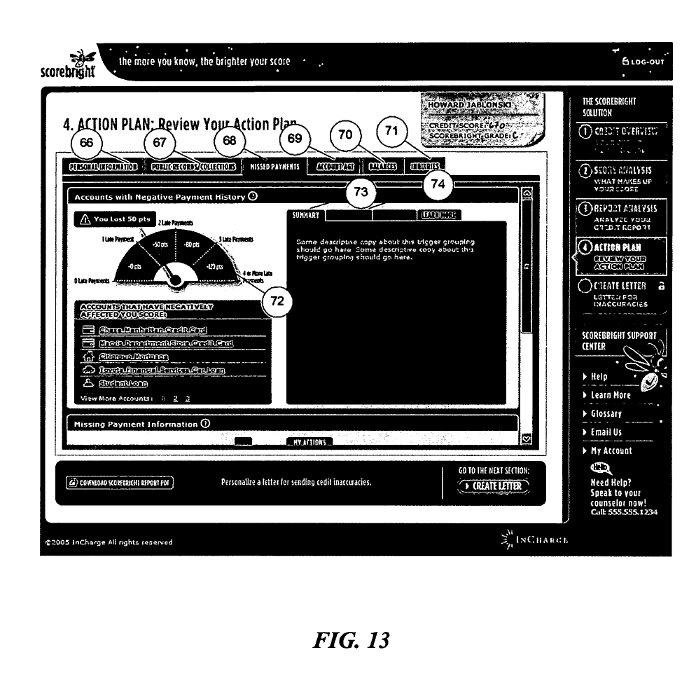

FIG. 12 includes the Personal Information screen of the action plan section of the Road Map. Information sub-panel 62 includes indicators relating to what if anything is missing and/or needed to complete the personal information section within a credit report. Then, in information sub-panel 63 a description of action(s) to be taken to correct the incomplete record of the credit report is provided. Information sub-panel 64 is similar to information sub-panels 40 and 44, of FIGS. 8 and 9. Numeral 65 indicates the tab for Public Records/Collections. As shown in FIG. 13, the action plan section includes a plurality of tabs: Personal Information 66, Public Records/Collections 67, Missed Payments 68, Account Age 69, Balances 70, and Inquiries 71.

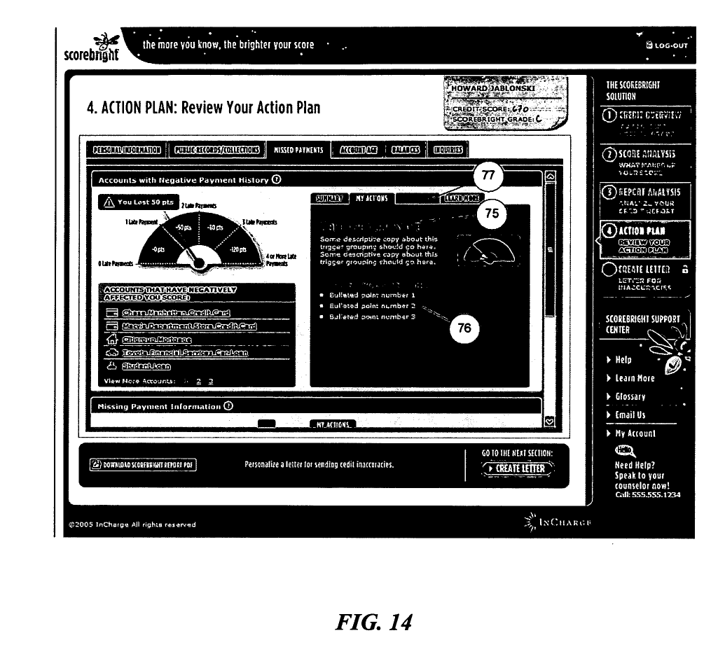

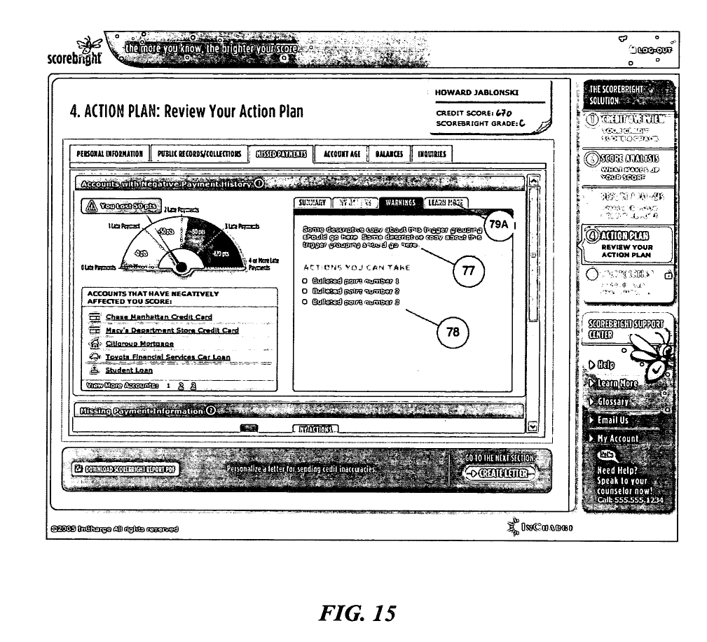

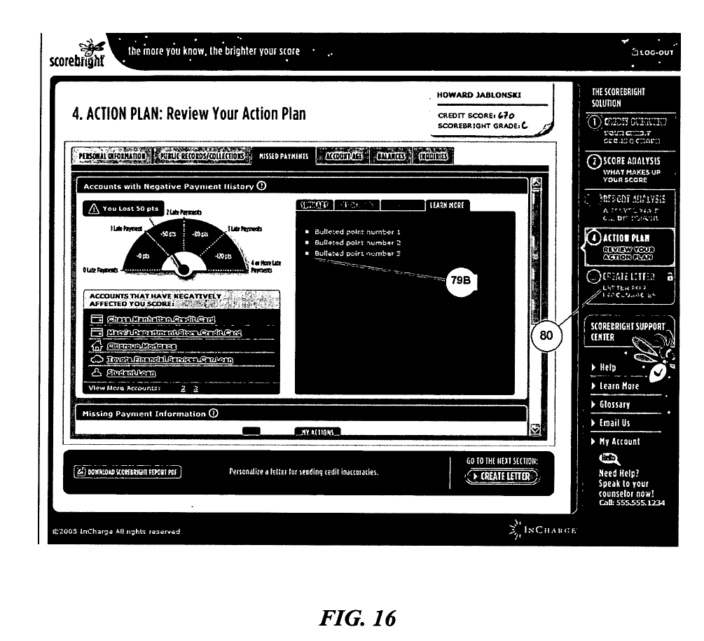

FIG. 13 further illustrates a display of the screen, including information panels and sub-panels for Missed Payments 68. Information sub-panel 72 identifies the user's accounts with negative payment information, the score impact that it has, a rating of where the consumer stands form the credit analyzing companies perspective, and a list of the accounts that are affecting this grouping. Further this screen, and the screens shown in FIGS. 15, 16, and 17, include an information sub-panel identified by a grouping of four tabs: Summary 73 (FIG. 13), My Actions 74 (FIG. 13), Warnings 77 (FIG. 14) and Learn More 79A (FIG. 15). As shown in FIG. 13, the Summary includes information that provides an overview of this grouping and the triggers that are impacting it. In FIG. 14, information sub-panel 75 and 76 are displaying information under the My Actions tab 74. These panels 75 and 76 provide a description of how to optimize the user's score within this grouping and a set of actions that the user may implement to move towards accomplishing those goals. FIG. 15 shows information sub-panels 77 and 78 under the Warnings tab. These panels 77 and 78 provide a description of what behaviors may negatively affect the credit score and actions steps that may be taken to avoid any negative impact. Information sub-panel 79B is displaying information under the Learn More tab, as shown in FIG. 16. Panel 79B may provide further explanation as to why the creditor's look at this grouping, how long the information stays on your report, and various other aspects of the credit reporting process. In addition, the Learn More screen may provide supplemental education material through identification of specific credit indicators (i.e., collections) that the consumer has on their report and may benefit from further information about. It is contemplated that information sub-panel 79B may include a functional capability to direct the consumer to a Dispute Checklist section of the Road Map. The Dispute Checklist section may allow the consumer to build a personal dispute profile, whereby they can compile a listing of the inaccuracies that are noted in their credit report by the instant invention and provide recommended actions or alternative steps to be taken by the consumer with respect to the listed inaccuracies.

It is to be understood that the action plan section may provide the user with information relating to any and all groupings and identifying the triggers that are affecting those groupings. Further, the action plan may provide assistance in the form of counseling and other descriptive language on how to improve or what may negatively affect the credit score and may identify action steps that the user may implement to achieve their goals.

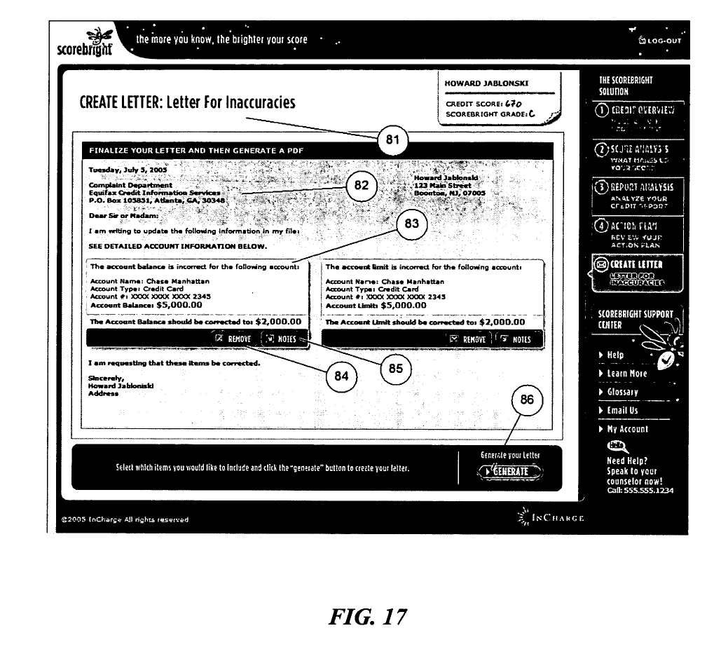

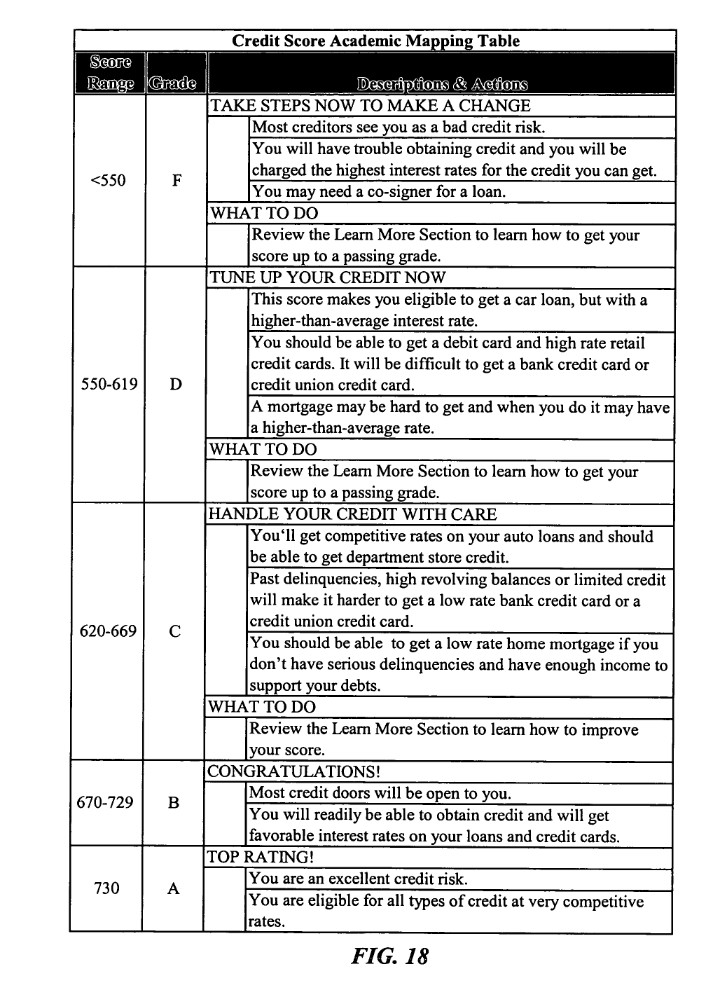

The current invention provides the capability to assist the user in compiling potential dispute items and facilitates a dispute tool to send to credit reporting agencies. The dispute tool may allow online submission of letters of dispute or statements of explanation and the like. As indicated throughout the previous sections of the Road Map, the current invention allows the user, as they are reviewing their credit information to “flag” information of concern. Numerals 40 and 44 are just two of the many examples within the various screens of the present invention wherein the user is given access to the dispute tool. This dispute tool a number of actions that can be generated by the user in order to address any credit issues discovered throughout the process, one of such examples is the creation of a Letter of Inaccuracies as described in FIG. 17. The dispute tool may provide instructions to review a disputed check list and allow to print the checklist created by the user to have readily available as a reference during the online dispute process The information utilized within the dispute tool capability may be automatically pulled from the information provided in earlier screens or entered by the user manually. Additionally, the user may modify the information contained dispute tool portion of the Road Map by adding or removing information that is desired or unwanted. Further, the dispute tool may contain a link to view education articles concerning correction of credit reports and allow the user to directly access the credit reporting agencies online for dispute submission according to their online process.

Another functional feature of the current invention which may be included with any of the exemplary methods is the capability to assist the user in generating letters to send to credit agencies. The letters may be letters of dispute or statements of explanation and the like. As indicated throughout the previous sections of the Road Map, the current invention allows the user, as they are reviewing their credit information to “flag” information of concern. Numerals 40 in FIG. 8 and 44 in FIG. 9 are just two of the many examples within the various screens of the present invention wherein the user is given access to the screen shown in FIG. 17. The screen displayed in FIG. 17 includes information sub-panels 81 through 86. Sub-panel 81 provides a description of the type of letter being created, in this embodiment a Letter for Inaccuracies. Sub-panel 82 shows the automatically inserted address for the credit company to which the letter is being directed. Sub-panel 83 provides an example of the type of information that may be included in the letter. This information may be automatically pulled from the information provided in earlier screens or entered by the user manually. Sub-panel 84 allows for the editing of the information contained in sub-panel 83 by removing information that is unwanted. Sub-panel 85 allows the user to view and/or enter notes regarding the item listed in sub-panel 83 and sub-panel 86 allows the user to automatically generate the letter from the screen.

In the exemplary embodiments, the methods disclosed may be implemented as sets of instructions/commands or software readable by a device. Further, it is understood that the specific order or hierarchy of steps in the methods disclosed are examples of exemplary approaches. Based upon design preferences, it is understood that the specific order or hierarchy of steps in the method may be rearranged while remaining within the scope and spirit of the present invention. The accompanying method claims present elements of the various steps in a sample order, and are not necessarily meant to be limited to the specific order or hierarchy presented.

It is to be understood that the functional capabilities of the current invention, including those provided within the methods described, may be implemented in various manners. In a preferred embodiment, these functional features are included within the sets of instructions/commands or software that may be downloaded upon a computing device or into a computing environment as described for the current invention. It is contemplated that various functional features may be individually provided to the system of the present invention. Further, the specific order or hierarchy of functional capabilities described herein are merely exemplary approaches and based upon design preferences may be rearranged while remaining with the scope and spirit of the present invention. The methods may employ the above described functional capabilities in various ways, enabling one or many of the features without regard to any specific hierarchical order.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method for providing credit education to a consumer, comprising the steps of:
building a personal profile of the consumer;
retrieving credit report data for the consumer; and
characterizing the consumer's credit performance.

2. The method of claim 1, wherein the step of building the personal profile of the consumer further comprises the step of having the consumer complete a self-assessment.

3. The method of claim 1, wherein the step of building the personal profile of the consumer further comprises the step of gathering personal information and payment method.

4. The method of claim 1, wherein the step of retrieving the credit report data file for the consumer further comprises the step of compiling data records and data attributes from a credit reporting agency.

5. The method of claim 4, wherein the step of compiling data records further comprises the step of collecting informational data records and trigger data records.

6. The method of claim 1, wherein the step of characterizing the consumer's credit performance further comprises the step of analyzing the data within the credit report data file.

7. The method of claim 1, wherein the step of characterizing the consumer's credit performance further comprises the step of assessing the consumer's credit performance based on the credit report data.

8. The method of claim 1, wherein the step of characterizing the consumer's credit performance further comprises the step of generating an Alert.

9. The method of claim 1, further comprising the step of generating an action plan for a consumer.

10. A method for counseling a consumer, comprising the steps of:
building a personal profile of the consumer;
retrieving a credit report data file for the consumer;
characterizing the consumer's credit performance; and
generating an action plan.

11. The method of claim 10, wherein the step of building the personal profile of the consumer further comprises the step of having the consumer complete a self-assessment.

12. The method of claim 10, wherein the step of building the personal profile of the consumer further comprises the step of gathering personal information and payment method.

13. The method of claim 10, wherein the step of retrieving the credit report data file for the consumer further comprises the step of compiling data records and data attributes from a credit reporting agency.

14. The method of claim 13, wherein the step of compiling data records further comprises the step of collecting informational data records and trigger data records.

15. The method of claim 10, wherein the step of characterizing the consumer's credit performance further comprises the step of analyzing the data within the credit report data file.

16. The method of claim 10, wherein the step of characterizing the consumer's credit performance further comprises the step of assessing the consumer's credit performance based on the credit report data.

17. The method of claim 10, wherein the step of characterizing the consumer's credit performance further comprises the step of generating an Alert.

18. The method of claim 10, wherein the step of generating an action plan further comprises the step of identifying positive or negative opportunities.

19. The method of claim 10, wherein the step of generating an action plan further comprises the step of reporting general recommendations.

20. A system for consumer credit education and counseling, comprising:
a computing device including a credit report inference engine and credit report interactive intelligent dashboard (CRIID); and
a credit reporting agency communicatively coupled with the computing device,
wherein the credit report inference engine retrieves consumer credit report data from the credit reporting agency, characterizes the consumer's credit performance information, and wherein a display of such characterization is provided via the CRIID.

21. The system of claim 20, wherein the computing device is networked with various other computing devices to provide credit education and counseling to one or more consumers.

22. The system of claim 20, wherein the credit report inference engine generates an action plan.

23. The system of claim 22, wherein the action plan reports opportunities to the consumer.

24. The system of claim 22, wherein the action plan reports general recommendations.

25. The system of claim 22, wherein the credit report inference engine generate Alerts.
